(19) United States
(12) Patent Application Publication
(10) Pub. No.: US 2026/0046962 A1
(43) Pub. Date: Feb. 12, 2026

(54) OFF-CHANNEL TDLS COMMUNICATION FOR MULTI-LINK DEVICES

(71) Applicant: CANON KABUSHIKI KAISHA, Tokyo (JP)

(72) Inventors: Romain GUIGNARD, RENNES (FR); Pascal VIGER, JANZE (FR)

(21) Appl. No.: 19/099,432

(22) PCT Filed: Jul. 19, 2023
(86) PCT No.: PCT/EP2023/069985

§ 371 Date: Jan. 28, 2025

(30) Foreign Application Priority Data
Jul. 29, 2022 (GB) 2211149.6
Dec. 16, 2022 (GB) 2219004.5
Jul. 6, 2023 (GB) 2310403.7

(51) Int. Cl. H04W 76/15; H04W 88/08

(52) U.S. Cl. CPC H04W 76/15; H04W 88/08

(57) ABSTRACT

A non-AP MLD (120) obtains a link ID, which defines an off-link corresponding to at least one off-channel (172b) that does not overlap the channel(s) used by the AP device. The non-AP MLD (120) establishes, through the channel(s) used by the AP device, a TDLS direct link, between a first TDLS STA, (122) affiliated with the non-AP MLD (120) and a second TDLS STA (132) of a second non-AP MLD (130), using the link ID as an indication of the off-link for the TDLS direct link. The non-AP MLD (120) operates a peer-to-peer communication between the first and second TDLS STAs, over the off-link.

### CROSS-REFERENCE TO RELATED APPLICATIONS

This application is the national stage of PCT/EP2023/069985, filed on Jul. 19, 2023, which claims the benefit under 35 U.S.C. § 119(a)-(d) of United Kingdom Patent Application No. 2211149.6, filed on Jul. 29, 2022 and entitled “IMPROVED OFF-CHANNEL COMMUNICATION METHOD AND SYSTEM FOR MULTI-LINK P2P STATIONS”, of United Kingdom Patent Application No. 2219004.5, filed on Dec. 16, 2022 and entitled “IMPROVED OFF-CHANNEL COMMUNICATION METHOD AND SYSTEM FOR MULTI-LINK P2P STATIONS”, and of United Kingdom Patent Application No. 2310403.7, filed on Jul. 6, 2023 and entitled “IMPROVED OFF-CHANNEL COMMUNICATION METHOD AND SYSTEM FOR MULTI-LINK P2P STATIONS”. The above-cited patent applications are incorporated herein by reference in their entireties.

### FIELD OF THE INVENTION

The present invention generally relates to wireless communications and more specifically to peer-to-peer (P2P) communications by Multi-Link (ML) devices.

### BACKGROUND OF THE INVENTION

Wireless communication networks are widely deployed to provide various communication services such as voice, video, packet data, messaging, broadcast, etc. These wireless networks may be multiple-access networks capable of supporting multiple users by sharing the available network resources. Examples of such multiple-access networks include Code Division Multiple Access (CDMA) networks, Time Division Multiple Access (TDMA) networks, Frequency Division Multiple Access (FDMA) networks, Orthogonal FDMA (OFDMA) networks, and Single-Carrier FDMA (SC-FDMA) networks.

The 802.11 family of standards adopted by the Institute of Electrical and Electronics Engineers (IEEE®) provides a great number of mechanisms for wireless communications between STAs.

With the development of latency sensitive applications such as online gaming, real-time video streaming, virtual reality, drone or robot remote controlling, better throughput, low latency and robustness requirements and issues need to be taken into consideration. Such problematic issues are currently under consideration by the IEEE 802.11 working group as a main objective to issue the next major 802.11 release, known as 802.11be or EHT for “Extremely High Throughput”.

The IEEE P802.11be/D2.2 version (October 2022, below “D2.2 standard”) introduces the Multi-Link (ML) Operation (MLO). MLO improves data throughput by allowing communications between STAs over multiple concurrent and non-contiguous communication links.

MLO enables a non-AP (Access Point) MLD (ML Device) to register with an AP MLD, i.e. to discover, authenticate, associate and set up multiple communication links with the AP MLD. Each communication link so setup (below “setup link” or “enabled link” once enabled) enables channel access and frame exchanges between the non-AP MLD and the AP MLD based on supported capabilities exchanged during the association procedure.

A MLD is a logical entity that has more than one affiliated station (STA) and has a single medium access control (MAC) service access point (SAP) to logical link control (LLC), which includes one MAC data service. An AP MLD is thus made of multiple affiliated APs whereas a non-AP MLD is made of multiple affiliated non-AP STAs. The affiliated STAs in both AP MLD and non-AP MLD can use 802.11 mechanisms to communicate with affiliated STAs of another MLD over each of the multiple communication links that are set up.

The existing Tunneled Direct Link Setup (TDLS) has been adapted to coexist with the MLDs of the D2.2 standard. More precisely, the D2.2 standard adapts the TDLS mechanism to the multi-link features, by adjusting the signalling of MAC addresses in the setup frames when establishing a TDLS session over one of the multiple setup links. As a result, a direct link, made of a single communication link (e.g. a 20 MHz channel on either of the 2.4, 5 and 6 GHz bands), is established in between two wireless STAs (TDLS peer STAs), each affiliated with an MLD.

Formerly endorsed by IEEE 802.11z standard in 2008, TDLS enables devices (called TDLS peer STAs) to link directly to one another when connected to a traditional AP. To set up and maintain a direct link, both TDLS peer STAs shall be associated with the same infrastructure BSS (in short, the same AP). The TDLS mechanism provides encapsulation of the setup frames, exchanged between the two TDLS peer STAs, in Data frames. This allows the setup frames to be transmitted transparently (or “tunneled”) through the AP. The setup frames include so-called TDLS Action frames. Besides, as the setup frames are transmitted transparently through the AP, the AP does not need to be TDLS-aware or to have the same capabilities as the TDLS peer STAs involved in the TDLS-based peer-to-peer communication. Then, once the direct link is setup, the TDLS peer STAs can communicate directly with one another through the setup direct link, without involving the AP although they remain associated with the AP. It must be noted that when the TDLS peer STAs communicate directly via the direct link, the P2P traffic competes with other traffic to/from the AP since the P2P traffic and the other traffic to/from the AP are performed over the same communication link, that is to say the same frequency channel.

To reduce competition with the traffic involving the AP, a switching between such channel used by the AP, referred to as “base channel”, and an associated off-channel has been proposed. The mechanism is known as a “TDLS channel switching”.

The IEEE P802.11-REVme/D2.0 version (October 2022) defines the off-channel. An off-channel is a channel used by TDLS peer STA that does not overlap the channel(s) used by the AP with which the TDLS peer STA is associated. In other words, an off-channel is a channel that does not belong to the AP's operating channel(s) and that can be used for P2P communication. TDLS devices can negotiate to move (i.e. switch) from the base channel (i.e. shared with the AP and used to setup the TDLS direct link) to such an off-channel (not shared with the AP). The two TDLS devices previously advertise in the TDLS setup frames, usually request and response, that they support at least partially the same channel(s) including the off-channel(s). Before moving (switching) from the base channel to the off-channel, the TDLS devices is in PS (Power Save) mode with the AP and is not involved in an active Service Period with the AP.

When operating via the off-channel, the TDLS devices remain in power save mode in the base channel and can no longer communicate with the AP. Thus, they have to regularly, hence repeatedly, return to the base channel in order to perform some actions, such as to receive beacons, look at the TIM (Traffic Indication Map) for any buffered packets, and communicate with other devices in the network.

As defined in the P802.11-REVme/D2.0 version, the usage of the off-channel, despite a huge interest to improve coexistence between infrastructure and P2P communications, follows a legacy behaviour, i.e. requires repeated TDLS channel switches (i.e. to go back and forth between the base channel and the off-channel). This is of course not optimal because, due to the repeated TDLS channel switches, the TDLS devices (TDLS peer STAs) cannot durably use the off-channel for TDLS (P2P) transmission.

There is thus a need to improve the off-channel usage mechanism in the context of the multi-link (multi-radio) mechanism.

### SUMMARY OF INVENTION

It is a broad objective of the present invention to overcome some of the foregoing concerns.

The inventors have noticed that the above deficiencies come from the inability of the non-AP MLDs, despite their multi-link (multi-radio) capability, to durably use the off-channel for TDLS transmission while keeping (i.e. remaining active on) a channel for communication with the AP to, e.g., get the beacon frames. The present invention hence defines new mechanisms that allow non-AP MLDs to durably use an off-channel for TDLS transmission, no longer needing to switch repeatedly between the off-channel and the base channel.

In this context, embodiments of the invention are directed to a communication method in a wireless network, comprising, at a non-access point, non-AP, multi-link device, MLD associated with an AP device:
obtaining a link identifier, ID, which defines an off-link corresponding to at least one off-channel that does not overlap the channel(s) used by the AP device;
establishing, through the channel(s) used by the AP device, a Tunneled Direct Link Setup, TDLS, direct link, between a first TDLS station, STA, affiliated with the non-AP MLD and a second TDLS STA affiliated with another non-AP MLD, using the link ID as an indication of the off-link for the TDLS direct link; and
operating a peer-to-peer communication between the first and second TDLS STAs, over the off-link.

Thus a new link ID is proposed, which defines a new link referred to as “off-link” independently to a base channel and a link setup with the AP device. As detailed below, establishing the TDLS direct link using this new link ID can be carried out:
either directly, i.e. using directly the link ID to define the off-link as the TDLS direct link (no channel switch in this case);
or indirectly, i.e. by a two-step mechanism comprising setting up an initial TDLS direct link (in a conventional way) and then performing a channel switch using a channel of the off-link as a target channel for the target link or performing a link switch using the link ID to define the off-link as the target link of the link switch.

In both cases, the off-channel is defined as an own link (i.e. new off-link), through the use of a new Link ID, which is independent to a base channel (defining the link on which a conventional TDLS direct link is established). Indeed, in the first case, there is no base channel since there is no channel switch. In the second case, there is no dependency to a base channel once the switch has been carried out. It should be noted that, as described below, in the second case the initial TDLS direct link (operating on the base channel) can even be removed or disabled.

As a consequence, the non-AP MLD no longer has to carry out any channel switch back from the off-channel to a base channel in order to receive beacon frames. It turns out that the non-AP MLD can durably use the off-link (and corresponding off-channel or off-channels) for TDLS transmission.

Furthermore, even when the first TDLS STA of the non-AP MLD is operating via the off-link, the non-AP MLD can, if necessary and thanks to the multi-link features, communicate with the AP via any other link possibly established by another of its affiliated STAs with any affiliated AP. Thus, the non-AP MLD can receive beacons, look at the TIM for any buffered packets, and communicate with other devices in the network, without requiring the repeated channel switches.

In other words, the proposed solution takes benefit of the multi-link (multi-radio) capabilities of the non-AP MLD to establish a durable TDLS direct link on an off-channel or off-channels thanks to an autonomous off-link (i.e. independent to a base channel), while communication with the AP device can be kept through another link.

Optional features of the invention are defined below with reference to a method, while they can be transposed into device features.

Advantageously, the method further comprises: operating a communication with the AP device on another link corresponding to at least one of said channel(s) used by the AP device.

As already discussed above, the non-AP MLD can, if necessary, communicate with the AP via another link established by another of its affiliated STAs. Thus, the non-AP MLD does not have to carry out any channel switch in order to receive beacons, look at the TIM for any buffered packets, and communicate with other devices in the network.

In some implementations, obtaining the link ID includes: receiving, from the AP device which is an AP MLD, information about a Virtual AP affiliated with the AP MLD, the Virtual AP defining the off-link and being assigned the link ID, the Virtual AP performing no communication in its Basic Service Set, BSS.

By “Virtual AP” it is meant an affiliated AP that does not actually operate (it performs no communication). Such virtual AP advantageously gives the non-AP MLDs a link identifier for a link corresponding to the off-channel.

In these implementations, the link ID is created by the AP MLD through the creation of a Virtual AP, which is a new kind of AP not to be used for communication in between the non-AP STAs or MLDs and the AP MLD.

In some other implementations, establishing the TDLS direct link by the non-AP MLD includes: defining the off-link and the link ID based on information about the at least one off-channel received from the AP device.

In these other implementations, the link ID is created by the non-AP MLD and the other non-AP STA or MLD (the AP MLD is not involved).

In some implementations, wherein establishing the TDLS direct link comprises setting up the TDLS direct link using the link ID to define the off-link as the TDLS direct link.

As discussed above, in this first case, establishing the TDLS direct link using the new link ID is carried out directly, i.e. using directly the link ID to define the off-link as the TDLS direct link (no channel switch in this case). The corresponding advantages have already been discussed above.

In some other implementations, establishing the TDLS direct link comprises:
setting up an initial TDLS direct link enabling a peer-to-peer communication between the first and second TDLS STAs; and
performing a channel switch to move the peer-to-peer communication from the initial TDLS direct link to a target link, using a channel of the off-link as a target channel for the target link or using the link ID to define the off-link as the target link.

As discussed above, in this second case, establishing the TDLS direct link using the new link ID is carried out indirectly, i.e. by a two-step mechanism comprising setting up an initial TDLS direct link and then performing a channel switch. The corresponding advantages have already been discussed above.

In various embodiments, the method further comprises, at the non-AP MLD: disabling or removing the initial TDLS direct link.

Thus the channel(s) corresponding to the removed or disabled link can be reused and these network resources are therefore optimized.

Embodiments of the invention also provide a communication method in a wireless network, comprising, at a non-access point, non-AP, multi-link device, MLD associated with an AP MLD:
receiving, from the AP MLD, information about a Virtual AP affiliated with the AP MLD, the Virtual AP performing no communication in its Basic Service Set, BSS, the Virtual AP defining an off-link corresponding to at least one off-channel that does not overlap the channel(s) used by the AP MLD, the affiliated Virtual AP being assigned a link identifier, ID, thus identifying the off-link; and
communicating over the wireless network using the link ID.

Thus the non-AP MLD receives a new kind of information (information about a Virtual AP which is a new kind of AP not to be used for communication in between the non-AP STAs or MLDs and the AP MLD) and in particular a particular link ID enabling it to communicate over the wireless network.

This configuration advantageously allows links additional to those operated by the AP MLD to be defined. Such additional links may for example be used for direct communications within the wireless network.

The fact that the Virtual AP performs no communication in its BSS does not prevent the present solution, in some embodiments, to be applied in the Multi-AP context, i.e. using the off-channel (and off-link) for Multi-AP communications.

In various embodiments, communicating over the wireless network using the link ID comprises:
establishing, through the channel(s) used by the AP device a tunneled direct link setup, TDLS, direct link, between a first TDLS station, STA, affiliated with the non-AP MLD and a second TDLS STA, using the link ID as an indication of the off-link for the TDLS direct link; and
operating a peer-to-peer communication between the first and second TDLS STAs, over the off-link.

Thus, the above mechanism, based on receiving information about a Virtual AP, is compatible with the TDLS mechanism and allows the non-AP MLD to durably use the off-link (and corresponding at least one off-channel) for TDLS transmission. Indeed, even when the first TDLS STA of the non-AP MLD is operating via the off-link (corresponding to at least one off-channel), the non-AP MLD can, if necessary, communicate with the AP via another link established by another of its affiliated STAs. Thus, the non-AP MLD does not have to carry out any channel switch in order to receive beacons, look at the TIM for any buffered packets, and communicate with other devices in the network.

In various embodiments, establishing the TDLS direct link comprises at least one of the following operations:
including, in TDLS setup frames exchanged between the first and second TDLS STAs, a link identifier which comprises a BSSID field set with a basic service set identifier, BSSID, corresponding to the Virtual AP and thus to the off-link;
adding the off-link in a per STA profile subelement carried in a TDLS Multi-Link element exchanged between the first and second TDLS STAs; and
including, in TDLS setup frames exchanged between the first and second TDLS STAs, a Multi-Link Link Information element which contains a Link ID bitmap indicating the off-link.

Each of these operations advantageously limits overhead while recycling and/or slightly modifying existing element and/or frames.

Embodiments of the invention also provide a communication method in a wireless network, comprising, at an access point, AP, multi-link device:
instantiating an affiliated Virtual AP defining an off-link corresponding to at least one off-channel that does not overlap the channel(s) used by the AP MLD, the affiliated Virtual AP being assigned a link identifier, ID, thus identifying the off-link, the Virtual AP performing no communication in its Basic Service Set, BSS; and
transmitting to the non-AP MLD information about the affiliated Virtual AP defining the off-link, including the link ID.

The advantages of using a Virtual AP defining the off-link have already been discussed above.

In various embodiments, the method further comprises receiving a trigger for said instantiating of the affiliated Virtual AP, wherein the trigger belongs to the group comprising:
receiving from the non-AP MLD a Probe Request frame including an off-link capability, as a new input in the Extended Capabilities, and/or a Channel Usage element in case the non-AP MLD is not yet associated with the AP MLD;
receiving from the non-AP MLD a Channel Usage Request frame in case the non-AP MLD is yet associated with the AP MLD, the Channel Usage Request frame including a Channel Usage element requesting the setup of the off-link;
receiving a Quality of service, QoS, characteristic; and
detecting a trigger internal to the AP MLD.

In some implementations, the information about the affiliated Virtual AP comprises, in addition to the link ID, one or several parameters belonging to the group comprising: operating class;
channel number;
channel width to define an operating frequency band;
BSSID;
information relating to BSSID indicating that the Virtual AP is not reachable (e.g. AP Reachability field from the BSSID Information element such as defined in IEEE P802.11-REVme/D1.3); and
Non-Inheritance element.

In some embodiments, the Virtual AP can be distinguished, from an AP able to perform communication, using a particular value of an AP Reachability field from the BSSID Information element (e.g. such as defined in IEEE P802.11-REVme/D1.3).

This advantageously limits overhead while reusing the existing AP Reachability field.

In various embodiments, the information about the affiliated Virtual AP is at least partially exchanged as a part of a Multi-link element in a Probe Response frame or in a beacon frame or in an Association Response frame, and:
the affiliated Virtual AP is declared as an additional STA in the Multi-link element with a dedicated per STA profile subelement containing information to discriminate the affiliated Virtual AP from other affiliated APs of the AP MLD; or
a Common Info field of the Multi-link element includes an off-link Bitmap or Virtual AP Bitmap subfield.

Each of these configurations advantageously limits overhead while recycling and/or slightly modifying existing element and/or frames.

In various embodiments, the per STA profile subelement dedicated to the affiliated Virtual AP:
comprises a Non-Inheritance element carrying at least one of AP capabilities or operations that are useless for the Virtual AP context which performs no communication in its Basic Service Set, BSS, and shall not be inherited by the Virtual AP from a reporting STA; or
is not subject to inheritance.

This avoids unnecessary inheritance.

In various embodiments, the information about the affiliated Virtual AP is at least partially exchanged as a part of a Neighbor Report element or a Reduced Neighbor Report element comprised in a beacon frame, said part being an off-link field or a Usage Mode field comprised in a MLD Parameters subfield and giving information relating to the link corresponding to the content of a Link ID field also comprised in the MLD Parameters subfield.

Each of these configurations advantageously limits overhead while recycling and/or slightly modifying existing element and/or frames.

In various embodiments, the information about the affiliated Virtual AP comprises information about the at least one off-channel of the AP MLD which is exchanged as a Channel Usage element:
which includes:
   a Link ID Information field containing said link ID and associated with all Channel entries of a Channel Entry field; or
   a Link ID Information subfield of a Channel Entry field, containing said link ID and associated with all Channel entries of the Channel Entry field; and
which is included in a Probe Response frame or a Channel Usage Response frame.

Each of these configurations advantageously limits overhead while recycling and/or slightly modifying existing element and/or frames.

In some embodiments, obtaining the link ID includes creating, by the non-AP MLD, a TDLS link, with own link ID, that defines the off-link corresponding to at least one off-channel that does not overlap the channel(s) used by the AP device. This implementation advantageously takes benefits of MLD capabilities of the non-AP MLDs involved in the peer-to-peer communication with a connection with a legacy AP, i.e. an AP that does not support Multi-Link features.

In some specific embodiments, creating the TDLS link includes triggering a creation of the same TDLS link at the other non-AP MLD. That means the two non-AP MLDs that desire to directly exchange therefore simultaneously create the same off-link to this purpose. This configuration hence facilitates the immediate and temporary creation of an off-link for a temporary direct links session.

In some embodiments, establishing the TDLS direct link includes performing, with the second TDLS STA, a TDLS direct-link establishment targeting the created off-link. In other words, establishing the TDLS direct link comprises setting up the TDLS direct link using the link ID to define the off-link as the TDLS direct link.

This means once the off-link has been created (at both sides) independently to any link setup with the AP device, the two non-AP MLDs can use conventional TDLS direct link mechanisms to setup a TDLS direct link on the off-link. This configuration fully integrates standardized mechanisms.

In some embodiments, a TDLS Setup frame exchanged during the TDLS direct-link establishment includes a MAC address of the first TDLS STA to identify the created off-link.

As discussed above, in this first case, establishing the TDLS direct link using the new link ID is carried out directly, i.e. using directly the link ID to define the off-link as the TDLS direct link (no channel switch in this case).

In some embodiments, creating the TDLS link includes exchanging TDLS Action frames with the other non-AP MLD, that are tunneled by the AP device, to simultaneously create the off-link at both non-AP MLDs. This allows the non-AP MLDs to use any link setup (and enabled) with the AP device to exchange signaling frames (here TDLS Action frames) with a view of creating and establishing the off-link for direct communication with each other.

In specific embodiments, exchanging TDLS Action frames includes for the non-AP MLD:
sending a link setup request to create an off-link corresponding to at least one candidate off-channel that does not overlap the channel(s) used by the AP device. and
in response thereto, receiving a link setup response including an alternative off-link corresponding to at least one alternative off-channel that does not overlap the channel(s) used by the AP device.

The non-AP MLDs can therefore negotiate the off-link.

In some embodiments, the method further comprises establishing, on a first link setup with the AP device, a first TDLS direct link between the two non-AP MLDs for a first TDLS session and switching the first TDLS session to the off-link.

In some embodiments, switching the first TDLS session to the off-link includes performing a TDLS Link switching to move the first TDLS session to the off-link. The off-link has been created in a previous step. This two-step approach advantageously allows only link IDs to be handled to perform the switch, which link IDs can be reused later on. Dedicated TDLS Action frames can be used for the switching.

In specific embodiments, performing the TDLS Link switching includes directly exchanging TDLS Action frames over the first TDLS direct link. This configuration takes advantage of the already-established TDLS direct link to efficiently (quickly) move to the off-link, usually with a view to release the already-established TDLS direct link (on the first link) once the switching is done. This aims at reducing access competition on the first link.

In some embodiments, switching the first TDLS session to the off-link includes performing a TDLS Channel switching that targets the off-channel or off-channels of the off-link to move the first TDLS session to the off-link. This configuration may advantageously rely on a conventional (standardized) TDLS direct link mechanism (so-called “TDLS channel switching” in section 11.20.6 of the REVme 2.0) to simultaneously disable the TDLS direct link on the first link and enable (or setup) a TDLS direct link on the off-link in the meaning of the invention.

In some embodiments, the method further comprises removing or disabling the first link setup with the AP device. This advantageously does not remove or disable the TDLS direct link on the off-link since the latter has been created independently to the first link. This configuration ensures the affiliated STAs of the non-AP MLDs have no longer the need to continue an activity with the corresponding AP (e.g. such as switching back to the channel of the AP).

Thus, the channel(s) corresponding to the removed or disabled link can be reused and these network resources are therefore optimized.

According to alternative implementations, removing or disabling the first link may include one of:
updating a TID-To-Link mapping of the links setup with the AP device, to remove all TIDs assigned to the first link, and
performing a multi-link setup with the AP device that excludes the first link.

In some embodiments, the link ID defining the off-link is selected from a set of candidate link IDs deprived of any link ID used by the AP device. For example, it may be selected from values above 15. This configuration ensures conflicts between link IDs are avoided at the non-AP MLDs.

In some embodiments, the method further comprises, responsive to creating the off-link, notifying the AP device about the created off-link. The off-channel or off-channels and possibly the link ID may be notified. This allows the AP to adjust its management of the BSS, e.g. by avoiding using off-channels competing with the created off-link.

In some embodiments, the off-link is assigned a BSSID, Basic Service Set Identifier, set to a MAC address of one of the TDLS STAs or of one of the two non-AP MLDs. That means the first and second TDLS STAs operate on a dedicated BSS (identified by the BSSID) that is separate from the AP device, although other affiliated stations of the non-AP MLDs can operate in the BSS managed by the AP device. This configuration advantageously allows defining the ad-hoc BSS without modifying the existing information elements, in particular the Link Identifier IE.

In some embodiments, obtaining the link identifier includes obtaining, from the AP device, recommended channels that are not infrastructure BSSs or an off-channel TDLS direct link, and selecting the off-channel or off-channels from the recommended channels.

In some embodiments, the TDLS Action frames include a multi-link element having one or several per-STA profiles to respectively signal one or more off-channels for the off-link.

This configuration allows the TDLS STAs to define a multiple-channel off-link using existing IEs. In that case, all the off-channels may be used to define the created off-link.

However, the configuration may alternatively allow the TDLS STAs (e.g. the first TDLS station) to define multiple candidate channels for the off-link to create. In that case, the responding TDLS STA may select one of the candidate channels as defined in the per-STA profiles (e.g. the channel that best suits the capabilities of the responding station) to form/create the off-link.

Correlatively, embodiments of the invention also provide a wireless communication device comprising at least one microprocessor configured for carrying out any method as described above.

Another aspect of the invention relates to a Tunneled Direct Link Setup, TDLS, Action frame to be exchanged between two non-access point, non-AP, multi-link devices, MLDs associated with an AP device, the frame comprising:
an Action field set to a value strictly greater than 10 to indicate the frame is a request to create a TDLS link, with own link ID, that defines an off-link corresponding to at least one off-channel that does not overlap the channel(s) used by the AP device, and
at least one Information Element, IE, defining the link ID and including the at least one off-channel.

Yet another aspect of the invention relates to a Tunneled Direct Link Setup, TDLS, Action frame to be exchanged between two non-access point, non-AP, multi-link devices, MLDs associated with an AP device, the frame comprising:
an Action field set to a value strictly greater than 10 to indicate the frame is a request to move a current TDLS session on a first link having a first link ID to a second link having a second and different link ID, and
at least one Information Element, IE, field indicating the second link ID.

In practice, such frames can be tunneled by the AP device to the other non-AP MLD.

In particular, the second link ID may identify an off-link defined on at least one off-channel that does not overlap the channel(s) used by the AP device.

Also, the at least one IE may include a BSSID field associated with the second link, the BSSID field being set to a MAC address of one of the non-AP MLDs or of one station affiliated to one of the non-AP MLDs.

Another aspect of the invention relates to a non-transitory computer-readable medium storing a program which, when executed by a microprocessor or computer system in a wireless device, causes the wireless device to perform any method as described above.

At least parts of the methods according to the invention may be computer implemented. Accordingly, the present invention may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present invention may take the form of a computer program product embodied in any tangible medium of expression having computer usable program code embodied in the medium.

Since the present invention can be implemented in software, the present invention can be embodied as computer readable code for provision to a programmable apparatus on any suitable carrier medium. A tangible, non-transitory carrier medium may comprise a storage medium such as a floppy disk, a CD-ROM, a hard disk drive, a magnetic tape device or a solid-state memory device and the like. A transient carrier medium may include a signal such as an electrical signal, an electronic signal, an optical signal, an acoustic signal, a magnetic signal or an electromagnetic signal, e.g. a microwave or RF signal.

The names of the information elements (IEs) as provided in the present document intend to reflect those currently used in the 802.11 standards in order to facilitate the reading of the document. Of course, any other naming carrying the same information can be used alternatively.

### BRIEF DESCRIPTION OF THE DRAWINGS

Embodiments of the invention will now be described, by way of example only, and with reference to the following drawings in which:

FIG. 1 illustrates a typical 802.11 network environment involving ML transmissions between MLDs in which a single link Tunneled Direct Link Setup, TDLS, direct link is established;

FIGS. 1a and 1b illustrate an exemplary 802.11be multi-link reference model for a MLD either AP MLD or non-AP MLD;

FIG. 2 illustrates, using frame exchanges in a timeline, a possible scenario for discovery and association process between a non-AP MLD and an AP MLD;

FIG. 2a illustrates, using frame exchanges in a timeline, a possible scenario for an initiator peer non-AP STA to handle P2P traffic;

FIG. 3 illustrates the format of 802.11 Action frames according to the 802.11 standards;

FIG. 4a illustrates a so-called “Link Identifier” IE according to the 802.11 standards;

FIG. 4b illustrates a so-called “TDLS Multi-Link” IE according to the 802.11 standards;

FIG. 4c illustrates a so-called “Multi-Link Link” IE according to the 802.11 standards;

FIG. 5a1 illustrates a so-called “Basic variant Multi-Link” IE according to the 802.11 standards;

FIG. 5a2 illustrates a so-called “Per-STA Profile” subelement according to the 802.11 standards;

FIG. 5b illustrates a “Per-STA Profile” subelement amended according to embodiments of the present invention;

FIG. 6 illustrates a so-called “Channel Usage” IE according to the 802.11 standards;

FIG. 6a illustrates a “Channel Usage” IE amended according to embodiments of the present invention;

FIG. 6b illustrates a “Channel Usage” IE amended according to other embodiments of the present invention;

FIG. 6c illustrates a Channel Usage Request frame;

FIG. 7a illustrates an 802.11 network environment involving multi-radio devices MLDs as of FIG. 1 in which embodiments of the present invention may be implemented;

FIG. 7b illustrates another 802.11 network environment involving multi-radio devices MLDs as of FIG. 1 in which embodiments of the present invention may beateras que implemented;

FIG. 7c illustrates example operations of wireless communications, in accordance with certain aspects of the present invention, performed by an AP MLD for the instantiation of a virtual AP;

FIG. 7d illustrates example operations of wireless communications, in accordance with certain aspects of the present invention, performed by a non-AP MLD for the TDLS setup on an off-link;

FIG. 8 illustrates, using frame exchanges in a timeline, the scenario of FIGS. 2 and 2a when an AP MLD notifies a TDLS initiator non-AP MLD that an off-link is available to handle P2P traffic;

FIG. 8b illustrates, using frame exchanges in a timeline, the scenario of FIGS. 2 and 2a when a non-AP MLD already associated with an AP MLD requests the creation of an off-link for P2P traffic through a Channel Usage Request frame;

FIG. 8c illustrates, using frame exchanges in a timeline, the scenario of FIGS. 2 and 2a when non-AP MLDs already associated with an AP MLD perform a TDLS setup on a link shared with the AP and move to the off-link by using a TDLS channel switch;

FIG. 9 illustrates the format of a reduced Neighbor Report (RNR) information element that is present in every beacon;

FIG. 9a illustrates a TBTT Information field (included in a RNR information element) comprising a MLD Parameters field amended according to a particular embodiment of the present invention (by including a new Off-link field);

FIG. 9b illustrates a TBTT Information field (included in a RNR information element) comprising a MLD Parameters field amended according to another particular embodiment of the present invention (by including a new Usage Mode field);

FIG. 10a shows a schematic representation a communication device according to at least one embodiment of the present invention;

FIG. 10b illustrates schematically the architecture of the communication device of FIG. 10a;

FIG. 11a illustrates an 802.11 network environment involving non-AP multi-radio devices MLDs associated to an AP device in which embodiments of the present invention may be implemented;

FIG. 11b illustrates, using a flowchart, exemplary steps for direct communications, in accordance with certain aspects of the present invention;

FIG. 11c illustrates, using frame exchanges in a timeline, the creation and use of an off-link according to embodiments of the invention, wherein the Channel Usage information is obtained from a Probe Response frame;

FIG. 11d illustrates, using frame exchanges in a timeline, the creation and use of an off-link according to other embodiments of the invention, wherein the Channel Usage information is obtained from a Channel Usage Response frame;

FIG. 12a illustrates another 802.11 network environment involving multi-radio devices MLDs as of FIG. 1 in which embodiments of the present invention may be implemented;

FIG. 12b illustrates, using a flowchart, exemplary steps for direct communications, in accordance with certain aspects of the present invention; and

FIGS. 12c and 12d illustrate, using frame exchanges in a timeline, two different scenarios for creating and using an off-link according to embodiments of the invention.

### DETAILED DESCRIPTION OF EMBODIMENTS

The techniques described herein may be used for various broadband wireless communication systems, including communication systems that are based on an orthogonal multiplexing scheme. Examples of such communication systems include Spatial Division Multiple Access (SDMA) system, Time Division Multiple Access (TDMA) system, Orthogonal Frequency Division Multiple Access (OFDMA) system, and Single-Carrier Frequency Division Multiple Access (SC-FDMA) system. A SDMA system may utilize sufficiently different directions to simultaneously transmit data belonging to multiple user terminals, i.e. wireless devices or STAs. A TDMA system may allow multiple user terminals to share the same frequency channel by dividing the transmission signal into different time slots or resource units, each time slot being assigned to different user terminal. An OFDMA system utilizes orthogonal frequency division multiplexing (OFDM), which is a modulation technique that partitions the overall system bandwidth into multiple orthogonal sub-carriers or resource units. These sub-carriers may also be called tones, bins, etc. With OFDM, each sub-carrier may be independently modulated with data. A SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers.

The teachings herein may be incorporated into (e.g., implemented within or performed by) a variety of apparatuses (e.g., STAs). In some aspects, a wireless device or STA implemented in accordance with the teachings herein may comprise an access point (so-called AP) or not (so-called non-AP STA or STA).

While the examples are described in the context of WiFi® networks, the invention may be used in any type of wireless networks like, for example, mobile phone cellular networks that implement very similar mechanisms.

An AP may comprise, be implemented as, or known as a Node B, Radio Network Controller (“RNC”), evolved Node B (eNB), 5G Next generation base STA (gNB), Base STA Controller (“BSC”), Base Transceiver STA (“BTS”), Base STA (“BS”), Transceiver Function (“TF”), Radio Router, Radio Transceiver, Basic Service Set (“BSS”), Extended Service Set (“ESS”), Radio Base STA (“RBS”), or some other terminology.

A non-AP STA may comprise, be implemented as, or known as a subscriber STA, a subscriber unit, a mobile STA (MS), a remote STA, a remote terminal, a user terminal (UT), a user agent, a user device, user equipment (UE), a user STA, or some other terminology. In some implementations, a STA may comprise a cellular telephone, a cordless telephone, a Session Initiation Protocol (“SIP”) phone, a wireless local loop (“WLL”) STA, a personal digital assistant (“PDA”), a handheld device having wireless connection capability, or some other suitable processing device connected to a wireless modem. Accordingly, one or more aspects taught herein may be incorporated into a phone (e.g., a cellular phone or smart phone), a computer (e.g., a laptop), a tablet, a portable communication device, a portable computing device (e.g., a personal data assistant), an entertainment device (e.g., a music or video device, or a satellite radio), a global positioning system (GPS) device, or any other suitable device that is configured to communicate via a wireless or wired medium. In some aspects, the non-AP STA may be a wireless node. Such wireless node may provide, for example, connectivity for or to a network (e.g., a wide area network such as the Internet or a cellular network) via a wired or wireless communication link.

An AP manages a set of STAs (registered to it or associated with it) that together organize their accesses to the wireless medium for communication purposes. The STAs (including the AP to which they register) form a service set, here below referred to as basic service set, BSS (although other terminology can be used). A same physical STA acting as an access point may manage two or more BSS (and thus corresponding WLANs): each BSS is thus uniquely identified by a specific basic service set identification, BSSID and managed by a separate virtual AP implemented in the physical AP. Each STA is identified within a BSS thanks to an identifier, AID, assigned to it by the AP upon registration.

The 802.11 family of standards define various media access control (MAC) mechanisms to drive access to the wireless medium.

The current discussions in the task group 802.11be, as illustrated by draft IEEE P802.11be/D2.2 of October 2022, introduce the Multi-Link Operation (MLO) when it comes to MAC layer operation. The MLO allows multi-link devices to establish or setup multiple links and operate them simultaneously. Those links are referred to as “setup links” or “setup communication links”.

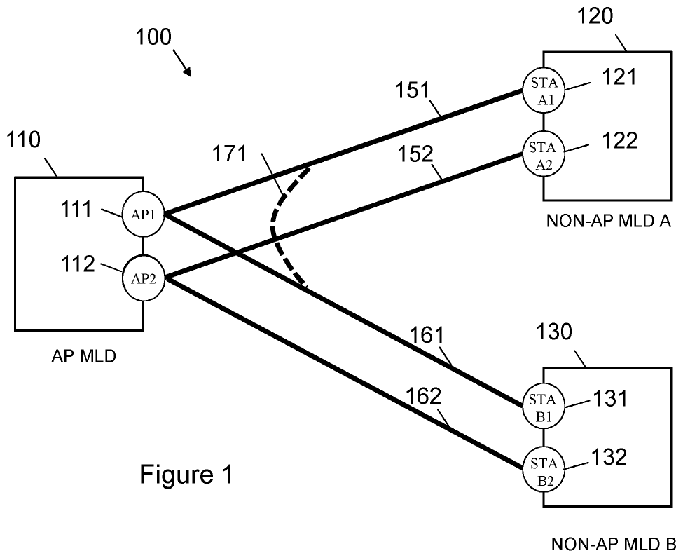

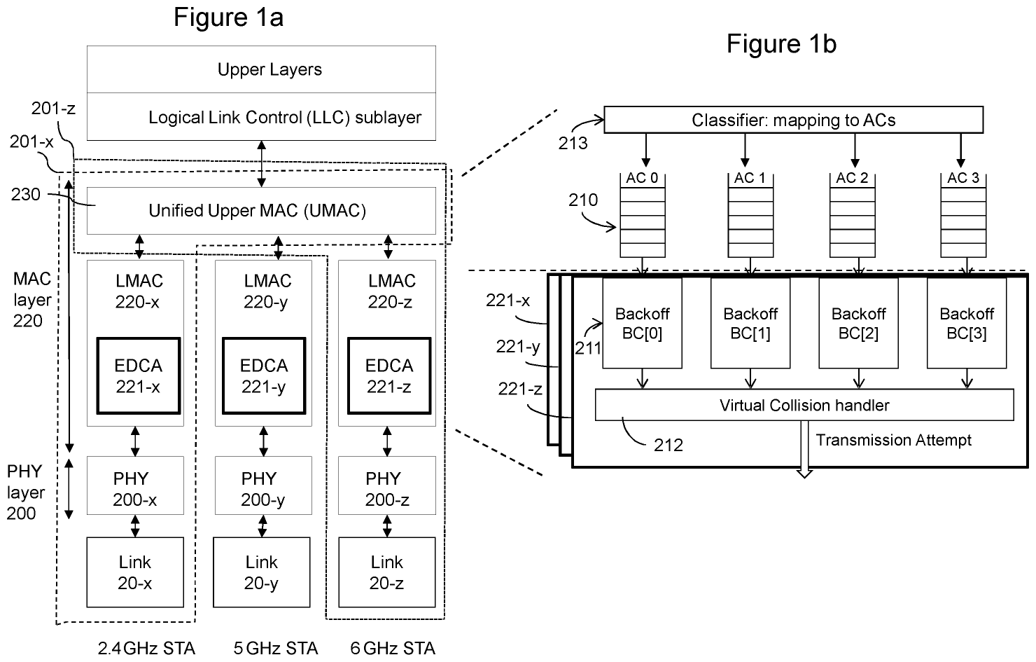

A Multi-Link Device (MLD) is a logical entity and has more than one affiliated STA (STA) and has a single medium access control (MAC) service access point (SAP) to logical link control (LLC), which includes one MAC data service. An Access Point Multi-Link Device (or AP MLD) then corresponds to a MLD where each STA affiliated with the MLD is an AP, hence referred to as “affiliated AP”. A non-Access Point Multi-Link Device (or non-AP MLD) corresponds to a MLD where each STA affiliated with the MLD is a non-AP STA, referred to as “affiliated non-AP STA”. Depending on the literature, “multilink device”, “ML Device” (MLD), “multilink logical entity”, “ML logical entity” (MLE), “multilink set” and “ML set” are synonyms to designate the same type of ML Device. An illustrative architecture of a Multi-Link Device is described below with reference to FIGS. 1a and 1b.

Multiple affiliated non-AP STAs of a non-AP MLD can then setup communication links with multiple affiliated APs of an AP MLD, hence forming a multi-link channel.

The communication links (or “enabled links”) setup for MLDs are theoretically independent, meaning that the channel access procedure (to the communication medium) and the communication are performed independently on each link. Hence, different setup communication links may have different data rates (e.g. due to different bandwidths, number of antennas, etc.) and may be used to communicate different types of information (each over a specific link).

A setup communication link or enabled link or merely “link” thus corresponds to a given channel (e.g. 20 MHz, 40 MHz, and so on) in a given frequency band (e.g. 2.4 GHz, 5 GHz, 6 GHz) between an AP affiliated with the AP MLD and a non-AP STA affiliated with the non-AP MLD.

The affiliated APs and non-AP STAs operate on their respective channels in accordance with one or more of the IEEE 802.11 standards (a/b/g/n/ac/ad/af/ah/aj/ay/ax/be) or other wireless communication standards.

Thanks to the multi-link aggregation, traffic associated with a single MLD can theoretically be transmitted across multiple parallel communication links, thereby increasing network capacity and maximizing utilization of available resources.

From architecture point of view, a MLD contains typically several radios in order to implement its affiliated STAs but not necessary a number equal to its number of affiliated STAs. In particular, a non-AP MLD may operate with a number of affiliated STAs greater than its number of radios (which can even be reduced to a single one).

FIG. 1 illustrates a typical 802.11 network environment involving ML transmissions between MLDs in which a single link Tunneled Direct Link Setup, TDLS, direct link according to the D2.2 standard can be established.

Wireless communication network 100 involves an AP MLD 110 and two non-AP MLDs 120 and 130. Of course, another number of non-AP MLDs registering to the AP MLD 110 and then exchanging frames with it may be contemplated.

One of the two non-AP MLDs may be a legacy 802.11 station. In that case, the “affiliated non-AP STA” mentioned below merely refer to the legacy station itself.

AP MLD 110 has multiple affiliated APs, two affiliated APs 111 and 112 (also referenced AP1, AP2 respectively) in the exemplary FIG. 1, each of which behaves as an 802.11 AP over its operating channel within one frequency band. Known 802.11 frequency bands include the 2.4 GHz band, the 5 GHz band and the 6 GHz band. Of course, other frequency bands may be used in replacement or in addition to these three bands.

The non-AP MLDs 120,130 have multiple affiliated non-AP STAs, each of which behaves as an 802.11 non-AP STA in a BSS (managed by an affiliated AP 111 or 112) to which it registers. In the exemplary FIG. 1, two non-AP STAs 121 and 122 (also referenced A1 and A2 respectively) are affiliated with non-AP MLD 120 and two non-AP STAs 131 and 132 (also referenced B1 and B2 respectively) are affiliated with non-AP MLD 130.

For example, AP 111 is set to operate on channel 38 corresponding to an operating 40 MHz channel in the 5 GHz frequency band and AP 112 is set to operate on channel 151 corresponding to another operating 40 MHz channel in the 5 GHz frequency band too. In another example, the affiliated STAs could operate on different frequency bands.

Each affiliated AP offers a link towards the AP MLD 110 to the affiliated non-AP STAs of a non-AP MLD (120 or 130). Hence, the links for each non-AP MLD can be merely identified with the identifiers of the respective affiliated APs. In this context, each of the affiliated APs 111 and 112 can be identified by an identifier referred to as “Link ID”. The Link ID of each affiliated AP is unique and does not change during the lifetime of the AP MLD. AP MLD may assign the Link ID to its affiliated APs by incrementing the IDs from 0 (for the first affiliated AP). Of course, other wording, such as “AP ID”, could be used in a variant.

To perform multi-link communications, each non-AP MLD 120, 130 has to discover, authenticate, associate and set up multiple links with the AP MLD 110, each link being established between an affiliated AP of the AP MLD 110 and an affiliated non-AP STA of the non-AP MLD. Each of such setup communication links, referred to as “enabled link”, enables individual channel access and frame exchanges between the non-AP MLD and the AP MLD based on supported capabilities exchanged during association.

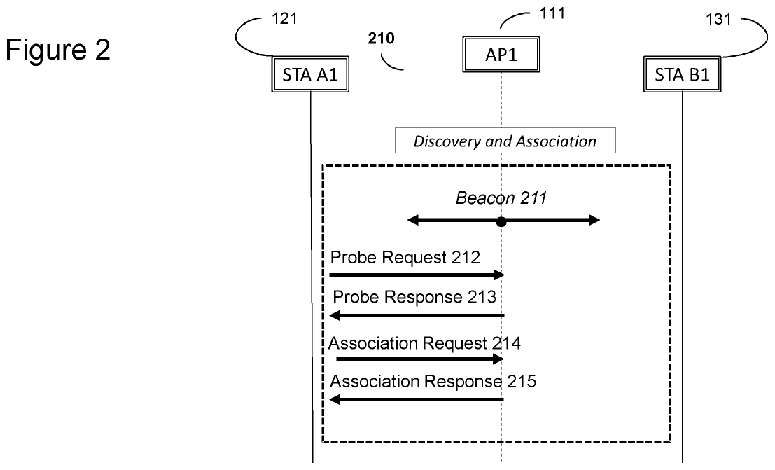

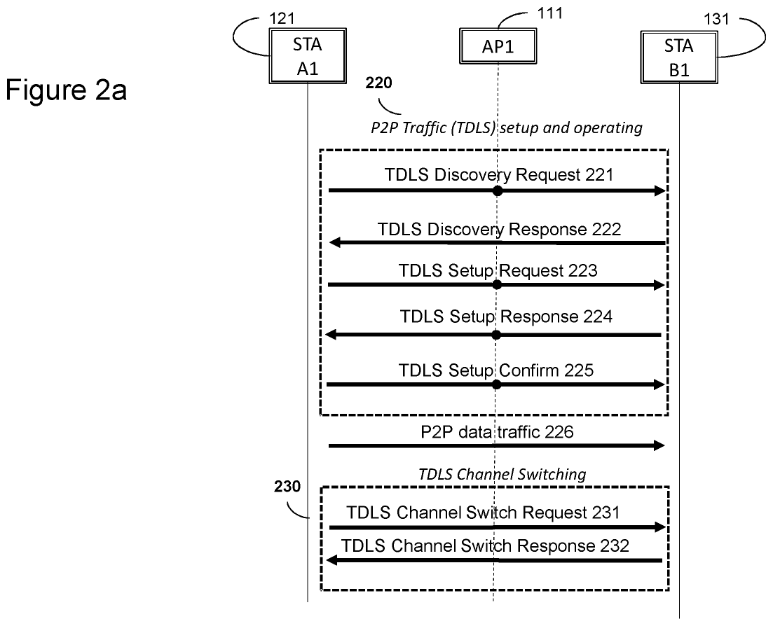

FIG. 2 illustrates, using frame exchanges in a timeline, a possible scenario for discovery and association process between a non-AP MLD and an AP MLD.

The example involves STA A1 121 affiliated to the non-AP MLD 120 and AP1 111 affiliated to the AP MLD 110.

The discovery phase is referred to as ML discovery procedure, and the multi-link setup phase (or association phase) is referred to as ML setup procedure. Management frames exchanged during the ML discovery and ML setup procedures contains a new Information Element specific to the Multi-Link Operation (MLO), referred to as Basic Multi-Link element, which conveys a description of the affiliated STA entities of the MLD sending the frame that are additional to the sending affiliated STA entity (known as “reporting STA”). More precisely, the profile of the reporting STA (i.e. STA sending the frame) is provided in Information Elements, IEs, of the frame outside the Basic Multi-Link element. And, the Basic Multi-Link element carries one or more Per-STA Profile subelement(s) corresponding to each additional affiliated STA (known as “reported STA”).

The ML discovery procedure allows the non-AP MLD to discover the wireless communication network 100, i.e. the various links to the AP MLD offered by the multiple affiliated APs. The ML discovery procedure thus seeks to advertise the various affiliated APs of the AP MLD, together with the respective network information, e.g. including all or part of capabilities and operation parameters. The discovery process mainly relies on the exchange of probe request and probe response between an AP and a non-AP. For ML discovery, the discovery may be performed either by using a probe request/response frame exchange per link or one ML probe request/response frame exchange carrying all the information of the various APs affiliated to the AP MLD on one of the available links. Moreover, the discovery may be based on active or passive scanning. In an active scanning, a non-AP STA transmits a probe request 212 (with a wildcard SSID) and waits for a probe response 213 from an AP. In the passive scanning, the non-AP STA listens on each channel for beacons 211 sent periodically by an AP on its operating channel and then transmits a probe request 212 with the SSID corresponding to its interested AP.

When sent by a non-AP MLD for instance non-AP MLD 120 through the STA A1 121, a probe request frame 212 allows the affiliated non-AP station to request an affiliated AP (AP to 111) include, in addition to its network information, the complete or partial set of capabilities and operation elements (i.e. network information) of other APs affiliated with the same AP MLD.

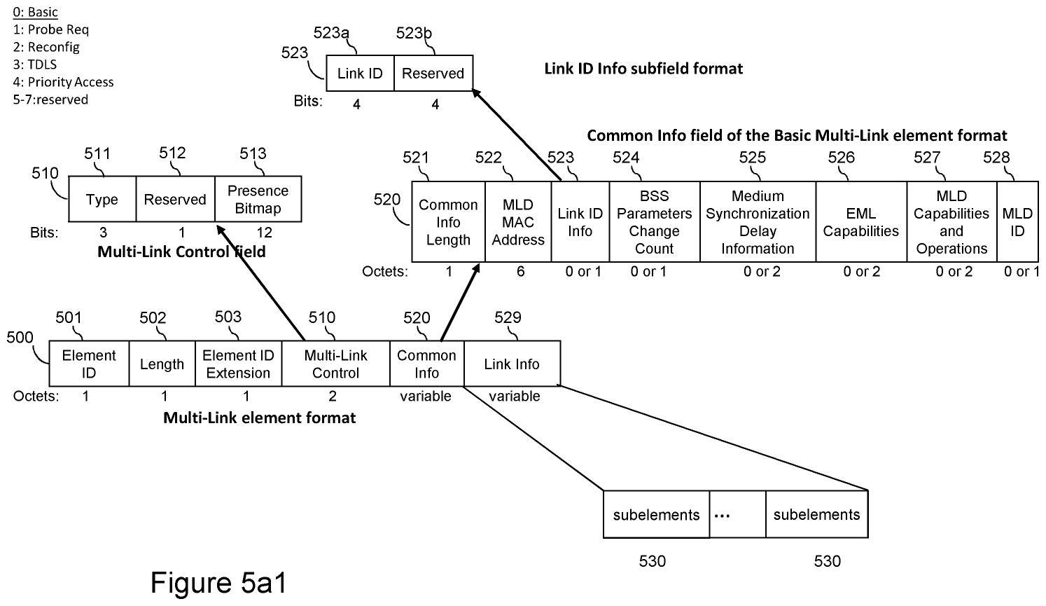

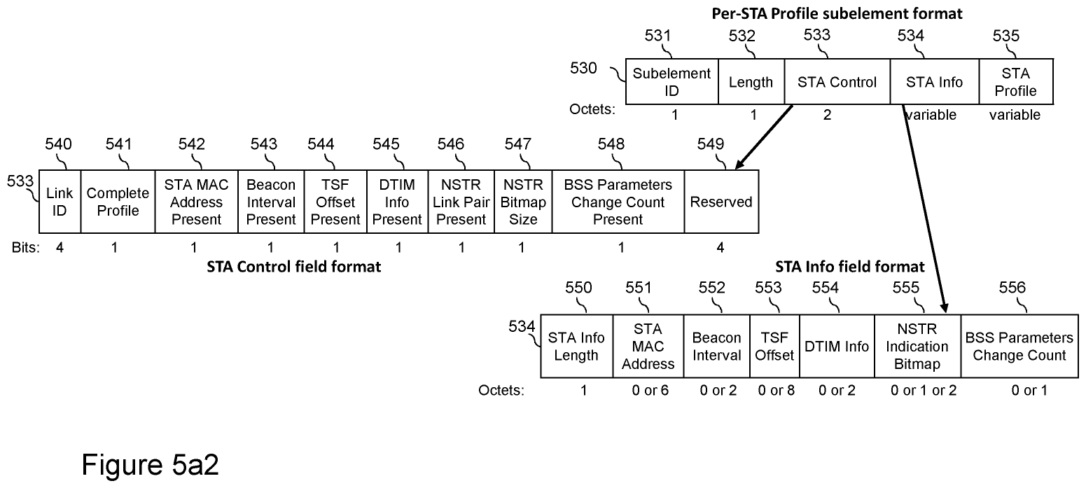

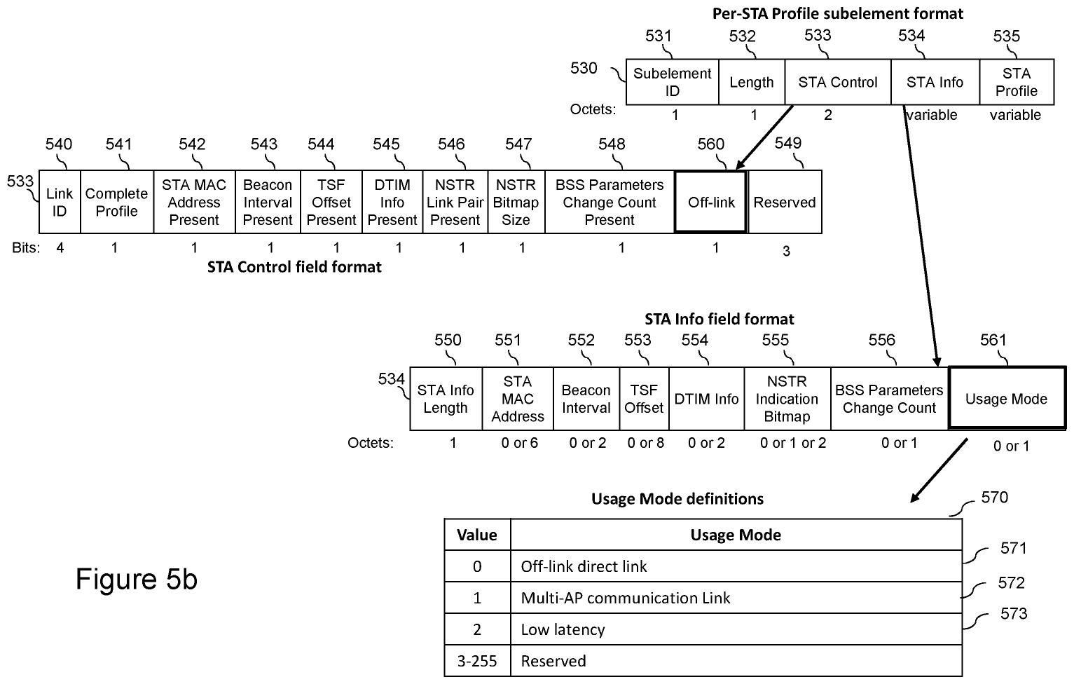

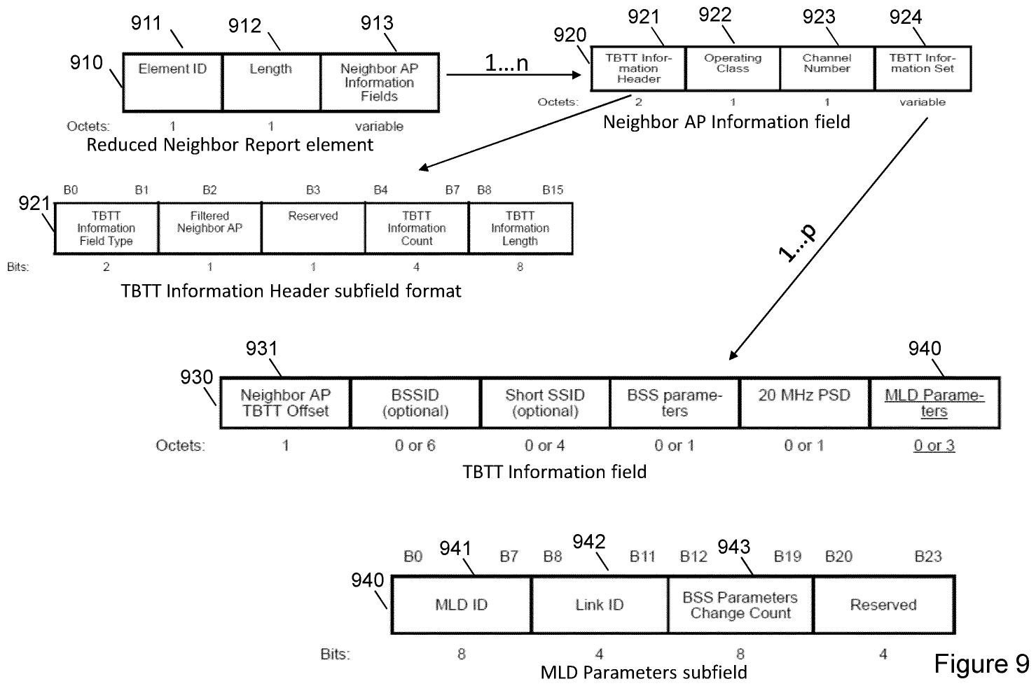

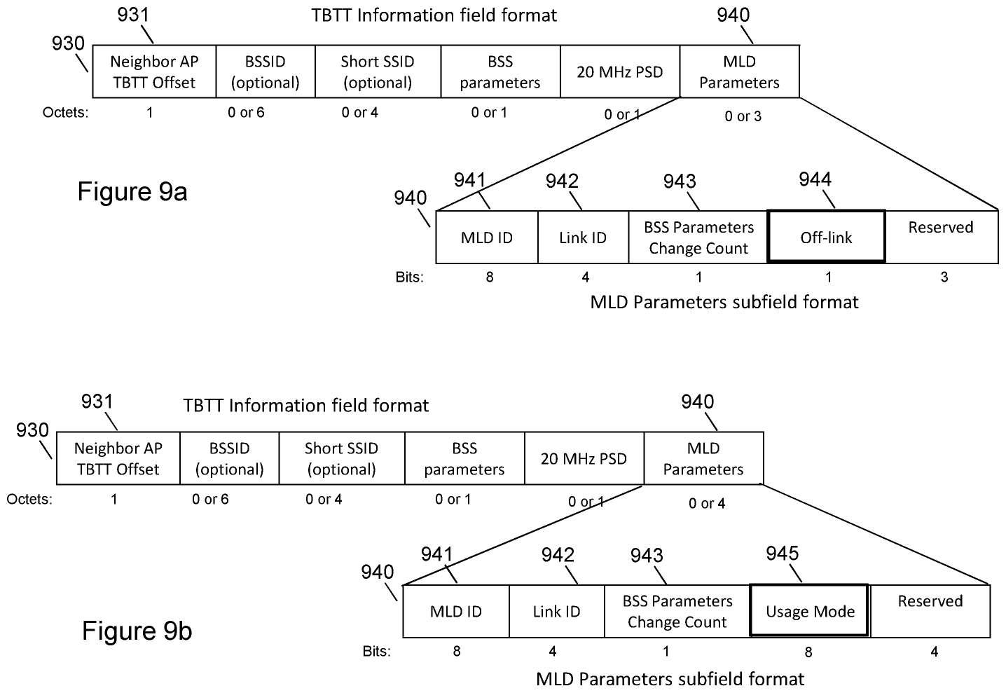

When sent by an AP MLD for instance AP MLD 110 through the AP1 111, a beacon frame 211 or probe response frame 213 includes both a Reduced Neighbor Report element (further described in FIG. 9) containing channel and other information related to neighbor APs, and a Basic Multi-Link element carrying one or more Per-STA Profile subelement(s) which describe all information of the APs affiliated to the AP MLD. The Multi-Link element in its basic variant is described hereafter with reference to the FIGS. 5a1 and 5a2.

Among the various capabilities exchanged by the AP and non-AP during the discovery procedure, a Channel Usage information may be provided in the probe response frame 213 by the AP to the non-AP STA to advise the STA on how to coexist with the infrastructure network, more particularly to recommend channels for BSSs that are not infrastructure BSSs or an off-channel TDLS direct link. The non-AP STAs can hence use the channel usage information as part of channel selection processing for a BSS that is not an infrastructure BSS or an off-channel TDLS direct link.

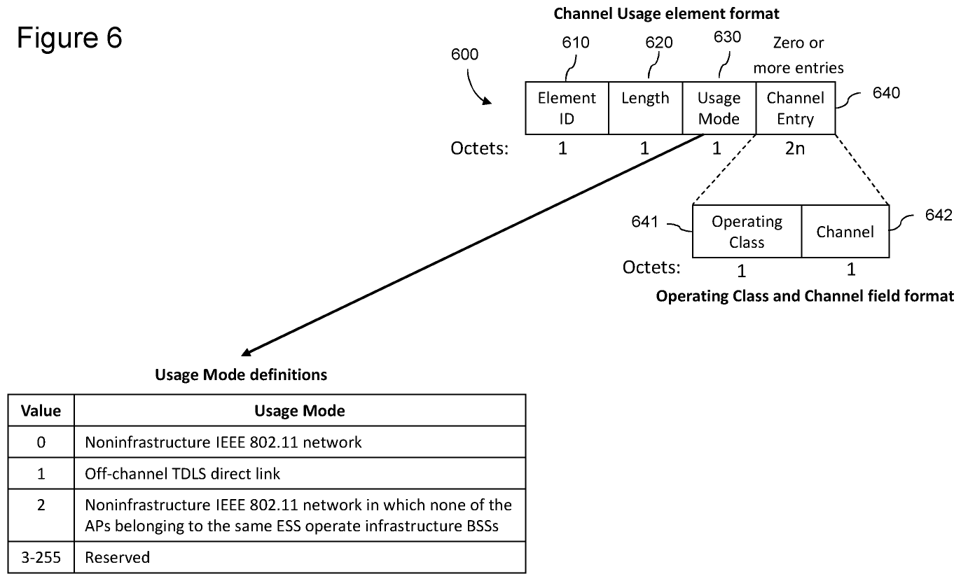

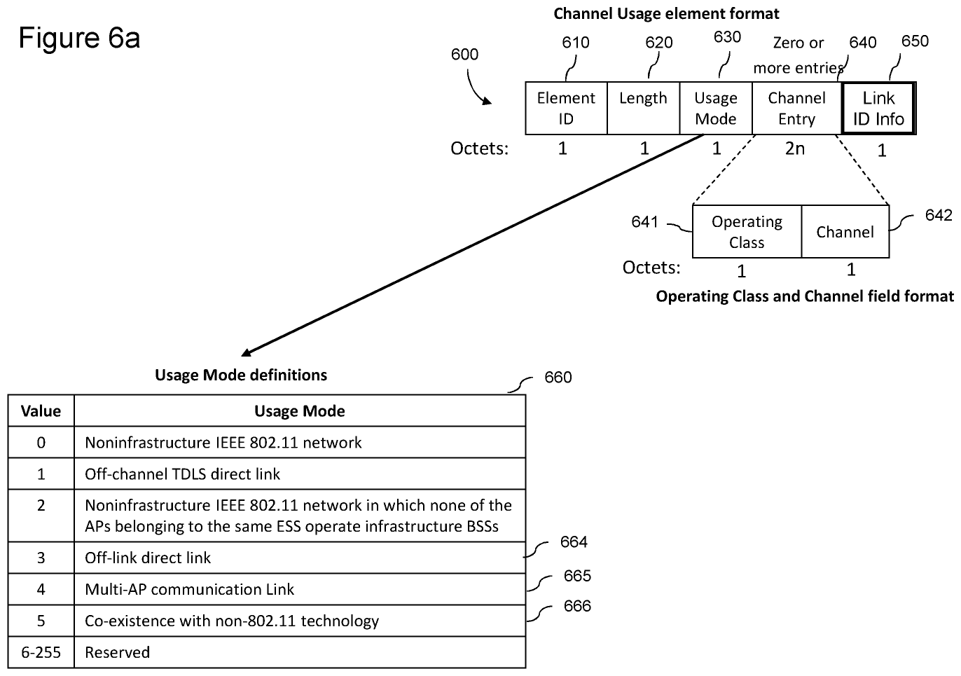

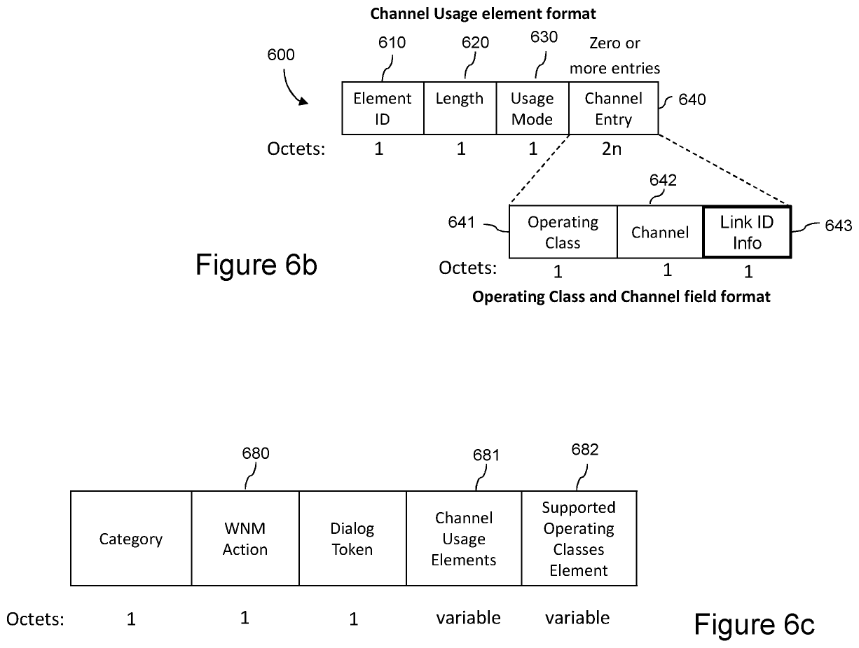

This Channel Usage information is a set of channels provided by an AP to non-AP STAs for operation of a non-infrastructure network or an off-channel TDLS direct link. A non-AP STA that supports Channel Usage and interesting to use a non-infrastructure network or an off channel TDLS direct link may include both Supported Operating Classes (as defined in IEEE 802.11-REVme/D1.3 (June 2022), section 9.4.2.53 Supported Operating Classes element) and Channel Usage (as defined in IEEE 802.11-REVme/D2.0 (October 2022), section 9.4.2.85 Channel Usage element) elements in the probe request frame 212. Then AP supporting Channel Usage shall send a probe response 213 frame including one or more Channel Usage elements. The Channel Usage element is further described with reference to the FIG. 6. We can also note that a non-AP STA supporting Channel Usage may send a Channel Usage Request frame at any time after association to the AP that supports the use of Channel Usage to request the Channel Usage information for supported operating classes, i.e. to request channels for a non-infrastructure network operation or off-channel TDLS direct link operation.

Once a non-AP MLD has discovered the wireless communication network 100 through the ML discovery procedure and after an MLD authentication procedure, the ML setup procedure (based on Association Request 214 and Association Response 215 frames) allows it to select a set of candidate setup links between its own affiliated non-AP STAs and some of the discovered affiliated APs and to request the AP MLD 110 to set up these links, which may be accepted or refused by the AP MLD. If the AP MLD accepts, the non-AP MLD is provided with an Association Identifier (AID) by the AP MLD, which AID is used by the affiliated non-APs of the non-AP MLD to wirelessly communicate over the multiple links (communication channels) with their corresponding affiliated APs.

During the ML setup procedure, the non-AP MLDs declare part or all of their capabilities. For instance, they may declare their Tunneled Direct Link Setup (TDLS) capability, which enables devices (called TDLS peer STAs) to communicate directly to one another when connected to a traditional AP. For this, appropriate fields are provided in the management frames. De facto, in all Management frames, a non-AP MLD which may act as TDLS initiator STA or TDLS responder STA (dot11TunneledDirectLinkSetupImplemented to true) sets the TDLS Support bit (bit 37) in the Extended Capabilities element to 1.

Similarly to the TDLS support, a non-AP MLD or AP MLD may also declare whether the Channel Usage is activated (dot11ChannelUsageActivated is true) and thus allows the devices to exchange their Channel Usage Information, by setting the Channel Usage bit (bit 24) in the Extended Capabilities element to 1.

For illustrative purpose, in wireless communication network 100, during the ML setup procedures, two candidate setup links have been requested by non-AP MLD 120 and accepted by AP MLD 110: a first link 151 between affiliated AP 111 (AP1) and affiliated non-AP STA 121 (A1), a second link 152 between affiliated AP 112 (AP2) and affiliated non-AP STA 122 (A2). Similarly, two candidate setup links have been requested by multi-radio non-AP MLD 130 and accepted by AP MLD 110: a first link 161 between affiliated AP 111 (AP1) and affiliated non-AP STA 131 (B1), a second link 162 between affiliated AP 112 (AP2) and affiliated non-AP STA 132 (B2).

With reference to the FIG. 6, the data payload of a Channel Usage element is shown under reference 600. The Channel Usage element is made up of four fields: an Element ID field 610, a Length field 620, a Usage Mode field 630 and a Channel Entry field 640.

Two different values are defined for the Usage Mode field 630 in the IEEE P802.11-REVme/D2.0 version (October 2022), i.e. value 0 for Non-infrastructure IEEE 802.11 network and value 1 for Off-channel TDLS direct link. Recent adaptation of the standards seeks to provide a new value 2 for Non-infrastructure IEEE 802.11 network in which none of the APs belonging to the same ESS operate infrastructure BSSs. The values 3 to 255 are reserved.

The Channel Entry field 640 includes zero or more Operating Class 641 and Channel 642 fields. The Operating Class field 641 indicates an operating class value. The operating class (defining radio frequencies, channel center frequencies, maximum channel width and behavioral constraints) is interpreted in the context of the country specified in the Beacon frame. The Channel field 642 indicates a channel number, which is interpreted in the context of the indicated operating class. Operating Class and Channel numbers are defined in Annex E in the IEEE P802.11-REVme/D1.3 version. Operating Class and Channel fields can be grouped together to identify a noncontiguous channel as described in 9.4.2.70.3 (Location Indication Channels subelement).

FIG. 9 describes the format of a Reduced Neighbor Report (RNR) information element 910 that is present in every beacon.

Element ID field 911 is equal to value 101 to indicate the type of information element is RNR.

Length field 912 indicated the length in octet of the information element including.

Neighbor AP information Fields field 913 contains a set of one or more (n in the example of the FIG. 9) Neighbor AP Information fields 920, each providing elements on a reported AP different from the reporting AP (AP sending the information element). For instance, in the example of the FIG. 2, beacon 211 will contain at least one Neighbor AP information field 920 corresponding to the AP2 (as reported AP). In addition, several other fields 920 can be present to give information from APs that are not affiliated to the reporting AP MLD but known by the reporting AP (like AP co-located in the same housing but operating different MLDs).

Each Neighbor AP Information field 920 comprises a TBTT information header subfield 921, an Operating Class subfield 922, a Channel Number subfield 923 and a TBTT information Set subfield 924.

The TBTT information header subfield 921 contains several fields that indicate how many TBTT Information fields 930 are present in the TBTT Information Set subfield 924 (TBTT Information count), and their type (TBTT Information Field Type).

Each TBTT Information field 930 comprises a Neighbor AP TBTT Offset subfield 931 and a MLD Parameters subfield 940.

The Neighbor AP TBTT Offset subfield 931 indicates the offset in TUs, rounded down to nearest TU, to the next TBTT of an AP's BSS from the immediately prior TBTT of the AP that transmits this element. The value 254 indicates an offset of 254 TUs or higher. The value 255 indicates an unknown offset value.

The MLD Parameters field 940 contains information relative to a link associated to the reported AP. More precisely, the MLD Parameters field 940 comprises a MLD ID subfield 941, a Link ID subfield 942 and a BSS Parameters Change Count subfield 943.

The MLD ID subfield 941 indicates the identifier of the AP MLD to which the reported AP is affiliated. If the reported AP is affiliated to the same MLD as the reporting AP, the MLD ID subfield 941 is set to 0. If the reported AP is part of another AP MLD, the MLD ID subfield is set to a value higher than 0. For instance, If the reported AP is affiliated to the same MLD as a non-transmitted BSSID that is in the same multiple BSSID set as the reporting AP, the MLD ID subfield 941 is set to the same value as in the BSSID Index field in the Multiple BSSID-Index element in the non-transmitted BSSID profile corresponding to the non-transmitted BSSID.

The Link ID subfield 942 is the unique identifier (within an MLD) of the link.

The BSS Parameters Change Count subfield 943 contains a counter that is incremented (modulo 255) each time a critical parameter of the BSS is updated in the Beacon frame of the reported AP.

The format of the Basic variant Multi-Link element 500 is illustrated in FIGS. 5a1 and 5a2. The Basic variant Multi-Link element 500 includes Element ID field 501, Length field 502 (enabling to know the presence or not of the optional fields as well as the number of Per-STA profiles in field 530), Element ID Extension field 503, Multi-Link Control field 510, Common Info field 520 and optional Link Info field 529.

The Multi-Link Control field 510 includes a Type subfield 511, a Reserved subfield 512 and a Presence Bitmap subfield 513. The Type subfield 511 is set to value 0 in order to signal the Multi-Link element 300 is a Basic variant ML element. The Presence Bitmap subfield 513 informs which parameters are present or not in the Common Info field 520. It includes a Link ID Info Present subfield, a BSS Parameters Change Count Present subfield, a Medium Synchronization Delay Information Present subfield, an EML Capabilities Present subfield, a MLD Capabilities and Operations Present subfield, a MLD ID Present subfield and a Reserved subfield.

The Common Info field 520 always includes a Common Info Length field 521, an MLD MAC Address subfield 522 and according to the values specified in the Presence Bitmap subfield 320, the Common Info field 520 includes optionally a Link ID Info subfield 523, a BSS Parameters Change Count subfield 524, a Medium Synchronization Delay Information subfield 525, an EML Capabilities subfield 526, an MLD Capabilities and Operations subfield 527 and a MLD ID subfield 528.

More precisely, the Link ID Info subfield 523 includes a Link ID subfield 523a and a Reserved field 523b. Link ID subfield 523a conveys the link ID on which the reporting affiliated (AP or non-AP) STA operates.

If the Link Info field 529 is present, one or more Per-STA Profile subelements 530 are included as a list of subelements 530, each describing one reported affiliated (AP or non-AP) STA of the same MLD.

As detailed in FIG. 5a2, the Per-STA Profile subelement 530 includes a Subelement ID field 531, a Length field 532, a STA Control field 533, a STA Info field 534 and a STA Profile field 535.

The STA Control field 533 includes a Link ID subfield 540 which specifies a value that uniquely identifies the link where the reported STA is operating on.

The STA Control field 533 additionally includes a Complete Profile subfield 541, a STA MAC Address Present subfield 542, a Beacon interval Present subfield 543, a TSF Offset Present subfield 544, a DTIM Info Present subfield 545, a NSTR Link Pair Present subfield 546, NSTR Bitmap Size subfield 547, a BSS Parameters Change Count Present subfield 548 and Reserved subfield 549.

The STA MAC Address Present subfield 542 is set to 1 if the STA MAC Address field is present in the STA Info field 534. Otherwise, the subfield is set to 0.

The Beacon interval Present subfield 543 is set to 1 if the Beacon interval subfield is present in the STA Info field 534. Otherwise, the subfield is set to 0.

The TSF Offset Present subfield 544 is set to 1 if the TSF Offset subfield is present in the STA Info field 534. Otherwise, the subfield is set to 0.

The DTIM Info Present subfield 545 is set to 1 in the DTIM Info subfield is present in the STA Info field 534. Otherwise, the subfield is set to 0.

The NSTR Link Pair Present subfield 546 is set to 1 if the NSTR Indication Bitmap subfield is present in the STA Info field 534. Otherwise, the subfield is set to 0.

The BSS Parameters Change Count Present subfield 548 is set to 1 if the BSS Parameters Change Count subfield is present in the STA Info field 534. Otherwise, the subfield is set to 0.

The STA Info field 534 includes a STA Info Length subfield 550 and according to the values specified in the STA Control subfields (542-548), the STA Info field 534 includes optionally a STA MAC Address subfield 551, a Beacon interval subfield 552, a TSF Offset subfield 553, a DTIM Info subfield 554, a NSTR Indication bitmap subfield 555 (whose size depends on the NSTR Bitmap Size subfield) and a BSS Parameters Change Count subfield 556.

The STA Profile field 535 carries variable number of fields and elements in the order defined in the different frame body corresponding to the frame carrying the Multi-Link element. For instance, the STA Profile included in the Multi-Link element carried in the Association Request frame refers to Table 9-62 Association Request frame body.

The per-STA profile shall not include the following elements: a Neighbor Report element, a Reduced Neighbor Report element, a Multiple BSSID element, TIM element, Multiple BSSID-Index element, Multiple BSSID Configuration element or another Basic Multi-Link element in the Per-STA Profile subelement.

FIG. 1a illustrates an exemplary 802.11be multi-link reference model for a MLD either AP MLD or non-AP MLD.

The MLD comprises a PHY layer 200, a MAC layer 220, a logical link control (LLC) sublayer and upper layers. Upper layers may include applications that generate traffic data or use received traffic data.

The transmission and the reception of the traffic data are handled by the MAC 220 and PHY 200 layers. Such transmission and the reception of the traffic data may take place over multiple links 20-x, 20-y, 20-z, as the ones 151, 152, 161, 162 introduced with reference to FIG. 1, as well as over single link TDLS direct link 171 (see FIG. 1) when established. Three links and therefore three affiliated stations are shown in the Figure. Of course, other configurations including two affiliated stations or more than three affiliated stations may be contemplated.

The traffic data are provided by the upper layers as a sequence of data frames, or “traffic stream”. Each traffic stream and thus each data frame is associated with an access category (AC) as defined in the EDCA mechanism (FIG. 1b). This mapping between the streams or data frames and the ACs is made by a classifier 213.

It is recalled that an 802.11 station (AP and non-AP station) maintains four Access Categories (ACs), each having one or more corresponding transmit buffers or queues. The four ACs are conventionally defined as follows:
AC1 and AC0 are reserved for best effort and background traffic. They have, respectively, the penultimate lowest priority and the lowest priority; and
AC3 and AC2 are usually reserved for real-time applications (e.g., voice or video transmission). They have, respectively, the highest priority and the penultimate highest priority.

The data frames, also known as MAC service data units (MSDUs), incoming from an upper layer of the protocol stack are mapped, by a classifier 213, onto one of the four ACs and thus input in a queue of the mapped AC for transmission.

FIG. 1b illustrates an implementation model with four transmit queues, one per access category.

The 802.11be multi-link reference model reflects the fact that MLDs may transmit and receive using several links, particularly at the level of the MAC layer 220 and the PHY layer 200.

The MAC layer 220 comprises one Unified Upper-MAC (UMAC) layer 230, multiple Lower-MAC (LMAC) layers 220-x, 220-y, 220-z coupled with a respective PHY layer 200-x, 200-y, 200-z, each couple corresponding to a link 20-x, 20-y, 20-z.

The UMAC 230 performs functionalities that are common across all links and each LMAC 220-x, 220-y, 220-z performs functionalities that are local to each link 20-x, 20-y, 20-z. The UMAC layer then offers a UMAC interface with the link-specific blocks 220-x, 220-y, 220-z and also provides a UMAC Service Access Point (SAP) to the LLC and upper layers.

The UMAC 230 is responsible for link-agnostic MAC procedures such as authentication, association, security association, sequence number assignments, MAC Protocol Data Unit (MPDU) encryption/decryption, aggregation/de-aggregation, acknowledgement score boarding procedure, etc.

Each data unit, MSDU, arriving at the MAC layer 220 from an upper layer (e.g. Link layer) with a type of traffic (User Priority (UP) hence Traffic Identifier (TID)) priority is mapped onto one of the ACs according to the mapping rule at the UMAC layer 230. Then, still at the UMAC layer 230, the data unit, MSDU, is provided with the next sequence number available and is stored in the queue corresponding to its TID (or UP) within the mapped AC.

Each LMAC 220-x, 220-y, 220-z is in charge of link specific functionalities like the channel access. In particular, each MLD Lower MAC includes its own contention-based channel access procedure, e.g. EDCA 221-x, 221-y, 221-z. Some of the functionalities require joint processing of both the UMAC 230 and LMACs 220-x, 220-y, 220-z.

As illustrated in FIGS. 1a and 1b, each EDCA 221-x, 221-y, 221-z per link performs contention per link for each queue. In that respect, each AC has its own set of queue contention parameters per link, and is associated with a priority value, hence defining traffics of higher or lower priority of MSDUs. Thus, there is a plurality of traffic queues for serving data traffic at different priorities for a given link. The contention window CW and the backoff value are known as being EDCA variables, and are specialized for each link 20-x, 20-y, 20-z.

That means that each AC acts as an independent DCF contending entity on a given link, including its respective queue backoff engine 211. Thus, each queue backoff engine 211 is associated with a respective traffic queue 210 for using queue contention parameters and drawing a backoff value (from CW) to initialize a respective queue backoff counter specialized per AC and per link. The backoff counter is used to contend for access to the link 20-x, 20-y, 20-z in order to transmit data stored in the queue of the AC. Practically, the backoff counter is decremented from its initialization value when the medium is idle, and the corresponding affiliated STA 201-x, 201-z is allowed to transmit (access granted) when the backoff counter reaches 0.

When the access to the wireless medium is granted for an AC on a link, MSDUs stored for that AC are transmitted to the physical (PHY) layer 200-x, 200-y, 200-z for transmission over the link.

The affiliated STA entities 111-121-131 (idem 112-122-132) compete one against each other on their common channel using a conventional EDCA (Enhanced Distributed Channel Access) contention scheme, to access the wireless medium in order to be granted a transmission opportunity (TXOP) and then to transmit (single-user, SU) data frames. The affiliated STAs 121-131 (idem 122-132) may also use a multi-user (MU) scheme in which the affiliated AP 111 (idem 112) of the AP MLD 110 is allowed to schedule a MU transmission, i.e. multiple simultaneous transmissions to or from the stations of its BSS, in the wireless network. One implementation of such a MU scheme has been for example adopted in IEEE Std 802.11ax-2021 standard, as the Multi-User Uplink and Downlink OFDMA (MU UL and DL OFDMA) procedures.

The single link TDLS direct link mechanism in the context of MLDs in now explained with reference to FIG. 2a which illustrates, using frame exchanges in a timeline, a possible scenario for an initiator peer non-AP STA or initiator TDLS peer STA (affiliated non-AP STA) to handle P2P traffic.

This example involves STA A1 121 as the initiator for the P2P communication and STA B1 131 as the partner or responder for the P2P communication 171. They both take part of the same BSS on a given link 1 (151/161), and are associated with AP 111. As mentioned above, STA A1 and STA B1 may be non-AP stations affiliated with respective non-AP MLDs, while AP 111 may be an AP affiliated with an AP MLD 110.

In the sequence, once STA A1 and STA B1 are associated with the AP (association not shown), they can exchange data over their operation link through the AP.

To reduce the amount of traffic that is transferred in the network and prevent congestion at the AP, the IEEE 802.11z amendment has defined mechanisms, known as Tunneled Direct Link Setup (TDLS), that allow the 802.11 non-AP stations to set up a direct link between them, while also remaining associated with the AP. The D2.2 standard upgrades the conventional TDLS mechanism to work with the multi-link feature.

Tunneled direct-link setup (TDLS) is characterized by the use of signaling frames that are encapsulated in 802.11 Data frames so that the signaling frames are transmitted through the AP transparently. Therefore, the AP does not need to be direct-link aware, nor does it have to support the same set of capabilities that are used on the direct link, in order for TDLS to be used.

In the sequence shown, a TDLS session or “TDLS direct link” is established between STA A1 and STA B1 (either of both can be the initiator of the TDLS direct link establishment). The establishment may include a TDLS discovery procedure (optional) and a TDLS setup procedure.

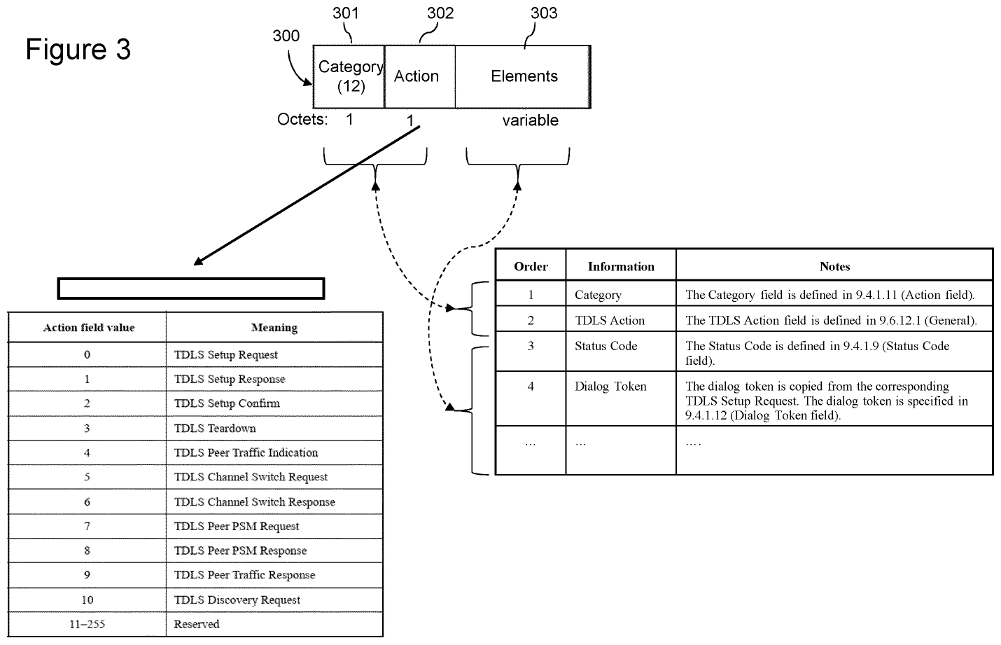

TDLS discovery and setup procedures between STA A1 and STA B1 involve frames, known as TDLS Action frames (see FIG. 3), that are usually sent and received via intermediate AP 111. The TDLS procedure is characterized by encapsulating signalling frames (TDLS Action frames) in 802.11 Data frames, which allows them to be transmitted through the AP transparently (hence “tunneled”).

When attempting to discover TDLS stations in the same BSS, a series of frame exchanges is used. STA A1, which is the initiator in the proposed scenario, sends a TDLS Discovery Request frame 221, tunneled through AP 111 (relay illustrated by the black dot), to an individual destination station, here STA B1.

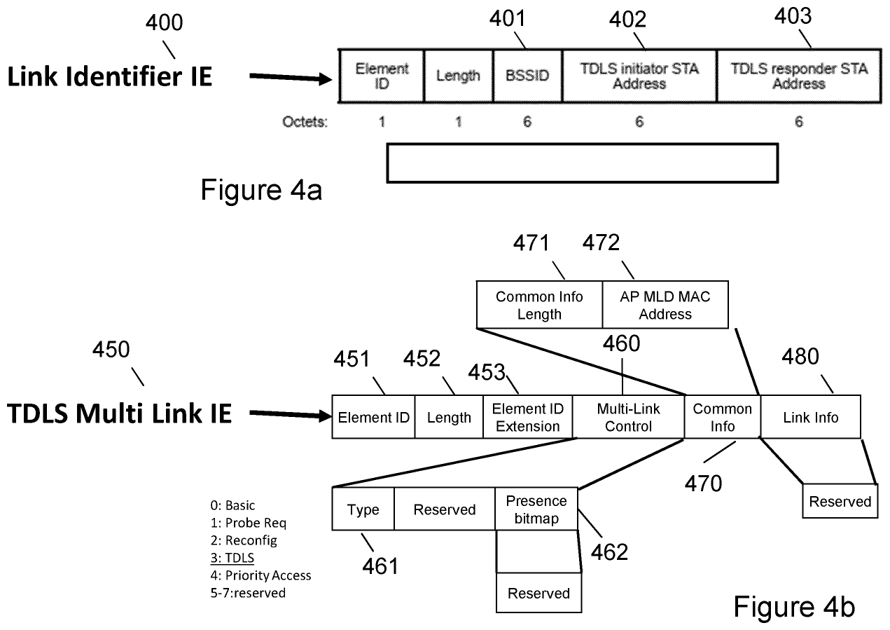

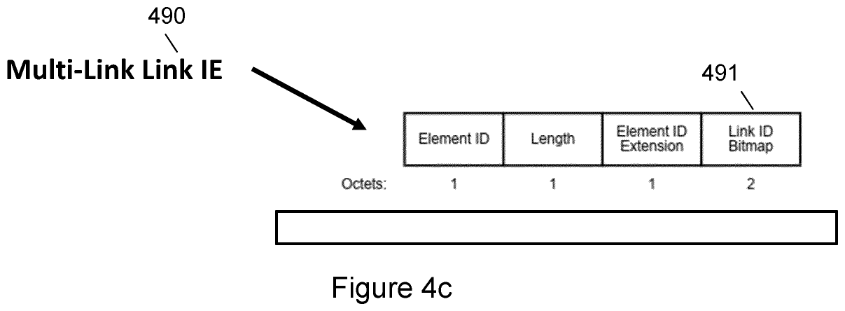

This request frame (as the TDLS Setup Request/Response/Confirm frames and TDLS Discovery Response frame, described below) conveys so-called “Link Identifier” element (see FIG. 4a) and “TDLS Multi-Link” element (see FIG. 4b) amongst the IEs of the Elements field 303. Other IEs forming the Elements field 303 are defined in Table 9-507 as defined in IEEE 802.11-REVme/D2.0 (October 2022).

The Link Identifier element is shown in FIG. 4a under reference 400. It includes a BBSID field 401, a TDLS initiator STA address field 402 and a TDLS responder STA address field 403. The BSSID field 401 is set to the BSSID of the BSS of which the TDLS initiator STA A1 is a member when the frame carrying the element is transmitted by a STA that is not affiliated with a non-AP MLD. Otherwise, in the context of MLD operations, the BSSID field is set to the BSSID of the AP that is operating on the link where the non-AP MLD 120 intends to establish a single link TDLS direct link. The TDLS initiator STA Address field 402 is set to the TDLS initiator's MAC address, which is the MLD MAC address of MLD A 120 in the context of MLD operations. The TDLS responder STA Address field 403 is set to the TDLS responder's MAC address, which is the MLD MAC address of MLD B 130 in the context of MLD operations.

Destination station STA B1 responds to the TDLS Discovery Request frame 221 with a TDLS Discovery Response frame 222 sent directly to STA A1 (without relay by AP 111). This response frame conveys a “Link Identifier” element and a “TDLS Multi-Link” element amongst the IEs of the Elements field 303.

From that point, STA A1 and STA B1 know each other, meaning they know the other operates on the same link setup with AP 111. They can then establish a TDLS direct link.

When attempting to establish a TDLS direct link over a single link with the discovered TDLS station, a series of TDLS Action frame exchanges is used to set up the single link TDLS direct link.

TDLS initiator STA A1 first sends a TDLS Setup Request frame 223, tunneled through AP 111 (relay illustrated by the black dot), to target TDLS responder STA B1. This request frame conveys a “Link Identifier” element and a “TDLS Multi-Link” element amongst the IEs of the Elements field 303. Other IEs forming the Elements field 303 are defined in Table 9-497 as defined in IEEE 802.11-REVme/D2.0 (October 2022), which include information about the capabilities of TDLS initiator STA A1 and an AID thereof.

TDLS responder STA B1 responds with a TDLS Setup Response frame 224, also tunneled through AP 111. This response frame conveys a “Link Identifier” element and a “TDLS Multi-Link” element amongst the IEs of the Elements field 303. Other IEs forming the Elements field 303 are defined in Table 9-498 as defined in IEEE 802.11-REVme/D2.0 (October 2022), which include information about the capabilities of TDLS responder STA B1, its AID plus a status code that either accepts or rejects the setup request.

If the Setup Request is accepted, TDLS initiator STA A1 then sends a confirmation, TDLS Setup Confirm frame 225, still tunneled through AP 111. This confirmation frame conveys a “Link Identifier” element and a “TDLS Multi-Link” element amongst the IEs of the Elements field 303. Other IEs forming the Elements field 303 are defined in Table 9-499 as defined in IEEE 802.11-REVme/D2.0 (October 2022).

This concludes the TDLS setup handshake. At this point, the two non-AP MLDs know the identity of each other on the one hand with their MLD MAC address and on the other hand with the AID assigned by the AP MLD.

During the TDLS setup handshake, the TDLS STAs (initiator and responder) may establish a robust security network association (RSNA) for the TDLS direct link. This security protection for the TDLS direct link follows the security in between the STA and its AP, thereby, if any security method is enabled on the connection between a STA and the AP, the STA requires that a security protocol completes successfully before using a TDLS direct link. If no security method is enabled on the connection between a STA and the AP, the STA does not use any security protocol on the TDLS direct link.

To secure the TDLS direct link, the TDLS STAs use the TDLS PeerKey (TPK) security protocol (as defined in section 12.7.8 in IEEE 802.11-REVme/D2.0 (October 2022)). The TPK key is derived by each TDLS STA during the TDLS setup handshake and relies on Information Elements included in the TDLS frames i.e. “Link Identifier” element, “robust security network” element (RSNE), “Timeout Interval” (TPK key lifetime) or TIE element and “fast BSS transition” or FTE element (as described in the table 399 below). Some information related to the TDLS session itself are used for the TPK derivation. Such information, e.g. the MAC address of the TDLS initiator, the MAC address of the TDLS responder and the BSSID, is directly retrieved from the Link Identifier Element shared between both TDLS STAs. The D2.2 standard has slightly amended this procedure to support the establishment of a single link TDLS direct link by a non-AP MLD. Therefore, to support this new procedure, a “TDLS Multi-Link” element is added in the TDLS setup frames and the AP MLD MAC address conveyed by this “TDLS Multi-Link” element is added as a new parameter to derive the TPK to be used for the multiple link TDLS session.

The stations can then start to communicate directly over link 171 (direct link): P2P traffic 226 can then be directly (not black dot shown at the AP in the Figure for arrow 226) exchanged between STA A1 and STA B1 using the established TDLS session. TDLS peers STA A1 and STA B1 are then configured to accept Data frames received directly from the other peer. The frame exchanges are performed over the same link, that is to say the same frequency channel so that this P2P traffic becomes concurrent to other traffic for AP1 111.

Reference 171 in the FIG. 1 illustrates a single link TDLS direct link that, when established, allows MLD A 120 (through affiliated STA A1 121) and MLD B 130 (through affiliated STA B1 131) to directly exchange data without relay by AP MLD 110.

To avoid the competition with the AP's traffic, the tunneled direct link setup (TDLS) stations that support TDLS channel switching can decide to perform a TDLS Channel Switch to a Supported Channel. The TDLS stations inform each other about their supported channels during the TDLS setup procedure, i.e. the TDLS stations include Supported Channels element and Supported Operating Classes element in all TDLS Setup Request and TDLS Setup Response frames that have a TDLS Channel Switching subfield equal to 1. More advantageously, the TDLS stations may move from the base channel (i.e. the channel corresponding to the link setup with the AP, AP1 111 in the example above) to an off-channel, that is to say a channel that does not overlap the channel(s) used by the access point (AP) with which the TDLS stations are associated. It is recalled that the off-channels available for TDLS are supplied by the AP through the Channel Usage element 600 transmitted in Probe Response 213 or Channel Usage Response frames.

Back to the example of the FIG. 2a, the TDLS STA initiator 121 sends a TDLS Channel Switch Request frame 231 over the TDLS direct link. This frame includes a target channel i.e. the destination off-channel of the intended channel switch. The target channel is specified by the STA that initiates a channel switch, from the set of operating classes supported by both TDLS peer STAs. Upon receiving the TDLS Channel Switch Request frame 231, the target partner STA B1 131 responds with a TDLS Channel Switch Response frame 232 to accept or reject the Channel Switch. If the status code indicated in the response frame is set to REQUEST_DECLINED, both stations continue to operate on the current channel. Otherwise, if the status code is set to SUCCESS in the response frame, both stations shall move to the target channel before a switch time also indicated in the TDLS Channel Switch frames but the first transmission shall not start before the end of the Switch Time. Finally, after the switch time has elapsed, the initiator STA A1 can transmit P2P data frame on the target channel.

The use of the off-channel remains within the operations conducted by the TDLS STAs in the initially established TDLS direct link, i.e. in association with the link ID of the link still setup with AP1 111.

When operating via the off-channel, the TDLS STAs are in power save mode with the AP and can no longer communicate with it over the base channel of the link. Thus, they have to regularly return to the base channel in order to receive beacons, look at the TIM (Traffic Indication Map) for any buffered packets, and communicate with other devices in the network.

Details on the TDLS procedure are provided in IEEE 802.11z, and have been upgraded to be established over one link among possibly multiple links as provided in the D2.2 standard.

FIG. 3 illustrates the format of 802.11 Action frames 300. The Figure only shows the payload of such Action frames, the MAC header being omitted for conciseness.

An Action frame 300 has the format of a frame, hence has a Category field 301, an Action field 302 immediately after the Category field 301 and an Elements field 303.

Various values of the Category field 301 are defined in the 802.11 standard, corresponding to various Actions frames. Category field set to 12 defines a TDLS Action frame, while Category field set to 4 defines a Public Action frame.

TDLS Action frames convey TDLS signalling.

1-byte Action field 302 for a TDLS Action frame may take various values from 0 to 10 (11 to 255 being reserved), as shown in Table 9-496 of the 802.11 Standard (as example, IEEE 802.11-REVme/D2.0 (October 2022)), to signal different types of TDLS Action frames having each its own function in the TDLS mechanism. For example, TDLS Setup Request frame 213 is identified by Action field 302 set to 0; TDLS Setup Response frame 214 by Action field 302 set to 1; TDLS Setup Confirm frame 215 by Action field 302 set to 2; TDLS Channel Switch Request frame 231 by Action field 302 set to 5; TDLS Channel Switch Response frame 232 by Action field 302 set to 6.

Table 399 below is provided for illustrative purposes only, to show exemplary IEs of the Elements field 303 to be provided in TDLS Setup Action frames (i.e. with Action field 302 set to 0, 1 or 2). Each type of TDLS Action frame has its own set of elements 303 to be provided to identify the frame (Category, TDLS Action and Dialog Token as defined in the standard).

The Action field of a TDLS Setup Request Action field contains the information shown below, whereas the corresponding TDLS Setup Response Action field only contains the information if Status Code is SUCCESS.

TABLE 399

| IE | Notes |
|---|---|
| Capability | The Capability field indicates the capabilities of the STA. The |
| | Capability field is defined in 9.4.1.4 (Capability Information field). |
| Supported Rates and | The Supported Rates and BSS Membership Selectors element |
| BSS Membership | indicates the rates that are supported by the STA. The |
| Selectors | Supported Rates and BSS Membership Selectors element is |
| | defined in 9.4.2.3 (Supported Rates and BSS Membership |
| | Selectors element). |
| Country | The Country element is present when |
| | dot11MultiDomainCapabilityActivated is true or |
| | dot11SpectrumManagementRequired is true. The Country |
| | element is defined in 9.4.2.8 (Country element). |
| Extended Supported | The Extended Supported Rates and BSS Membership Selectors |
| Rates and BSS | element is present if there are more than eight supported rates |
| Membership | and BSS membership selectors, and it is optionally present |
| Selectors | otherwise. The Extended Supported Rates and BSS |
| | Membership Selectors element is defined in 9.4.2.12 (Extended |
| | Supported Rates and BSS Membership Selectors element). |
| Supported Channels | The Supported Channels element is present if the TDLS |
| | Channel Switching subfield is equal to 1. |
| | The Supported Channels element is defined in 9.4.2.17 |
| | (Supported Channels element). |
| RSNE | The RSNE is present if security is required on the TDLS direct |
| | link (see 12.7.8.1 (General)). The RSNE is defined in 9.4.2.24 |
| | (RSNE). |
| Extended Capabilities | The Extended Capabilities element is present if any of the fields |
| | in this element are nonzero. The Extended Capabilities element |
| | is defined in 9.4.2.26 (Extended Capabilities element). |
| QoS Capability | The QoS Capability element is present when |
| | dot11QosOptionImplemented is true and not present otherwise. |
| | The QoS Capability element is defined in 9.4.2.34 (QoS |
| | Capability element). |
| FTE | The FTE is present if security is required on the TDLS direct link |
| | (see 12.7.8.1 (General)). The FTE is defined in 9.4.2.47 (Fast |
| | BSS Transition element (FTE)). |
| Timeout Interval | The Timeout Interval element contains the TPK key lifetime and |
| (TPK key lifetime) | is present if security is required on the TDLS direct link (see |
| | 12.7.8.1 (General)). |
| | The Timeout Interval element is defined in 9.4.2.48 (Timeout |
| | Interval element (TIE)). |
| Supported Operating | The Supported Operating Classes element is present if the |
| Classes | TDLS Channel Switching subfield is equal to 1. |
| HT Capabilities | The HT Capabilities element is defined in 9.4.2.55 (HT |
| | Capabilities element). |
| | The HT Capabilities element is present when |
| | dot11HighThroughputOptionImplemented is true. |
| 20/40 BSS | The 20/40 BSS Coexistence element is defined in 9.4.2.59 |
| Coexistence | (20/40 BSS Coexistence element). |
| | The 20/40 BSS Coexistence element is optionally present. |
| Link Identifier | The Link Identifier element is specified in 9.4.2.61 (Link |
| | Identifier element). |
| Multi-band | The Multi-band element is optionally present if |
| | dot11MultibandImplemented is true. |
| AID | The AID element containing the AID of the STA sending the |
| | frame is present if dot11VHTOptionImplemented, |
| | dot11HEOptionImplemented, or dot11S1GOptionImplemented is |
| | true.(11ax) |
| VHT Capabilities | The VHT Capabilities element is present if |
| | dot11VHTOptionImplemented is true. |
| S1G Capabilities | S1G Capabilities element is optionally present if |
| | dot11S1GOptionImplemented is true. |
| EL Operation | EL Operation element is present if |
| | dot11S1GELOperationActivated is true. |
| HE Capabilities | The HE Capabilities element is present if |
| | dot11HEOptionImplemented is true; otherwise, it is not present. |
| | The HE Capabilities element is defined in 9.4.2.248 (HE |
| | Capabilities element(11ax)). |
| TWT | The TWT element is optionally present if |
| | dot11TWTOptionActivated is true; otherwise, it is not present. |
| | The Trigger subfield and the Negotiation Type subfield of the |
| | TWT element are set to 0. |
| HE 6 GHz Band | The HE 6 GHz Band Capabilities element is present if |
| Capabilities | dot11HEOptionImplemented and dot11HE6GOptionImplemented |
| | are true; otherwise, it is not present. |
| EHT Capabilities | The EHT Capabilities element is present if dot11EHTOption- |
| | Implemented is true; otherwise it is not present. |
| TDLS Multi-Link | The TDLS Multi-Link element is present if the STA is affiliated |
| | with a non-AP MLD; otherwise, it is not present. |

The Action field of a TDLS Setup Confirm Action field may contain a subset of this list, where Capabilities IEs are replaced by Operation IEs (e.g. HT/VHT/HE/EHT Capabilities IEs are replaced by HT/VHT/HE/EHT Operation IEs).

Among most interesting elements for the sake of invention, the Supported Channel and Supported Operating Classes elements are used by the peer STAs to inform each other about the possible channels to operate on an off-channel.

The IEEE P802.11be/D2.2 version has envisaged making effective the setup of TDLS direct link over one single communication link for MLDs.

All TDLS Discovery and Setup request and response frames contain a TDLS multi-link IE as described in the FIG. 4b. The TDLS multi-link IE 450 is based on the structure of Multi-Link element introduced for supporting several links (e.g. Basic version is used for association of MLDs), and is therefore composed of:
An Element ID 451 equal to 255,
The Length field 452 defines the length of the information Element,
The Element ID extension field 453 is set to 107 identifying a multi-link IE,
The Multi-link Control field 460 allows defining the type of the multi-link IE as TDLS (value: 3) with the Type field 461,
The Common Info field 470 contains the Common Info Length field 471 and the AP MLD MAC address field 472 set to the MAC address of the AP with which the TDLS initiator non-AP STA is affiliated,
The Link info field 480 is reserved (that means not used).

As a result, the TDLS multi-link IE 450 allows each peer non-AP STA to share the AP MLD MAC address of the AP MLD in the multi-link environment.

A TDLS STA affiliated with a non-AP MLD will only consider a TDLS (Discovery/Setup) frame if the frame carries a TDLS Multi-Link element 450 and the MLD MAC address carried in the AP MLD MAC Address field 472 of the TDLS Multi-Link element 450 matches the MLD MAC address of the AP MLD with which the non-AP MLD has already performed a multi-link setup.

Outside the scope of TDLS, the IEEE P802.11be/D2.2 version has also envisaged making effective the description of links for MLDs. Between an AP MLD and a non-AP MLD associated with the AP MLD, an MLD may transmit an individually addressed Management frame (MMPDU), that is intended for one or more STA(s) affiliated with the associated MLD, to another STA. In other words, the MMPDU is to be distributed via given link(s) different from the link(s) related to the Management information (e.g. a possibility is also that information is intended for more than one STA/Link, or a retransmission is willing on a different STA . . . ). According to FIG. 4c, the Multi-Link Link Information element 490 identifies the intended link(s) of the MMPDU that carries the element. The Link ID Bitmap field indicates the link(s) where the intended STA(s) are operating on (see 35.3.2.1 (General) for the usage of link ID). This illustration of Link identification will be further considered as another means useful for embodiments.

As a result, the D2.2 standard allows direct link communications between non-AP MLDs with one or more single link TDLS direct links. It means separate and independent TDLS sessions can be established on multiple links via multiple affiliated STAs of the same non-AP MLDs.

We can note from the above explanations that the usage of the off-channel, despite a huge interest to improve coexistence between infrastructure and P2P communications, follows a legacy behaviour which does not take benefit of the multi-radio/multi-link capabilities of the devices. Thereby, a non-AP MLD is unable to keep communication with its AP MLD (or AP) through one link while another link may be camped on an off-channel for P2P communication. On the contrary, the usage of the off-channel is still performed through a TDLS channel switch from the base channel to one of the off-channels, hence requires to repeated TDLS channel switches to go back and forth between the base and off-channels.

Notice is made that this constraint between the base channel and the off-channel results from the use of the same enabled link to support both channels. This is because, for the time being, a non-AP MLD only relies on the links setup with the AP MLD.

Inventors intend to overcome some of the foregoing concerns, by providing an off-link scheme, i.e. an extension of the off-channel usage allowing a durable usage of this network resource while keeping a link dedicated for communication with the AP. This is achieved by dedicating a link (hence a link ID) for direct communication over the off-channel. An “off-link” is therefore defined that is separate from the links on which the AP operates.

As an example, the AP MLD (or device) may instantiate a Virtual AP performing no communication in the BSS of the AP MLD. The Virtual AP defines an off-link corresponding to at least one off-channel that does not overlap the channel(s) used by the other AP(s) affiliated to the AP MLD. The Virtual AP is therefore assigned a link identifier, ID, thus identifying the off-link to be used by the non-AP MLDs to set up a TDLS direct link.

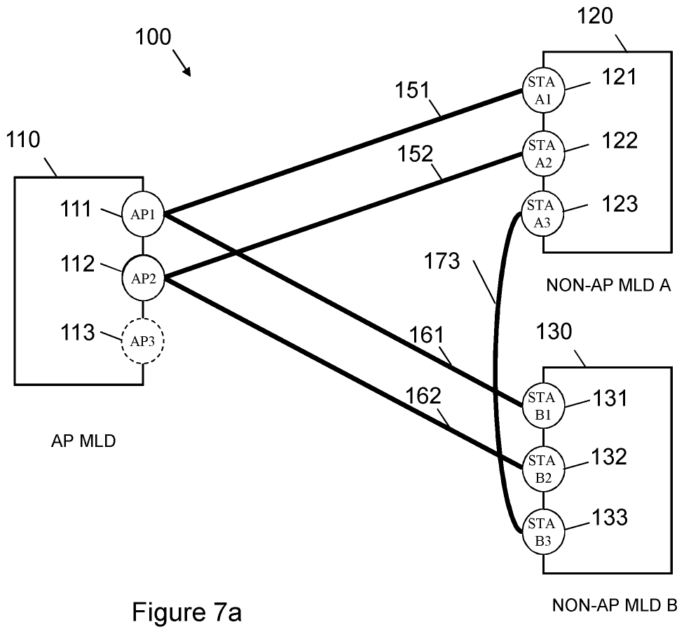

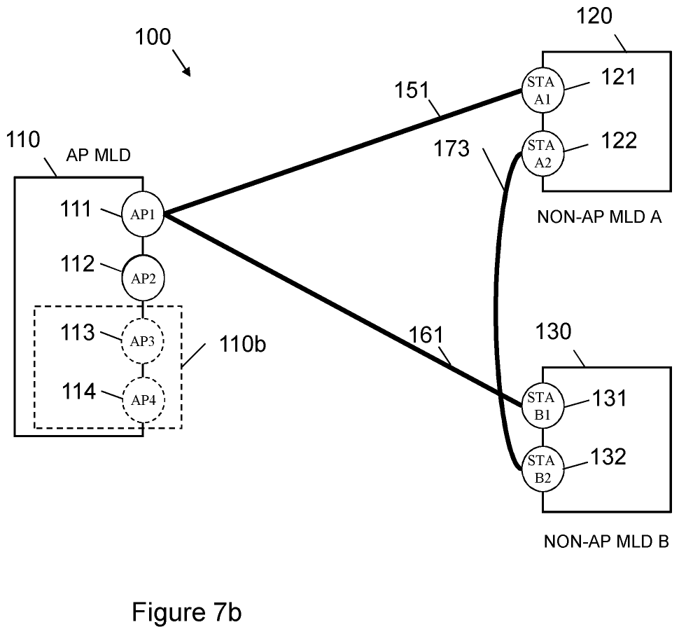

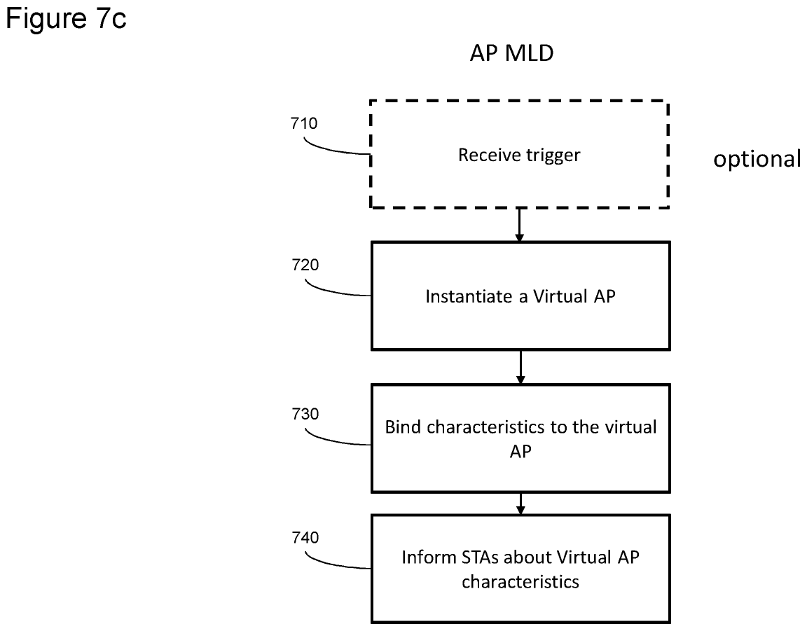

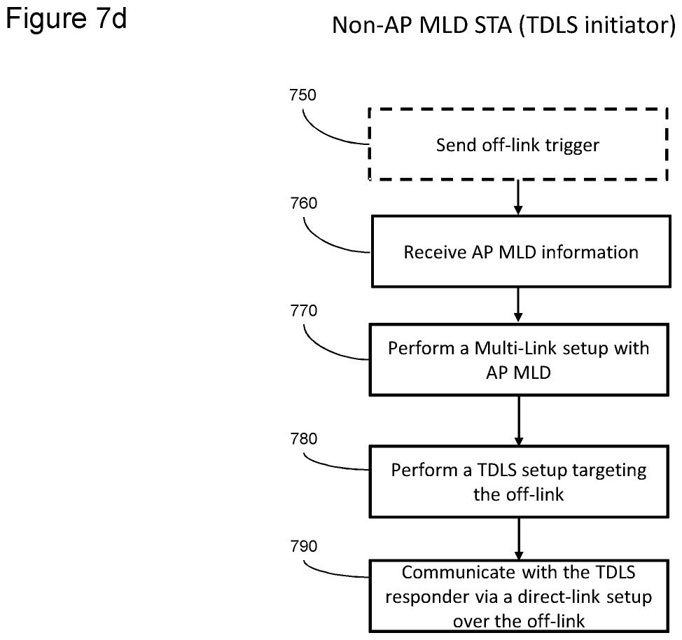

FIG. 7a illustrates an 802.11 network environment involving multi-radio devices MLDs as of FIG. 1 in which the present invention may be implemented. The example of the FIG. 7a presents two non-AP MLDs (non-AP MLD A 120 and non-AP MLD B 130) with three affiliated STAs (from 121 to 123 and from 131 to 133 respectively) and an AP MLD 110 with three affiliated APs 111, 112 and 113. The AP 113 is an instantiation of a virtual AP whose purpose of this virtual AP is to obtain a link ID corresponding to a set of off-channel(s) (at least one off-channel) in order to support the off-link 173 for operations outside the AP MLD management. As a result, the non-AP MLDs 120 and 130 are able to use the off-link 173 with one of their affiliated stations while keeping the former connection with AP MLD through the links 1 and 2 corresponding to the connection with the affiliated AP1 and AP2 respectively.

Of course, the number of links shown in the present figure for the sake of illustration, is not limitative.

FIG. 7b illustrates another 802.11 network environment involving multi-radio devices MLDs as of FIG. 1 in which the present invention may be implemented. The example of the FIG. 7b presents two non-AP MLDs (non-AP MLD A 120 and non-AP MLD B 130) with two affiliated STAs (from 121 to 122 and from 131 to 132 respectively) and an AP MLD 110 with four affiliated APs 111, 112, 113 and 114. The APs 113 and 114 are an instantiation of a virtual AP whose purpose of each of these virtual APs is to obtain a link ID. The link related to AP 113 corresponds to a first set of off-channel(s) and which enables the off-link 173. The link related to AP 114 corresponds to a second set of off-channel(s) which enables another off-link (not represented in the figure). The Virtual APs 113 and 114 may be optionally affiliated to a Virtual AP MLD 110b with a specific MLD ID. As a result, the non-AP MLDs 120 and 130 are able to use the off-link (e.g. 173) with one of their affiliated stations while keeping the former connection with AP MLD through the link 1 corresponding to the connection with the affiliated AP1.

FIG. 7c illustrates example operations of wireless communications, in accordance with certain aspects of the present invention, performed by an AP MLD for the instantiation of virtual AP.

The operations may begin at step 710, where an AP MLD (e.g. 110) receives a trigger to instantiate a Virtual AP. For example, this trigger may be a Probe Request frame 212 including an off-link capability as a new input in the Extended Capabilities element (e.g. bit 90) and/or a Channel Usage element received from a non-AP MLD not yet associated. After the association, a non-AP MLD may request assistance to setup a Noninfrastructure network on an off-channel i.e. the setup of an off-link by sending a Channel Usage Request to the AP MLD with the Usage mode field of the Channel Usage element set to 2. In an alternative, the trigger may be a QoS characteristics such as defined by the draft 2.0 with a Direction subfield with a value corresponding to direct-link communication. In another alternative, the trigger may be an internal trigger, for instance, if the AP MLD supports the Virtual AP or off-link capability, it may setup an off-link by the way of the instantiation of a virtual AP. In another alternative, the AP MLD may instantiate a Virtual AP for any reason without specific trigger.

In other words, the trigger to instantiate an affiliated Virtual AP belongs to the group comprising:
receiving from the non-AP MLD a Probe Request frame (212, 812) including an off-link capability, as a new input in the Extended Capabilities, and/or a Channel Usage element (600) in case the non-AP MLD is not yet associated with the AP MLD;
receiving from the non-AP MLD a Channel Usage Request frame (815) in case the non-AP MLD is yet associated with the AP MLD, the Channel Usage Request frame including a Channel Usage element requesting the setup of the off-link;
receiving a Quality of service, QoS, characteristic; and
detecting a trigger internal to the AP MLD.

At step 720, the AP MLD (e.g. 110) instantiates a Virtual AP 113 (at least one, even if description is focused on one VAP) that is to say allocate an AP ID which can be further used as a link ID. The purpose of the Virtual AP instantiation is to get at least a link ID. In other words, the AP MLD instantiates an affiliated Virtual AP defining an off-link corresponding to at least one off-channel that does not overlap the channel(s) used by the AP MLD, the affiliated Virtual AP being assigned a link identifier, ID, thus identifying the off-link, the Virtual AP performing no communication in its Basic Service Set, BSS.

Then, in step 730, the AP MLD defines the characteristics of the Virtual AP, for instance, in addition to the link ID, the operating class, the channel number, the channel width to define the operating frequency band; the BSSID, information relating to BSSID indicating that the Virtual AP is not reachable, Non-Inheritance element, and so on.

In a particular embodiment, the Virtual AP can be distinguished, from an AP able to perform communication, using a particular value of an AP Reachability field from the BSSID Information element such as defined in IEEE P802.11-REVme/D1.3.

And finally, in step 740, the AP MLD informs the non-AP MLDs or STAs about the Virtual AP characteristics. In other words, the AP MLD transmits to the non-AP MLD information about the affiliated Virtual AP defining the off-link, including the link ID. To do this, the AP MLD may transmit the information in different frames according to the event that has triggered the instantiation of the Virtual AP and the type of information that the AP MLD want to share with the STAs.

### Complete Virtual AP Characteristics:

The AP MLD may include the Virtual AP identity and characteristics as a part of the Multi-link element in a Probe Response frame 213 or in a beacon frame 211 or in Association response frame 215. Thus, the Virtual AP may be an additional STA in the Link Info 530 with a dedicated per STA profile. The per STA profile corresponding to the Virtual AP shall contain information to discriminate the Virtual AP from the other AP. For instance, as illustrated by the FIG. 5b, a new Off-link field 560 may be included in the STA Control field 533. The Off-link field is set to 1 when the link corresponding to the Link ID is an off-link bound to a Virtual AP which is not directly reachable. STA Info field 534 may also include a Usage Mode subfield 561. The Usage mode subfield 561 is a number that identifies the (recommended/restricted) usage of the link corresponding to the link ID carried in the subfield 540. In a variant the Usage Mode field 561 may be conditionally present if the Off-link subfield 561 is set to 1. The Usage mode subfield could be the same as the subfield 630 represented in the FIGS. 6/6a/6b. The Usage mode definitions table 660 presented in the FIG. 6a includes new values “3”, “4” and “5” that can be used to specify the link usage in addition to the existing values. The new value “3” 664 indicates that the link should be restricted to P2P communication, the value “4” 665 indicates that the link is dedicated to communication in between AP, the value “5” 666 indicates that the link is dedicated to coexistence with communication in another Radio Access technology, for instance, the device embeds multiple communication chips (cellular, Wi-Fi, Bluetooth) and try to optimize coexistence in between these different Radio Access technologies. The Usage mode definitions could be a table independent to the table used for the channel usage element to define the link usage as presented in the FIG. 5b. In this table 570, the value “0” 571 indicates that the link should be restricted to P2P communication, the value “1” 572 indicates that the link is dedicated to communication in between AP and the value “2” 573 indicates that the link is dedicated to low latency communication.

In an alternative embodiment, the Common Info field 520 (FIG. 5ai) includes a new Off-link Bitmap or Virtual AP Bitmap subfield. Each bit in the Off-link Bitmap (or Virtual AP Bitmap) subfield included in the Common Info field 520 corresponds to a link and the bit position i in the bitmap corresponds to a link with link ID equals to i. A value of 1 in the bit position i in the bitmap that corresponds to a link on which a STA affiliated with a non-AP MLD indicates that this link is an Off-link or that the AP corresponding to this link is a Virtual AP otherwise the bit position is set to 0. This variant could be interesting in order to improve the parsing of the per-STA profile element. Thereby, if a STA is not interested by the off-link/Virtual AP functionalities, it can skip the per-STA profile corresponding to link identified as off-link or that the AP corresponding to this link is a Virtual AP.

Additionally, the per STA profile may include all elements required to characterize the Virtual AP.

In other words, information about the affiliated Virtual AP is at least partially exchanged as a part of a Multi-link element 500 in a Probe Response frame 213 or in a beacon frame 211 or in an Association Response frame 215, and wherein:
the affiliated Virtual AP is declared as an additional STA in the Multi-link element 500 with a dedicated per STA profile subelement 530 containing information 560, 561 to discriminate the affiliated Virtual AP from other affiliated APs of the AP MLD; or
a Common Info field 520 of the Multi-link element 500 includes an off-link Bitmap or Virtual AP Bitmap subfield.

Optionally, a Non-Inheritance element appears as the last element in the STA Profile field and carries a list of elements that are not inherited by the reported STA from the reporting STA. In one embodiment, this element carries all the element IDs corresponding to the AP capabilities or operations (HE, EHT, QoS) that are useless in the Virtual AP context. As example, all capabilities or operational parameters commonly used to describe a link for non-AP MLD operation (e.g. HT/HE/VHT/EHT Capabilities or Operation IEs) shall not be inherited by the reported Virtual link/AP from the reporting STA: those elements are thus specified in the Non-Inheritance element present as the last element of the per STA profile of a Basic Multi-Link element. In another embodiment, the per-STA profile of the Virtual AP is not subject to inheritance from the reporting STA and is only defined by the elements included in its per-STA profile. In other words, the per STA profile may exclude all elements required to characterize the communication over Virtual AP.

In other words, the per STA profile subelement 530 dedicated to the affiliated Virtual AP:
comprises a Non-Inheritance element carrying at least one of AP capabilities or operations that are useless in the Virtual AP context due to the fact the Virtual AP performs no communication in its Basic Service Set, BSS; or
is not subject to inheritance.
   Virtual AP operating Channels:

The AP MLD may also transmit a Channel Usage Response frame (upon reception of a Channel Usage Request frame in step 710 or autonomously) including Channel Usage elements. A new variant of the Channel Usage element may be contemplated to inform the STAs on the Virtual AP operating channel(s) i.e. the operating channel(s) of the off-link. Thereby, this new variant of the Channel Usage element (presented with reference to the FIG. 6a) includes at the end of the payload 600 a new field 650 carrying the Link ID associated to the different channel entries 640. This field 650 could be the Link ID Info subfield 523 presented in the FIG. 5a1. Another variant presented with reference to the FIG. 6b includes the link ID Info subfield 643 as a new subfield of the Channel entry field 640.

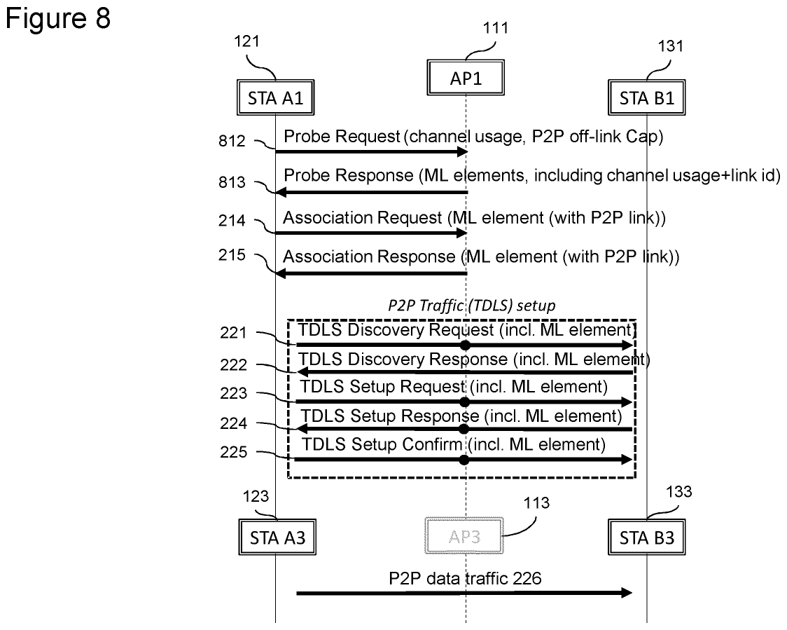

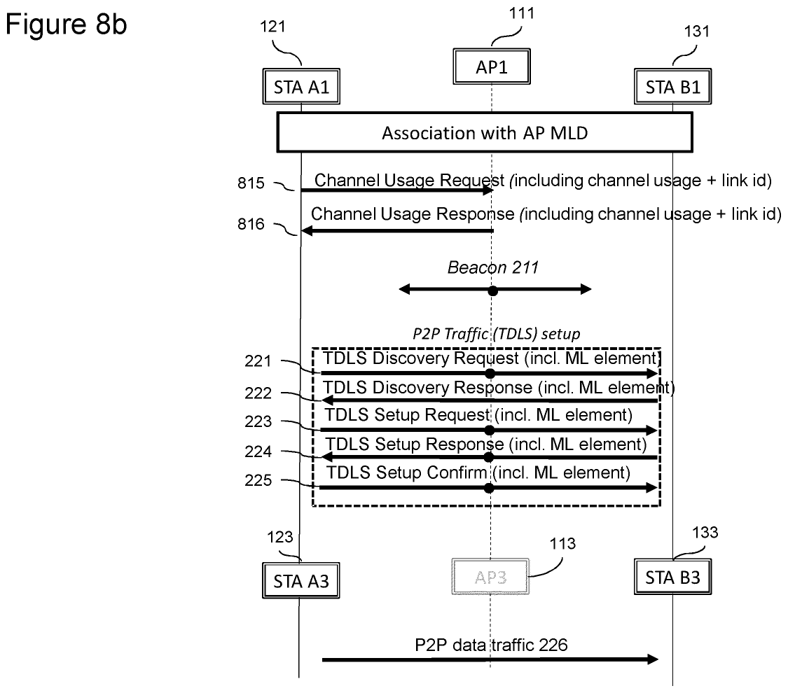

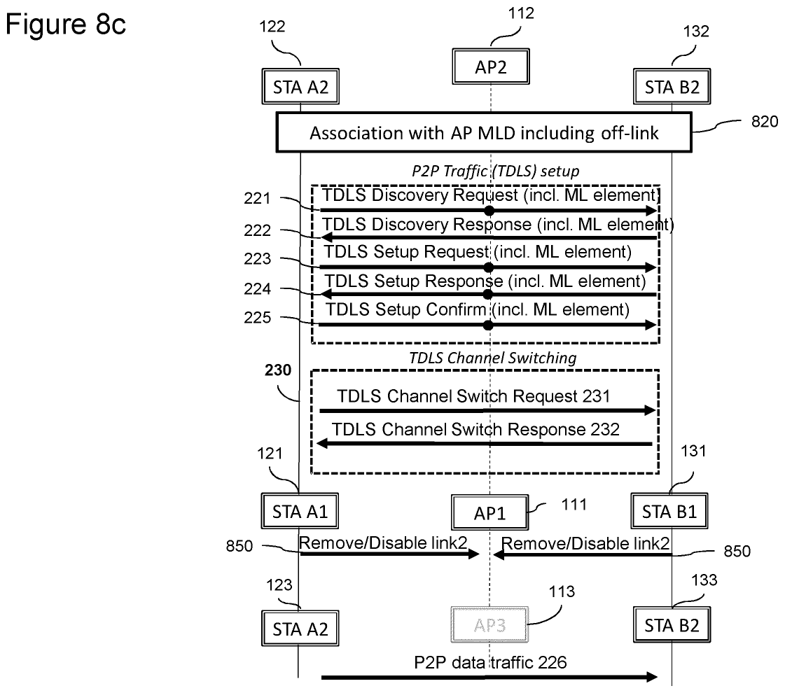

The variant of the Channel Usage element presented with reference to FIGS. 6a and 6b may be included in the Probe Response frame body for the reporting AP (AP1 in the example of the FIG. 8) or in the per-STA profile included in the Multi-Link element for the reported APs (AP2 in the example of the FIG. 8). If the Channel Usage element (presented with reference to FIGS. 6, 6a and 6b) is only included in the frame body for the reporting AP, it may include channel usage information for all bands (2.4 GHz, 5 GHz and 6 GHz) supported by all APs affiliated with the AP MLD of the reporting AP. The reporting AP may optionally use the multi-band element (as defined in IEEE 802.11-REVme/D1.3 (June 2022), section 9.4.2.138 Multi-band element) to advertise the Supported Channels relative to the other affiliated APs (reported APs). In another alternative, the Channel Usage element may be included in the Common Info field 520 with the channel usage of the AP MLD (including all affiliated APs). Otherwise, the channel usage information may be advertised per band corresponding to the band of the different APs affiliated with the AP MLD thereby, as described above, the Channel Usage element is carried in the frame body for the reporting AP and in the per-STA profile of the Multi-Link element for the reported AP(s). For example, if the AP1 operates in the 2.4 GHz band, it may only report the channel usage corresponding to the 2.4 GHz band and if the AP2 operates in the 5 GHz band, it may only report the channel usage corresponding to the 5 GHz band.

In other words, the information about the affiliated Virtual AP comprises information about the at least one off-channel of the AP MLD which is exchanged as a Channel Usage element 600 which includes:
a Link ID Information field 650 containing said link ID and associated with all Channel entries of a Channel Entry field 640; or
a Link ID Information subfield 643 of a Channel Entry field 640, containing said link ID and associated with all Channel entries of the Channel Entry field 640; and

and which is included in a Probe Response frame 213 or a Channel Usage Response frame 816.

The AP MLD may also use Neighbor report element or Reduced Neighbor Report element to convey partial or complete characteristics of the Virtual AP/off-link. An example of the TBTT Information field included in the Reduced Neighbor Report element according to embodiment of the invention is presented in the FIGS. 9a and 9b.

Back to the FIG. 9, in the example of the FIG. 7a, a beacon frame carrying a Reduced Neighbor Report element will contain at least two information fields 920 corresponding to the AP2 and AP3 (as reported AP). The AP3 being a Virtual AP. Now, in the example of the FIG. 7b, a beacon frame carrying a Reduced Neighbor Report element will contain at least three information fields 920 corresponding to the AP2, AP3 and AP4 (as reported AP). AP3 and AP4 being Virtual APs. The value of the MLD ID field 941 may be different between the AP2 and the Virtual APs 3 and 4.

In the first embodiment of the FIG. 9a, the MLD Parameters field 940 includes a new Off-link field 944. The Off-link field is set to 1 when the link corresponding to the Link ID carried in the field 942 is an off-link bound to a Virtual AP which is not directly reachable.

In the second embodiment of the FIG. 9b, the MLD Parameters field 940 includes a new Usage Mode field 945. The Usage Mode field 945 is a number that identifies the usage of the link corresponding to the Link ID carried in the field 942. The values identifying the usage of the link may rely on the table 660 presented in the FIG. 6a or the table 570 presented in the FIG. 5b or the table 9-265 presented in the FIG. 6 and issued from IEEE P802.11-REVme/D1.3 version or any combination of the values presented in these tables.

In other words, the information about the affiliated Virtual AP is at least partially exchanged as a part of a Neighbor Report element or a Reduced Neighbor Report element 910 comprised in a beacon frame 211, said part being an off-link field 944 or a Usage Mode field 945 comprised in a MLD Parameters subfield 940 and giving information relating to the link corresponding to the content of a Link ID field 942 also comprised in the MLD Parameters subfield 940.

A third embodiment could be the combination of the two preceding ones. In this case, the MLD Parameters 940 includes the Off-link field 944 and the Usage Mode field 945. The Off-link field is set to 1 when the link corresponding to the Link ID carried in the field 942 is an off-link bound to a Virtual AP which is not directly reachable. The Usage Mode field 945 is a number that identifies the usage of the Off-link corresponding to the Link ID carried in the field 942. The Usage mode element may be present only if the Off-link field 944 is set to 1.

In a variant, the AP MLD may create a Virtual AP based on existing affiliated AP. For instance, the AP MLD may un-map all TIDs in downlink and Uplink on the link corresponding to the AP that it wants to convert in a Virtual AP. In addition, the AP MLD may only map some TID(s) on a P2P TID to Link mapping for the link bound to the Virtual AP.

Additionally, the Virtual AP or off-link capability of the AP MLD may be reported to the non-AP MLD either through a new input in the Extended Capabilities element (e.g. bit 90) or through a new subfield of the MLD Capabilities and Operations (e.g. one of the reserved bit) of the Multi-Link element carried for example in the Beacon frame 211 or the Probe Response frame 213 or the Association Response 215 or a Reassociation Response frame. This capability advertises the non-AP MLDs that the AP MLD supports Virtual AP or off-link capability and although no off-link is currently available, the non-AP MLD(s) may further trigger the creation of an off-link for instance by sending a Channel Usage Request frame as described in the FIG. 8b.

FIG. 7d illustrates example operations of wireless communications, in accordance with certain aspects of the present invention, performed by a non-AP MLD for the TDLS setup on an off-link.

The operations may begin at step 750, where a non-AP MLD (e.g. 120) transmits a trigger to obtain an off-link for instance for P2P communication. This trigger may be a Probe Request frame 212 including an off-link capability as a new input in the Extended Capabilities element (e.g. bit 90) and/or a Channel Usage element received from a non-AP MLD not yet associated. We can note that the Extended Capabilities element including the off-link capability may be carried in addition to the Probe Request frame, in an Association Request frame or a Reassociation Request frame. After the association, a non-AP MLD may request the setup of an off-link by sending a Channel Usage Request to the AP MLD. The Channel Usage Request frame may include a legacy Channel Usage element such as define by the IEEE P802.11-REVme/D1.3 version or one of the new variants of the Channel usage element (presented in FIG. 6a or 6b). In this variant, the Link ID Info field 650 may be set with a specific value requesting the AP MLD to allocate an off-link.

In the step 760, the non-AP MLD receives information related to an AP MLD, either as a direct response to the step 750 or according to an autonomous transmission of the AP MLD (e.g. a beacon or an autonomous Channel Usage Response frame).

In particular, the non-AP MLD obtains a link identifier, ID, which defines an off-link corresponding to at least one off-channel that does not overlap the channel(s) used by the AP MLD.

Based on the received information, in step 770, the non-AP MLD 120 initiates a Multi-Link setup with the AP MLD 110 similarly to the procedure 210 described in the FIG. 2. This procedure relies on the Association request 214/response 215 frame exchange, each frame including a Multi-Link element. The Multi-Link element allows to describe and to select a set of candidate setup links between its own affiliated non-AP STAs and some of the discovered affiliated APs and to request the AP MLD 110 to set up these links, which may be accepted or refused by the AP MLD. In the present invention, if the non-AP MLD intends to use the off-link, it includes information of the Virtual AP (off-link) in addition to the information of the other APs (other links) in the Multi-Link element transmitted in the Association Request 214. This information could be useful for the AP MLD to get some metrics on the off-link usage e.g. number of non-AP MLD intending to use the off-link. According to the metric, the AP MLD may further decide to instantiate a new Virtual AP to support more P2P communications or to modify the existing one by enlarging the operating band. Once the ML setup is completed, the AP MLD and non-AP MLD may communicate together through any setup links according to the TID-to-link mapping rules except through the off-link whose the usage is restricted for instance to P2P communication.

Then in step 780, the non-AP MLD 120 performs a TDLS setup with a second non-AP MLD 130 with the off-link as a target link. In other words, the non-AP MLD establishes, through the channel(s) (and thus the link) used by the AP device, a tunneled direct link setup, TDLS, direct link, between a first TDLS station, STA, affiliated with the non-AP MLD and a second TDLS STA, using the link ID as an indication of the off-link for the TDLS direct link.

In a particular embodiment, establishing the TDLS direct link comprises setting up the TDLS direct link using the link ID to define the off-link as the TDLS direct link.

This link ID is for example: the content of the BSSID field 401 of FIG. 4a, or the content of the Link ID field 540 of FIG. 5a2, or a bit of the Link ID Bitmap field 491 of FIG. 4c.

In a variant, the step 780 may be executed in two successive steps. Firstly, the non-AP MLD 120 performs a TDLS setup with a second non-AP MLD 130 on a link on which an AP operates (not a virtual AP) and both non-AP MLDs gather the Supported Channel of each other. Then the two non-AP MLDs move to one off-link corresponding to an off-channel mutually supported, for instance by using the TDLS Channel Switch procedure 230. This variant is further described with reference to the FIG. 8c.

In other words, in this variant, establishing the TDLS direct link comprises:
setting up an initial TDLS direct link enabling a peer-to-peer communication between the first and second TDLS STAs; and
performing a channel switch to move the peer-to-peer communication from the initial TDLS direct link to a target link, using a channel of the off-link as a target channel for the target link or using the link ID to define the off-link as the target link.

In a particular implementation of this variant (see below), the non-AP MLD disables or removes the initial TDLS direct link.

The TDLS setup may be performed through any of the links setup with the AP MLD (except the off-link). In the example of the FIG. 8, the TDLS initiator STA A1 121 performs the TDLS setup with the TDLS responder STA B1 131 via the AP1 111. Each TDLS setup frames includes the link identifier 400. The TDLS initiator STA Address field 402 carried in the Link Identifier is set with the MLD MAC Address of the non-AP MLD 120, the TDLS responder STA Address field 403 is set with the MLD MAC Address of the non-AP MLD 130 and the BSSID field 401 is set with the BSSID corresponding to the off-link. In another variant, the off-link may be added in the per STA profile carried in the TDLS Multi-Link element. The ML element transmitted by the TDLS initiator non-AP MLD in the TDSL Setup Request informs the peer non-AP MLD on which link(s) TDLS could be established. As a response, the ML element transmitted by the TDLS responder non-AP MLD in the TDLS Setup Response informs the TDLS initiator non-AP MLD on which link(s) the TDLS session is effectively established i.e. the accepted links.

In another variant, the TDLS setup frames include the Multi-Link Link Information element 490 which contains a Link ID bitmap 491. This link ID bitmap 491 indicates the targeted link for the TDLS setup when the Multi-Link Link Information element 490 is transmitted in the TDLS setup Request frame and the link ID bitmap 491 indicates the accepted link when the Multi-Link Link Information element 490 is transmitted in the TDLS setup Response frame. One bit in the link ID bitmap may correspond to an off-link of the present invention.

In other words, establishing the TDLS direct link comprises at least one of the following operations:
including, in TDLS setup frames exchanged between the first and second TDLS STAs, a link identifier 400 which comprises a BSSID field set with a basic service set identifier, BSSID, corresponding to the Virtual AP and thus to the off-link;
adding the off-link in a per STA profile subelement 530 carried in a TDLS Multi-Link element 500 exchanged between the first and second TDLS STAs; and
including, in TDLS setup frames exchanged between the first and second TDLS STAs, a Multi-Link Link Information element 490 which contains a Link ID bitmap 491 indicating the off-link.

As a result, in the step 790, if the TDLS setup succeeds, the STA A3 123 and B3 133 (TDLS peer STAs) respectively affiliated to the non-AP MLDs 120 and 130 may communicate over the off-link. In other words, the non-AP MLD operates a peer-to-peer communication between the first and second TDLS STAs, over the off-link.

It must be noted that the non-AP MLD can operate a communication with the AP device on another link (e.g. 151 in FIGS. 7a and 7b) corresponding to at least one of the channel(s) used by the AP device.

FIG. 8 illustrates, using frame exchanges in a timeline, the scenario of FIGS. 2 and 2a when an AP MLD notifies a TDLS initiator non-AP MLD that an off-link is available to handle P2P traffic. The same references as in FIGS. 2 and 2a correspond to the same phases/steps/frames/entities.

At the beginning of the frame exchange, the STA A1 121 affiliated with the non-AP MLD 120 is not associated with any AP or AP MLD. In the context of Multi-Link discovery, the STA A1 121 transmits a Probe Request frame 812 including a part of the STA capabilities. In relation with the current invention, the Probe Request frame 812 includes a Supported Operating Classes element (order 6 in the Probe Request frame body) and a Channel Usage element (order 11 in the Probe Request frame body). The Supported Operating Classes element is used by a STA or non-AP MLD if the reporting STA is affiliated to a non-AP MLD to advertise the operating classes within which it is currently configured to operate. The Channel Usage element includes the link ID Info field (650 in the FIG. 6a or 643 in the FIG. 6b). The link ID Info subfield is set to a wildcard value requesting the AP MLD to allocate an off-link. The Usage Mode carried in the Channel Usage element advertises the AP MLD the usage that the station wants to do with the off-link. The Probe Request in its Multi-Link version also includes a Multi-Link element that permits to request information to the AP MLD. If there is no per-STA profile in the Multi-Link element, the AP MLD shall include information about all its affiliated APs otherwise the AP MLD advertises the non-AP MLD only with the per-STA profile whose Link ID is equals to the value in the link ID field included in the per-STA profile carried in the Multi Link element in the Probe Request frame. In another embodiment, the Supported Operating Classes may be carried in the per-STA profile included in the Multi-link element to advertise for each STA affiliated to the non-AP MLD the operating classes within which each STA is currently configured to operate. In addition, the STA Control field of the Probe Request Multi-Link element may include a new subfield indicating that this per-STA profile is for AP information while normally the per-STA profile in the Multi-Link probe request identifies the AP whose information is requested.

In another embodiment, the non-AP MLD may use the Multi-Band element (order 14 in the Probe Request Frame Body) to advertise AP MLD about the Supported Operating Classes through the different frequency band. Indeed, the Multi-band element indicates that the STA transmitting this element (the transmitting STA) is within a multi-band device capable of operating in a frequency band or operating class or channel other than the one in which this element is transmitted.

Target AP MLD 110 responds through its affiliated AP1 111 a Probe Response frame 813 to the STA A1 121. The Probe Response frame includes one or more Channel Usage elements. Channel Usage elements shall include channels that are valid for the regulatory domain in which the AP transmitting the element is operating and consistent with the Country element in the Beacon or Probe Response frame; the Channel Usage elements shall not include any other channels. Channel Usage element includes a link ID associated to a Virtual AP which has been instantiated (step 720 if the AP MLD supports the Virtual AP or the off-link capability) to create an off-link. The operating band allocated to the off-link depends on the Supported Operating Classes gathered from the non-AP MLD and the operating frequency band currently used by the AP MLD. As a reminder, the off-channel does not overlap the channel(s) used by the access point. In addition, the AP MLD may further consider some Non-Simultaneous Transmit and Receive constraints. In an alternative embodiment, the Probe Response frame includes a legacy Usage Channel element. In that case, the Probe Response frame includes a Multi-Link element with the Virtual AP identity (i.e. link ID) and characteristics (at least the operating classes/bands/channels) in a dedicated per-STA profile in addition to per-STA profile for the other requested APs. The per-STA profile with reference to the FIG. 5b includes an off-link subfield 560 and/or a Usage Mode subfield 561. In another embodiment, the information related to the Virtual AP identity and Usage are included in a Reduced Neighbor Report element such as described in the FIGS. 9a and 9b. The Usage mode in different aforementioned variants is set to the value (for instance value 3 in the FIG. 6a) restricting the usage to P2P communication.

Once receiving the Probe Response frame 813, the non-AP MLD 120 may attempt an association with the AP MLD 110. The non-AP MLD 120 transmits via the STA A1 111 an Association Request frame 214 which includes the Multi-Link element with a per-STA profile for each link (corresponding to each AP affiliated to the AP MLD) that are requested by the non-AP MLD for the association. The Virtual AP may be added as requested AP in the per-STA profile in order to inform the AP MLD that the non-AP MLD would use the off-link.

If the AP MLD agrees with the Association request, the AP MLD 110 responds to the non-AP MLD 120 with an Association Response frame 215. The Association Response frame includes a per-STA profile for each link corresponding to each AP affiliated to the AP MLD that are accepted for the association. The link corresponding to the Virtual AP shall be always accepted.

If the off-link is dedicated to P2P communication, the non-AP MLD 120 may decide to establish a TDLS setup targeting this off-link. This procedure follows the procedure 220 described with reference to the FIG. 2a.

The TDLS initiator STA A1 121 performs the TDLS discovery and TDLS setup with the TDLS responder STA B1 131 via the AP1 111. Each TDLS Discovery and setup frames includes the link identifier 400. The TDLS initiator STA Address field 402 carried in the Link Identifier is set with the MLD MAC Address of the non-AP MLD 120, the TDLS responder STA Address field 403 is set with the MLD MAC Address of the non-AP MLD 130 and the BSSID field 401 is set with the BSSID corresponding to the off-link.

In another variant, the off-link may be added in the per STA profile carried in the TDLS Multi-Link element. The Multi-Link element transmitted by the TDLS initiator non-AP MLD in the TDSL Discovery Request frame 221 informs the peer non-AP MLD on which link(s) TDLS could be discovered. As a response, the Multi-Link element transmitted by the TDLS responder non-AP MLD in the TDLS Discovery Response frame 222 informs the TDLS initiator non-AP MLD on which link(s) it may operate.

The Multi-Link element transmitted by the TDLS initiator non-AP MLD 120 through the STA A1 121 in the TDSL Setup Request frame 223 informs the peer non-AP MLD 130 on which link(s) TDLS could be established. As a response, the Multi-Link element transmitted by the TDLS responder non-AP MLD 130 through its affiliated station STA B1 131 in the TDLS Setup Response frame 224 informs the TDLS initiator non-AP MLD on which link(s) the TDLS session will be effectively established i.e. the accepted links. The Multi-Link element transmitted by the TDLS initiator non-AP MLD 120 through the STA A1 121 in the TDSL Setup Confirm frame 225 informs the peer non-AP MLD 130 on which link(s) the TDLS session is established.

In another variant, the TDLS setup frames includes the Multi-Link Link Information element 490 which contains a Link ID bitmap 491. This link ID bitmap 491 indicates the targeted link for the TDLS setup when the Multi-Link Link Information element 490 is transmitted in the TDLS setup Request frame 223 and the link ID bitmap 491 indicates the accepted link when the Multi-Link Link Information element 490 is transmitted in the TDLS setup Response frame 224. One bit in the link ID bitmap may correspond to an off-link of the present invention.

Then when the TDLS session is established, the peer non-AP MLD may directly communicate P2P data traffic 226 with their dedicated affiliated stations (respectively STA A3 123 affiliated to the non-AP MLD 120 and STA B3 133 affiliated to the non-AP MLD 130) through the off-link 173. Each non-AP MLD can continue to operate with the AP MLD with other setup link(s).

FIG. 8b illustrates, using frame exchanges in a timeline, the scenario of FIGS. 2 and 2a when a non-AP MLD already associated with an AP MLD request the creation of an off-link for P2P traffic through a Channel Usage Request frame.

In the example of this figure, there is no off-link created and used during the association with the AP MLD. The Non-AP MLD 120 requests to the AP MLD 110 the creation of a P2P off-link for instance to answer to a new application need.

The non-AP MLD 120 transmits via the STA A1 121 a Channel Usage Request frame 815 to the AP MLD 110.

The Channel Usage Request frame is described with reference to the FIG. 6c. It includes mainly Channel Usage Element field 681 and Supported Operating Classes Element field 682. The WNM field 680 defined the type of the frame i.e. Channel Usage Request Frame.

The Channel Usage Element field includes one or more Channel Usage elements to identify the request Usage Mode. The Channel Usage element is described in the FIGS. 6, 6a and 6b. The Channel Usage element includes the link ID Info field (650 in the FIG. 6a or 643 in the FIG. 6b). The link ID Info subfield is set to a wildcard value requesting the AP MLD to allocate an off-link.

The Supported Operating Classes Element field contains a Supported Operating Classes element to indicate the supported operating classes for the requested network type, consistent with the Country element advertised by the AP.

In an alternative, the frame 815 could be a new off-link Creation Request frame identified with a new value in the NWM field (WNM Action field value set to 28) with the same element but without link ID field in the Channel Usage element.

Upon reception of the Channel Usage Request frame 815, the AP MLD executes the step 720 and 730 to create an off-link dedicated to P2P communication in the example of the FIG. 8b. Then the AP MLD 110 responds a Channel Usage Response frame 816 to the non-AP MLD 120 via the AP1 111. The Channel Usage Response frame includes similarly to the Channel Usage Request frame the NWM field 680 and the Channel Usage Element field 681. The Channel Usage element includes a link ID associated to a Virtual AP which has been instantiated (step 720 if the AP MLD supports the Virtual AP or off-link capability) to create an off-link. The operating band allocated to the off-link depends on the Supported Operating Classes gathered from the non-AP MLD and the operating frequency band currently used by the AP MLD. As a reminder, the off-channel does not overlap the channel(s) used by the access point. In addition, the AP MLD may further consider some Non-Simultaneous Transmit and Receive constraints. The other fields are out of the scope of the invention.

In a variant, the frame 816 could be a new off-link Creation Response frame identified with a new value in the NWM field (WNM Action field value set to 29) with the same element as in the Channel Usage Response frame.

Once the off-link created by the AP MLD 120, it may advertise all surrounding stations by including the Virtual AP/off-link characteristics in the Beacon frame 211. The Beacon frame 211 includes the variant based on the Reduced Neighbor Report and Multi-Link element described in the previous figures.

The remaining frame exchange is similar to the ones described in the FIG. 8.

FIG. 8c illustrates, using frame exchanges in a timeline, the scenario of FIGS. 2 and 2a when non-AP MLDs already associated with an AP MLD (the association including the off-link such as described in the FIG. 8 by the procedure 820) perform a TDLS setup on a link shared with the AP and move to the off-link by using a TDLS channel switch. This figure is related to the 802.11 network environment of the FIG. 7b in which the non-AP MLDs have two affiliated STAs, one dedicated for P2P communication and the other for communication with the AP MLD.

The procedure 820, corresponding to the Multi-Link setup with the AP MLD including the off-link in the Multi-Link element, encompasses the steps 812, 813, 214 and 215 described in the FIG. 8. This procedure is performed in between non-AP MLD 120 and the AP MLD 110 and also in between the non-AP MLD 130 and the AP MLD 110. As a result, the non-AP MLDs 120 and 130 are associated with the AP MLD 110 and have the knowledge of the off-link dedicated to P2P communication.

The TDLS initiator STA A2 122 performs the TDLS discovery and TDLS setup with the TDLS responder STA B2 132 via the AP2 112. Each TDLS Discovery and setup frames includes the link identifier 400. The TDLS initiator STA Address field 402 carried in the Link Identifier is set with the MLD MAC Address of the non-AP MLD 120, the TDLS responder STA Address field 403 is set with the MLD MAC Address of the non-AP MLD 130 but conversely to FIG. 8 the BSSID field 401 is set with the BSSID corresponding to one usual AP (not a Virtual AP) operating on a base channel. This AP is associated with the STAs which will be used for the further P2P communication, AP 2 in the example of the present figure. The TDLS setup frame allows sharing the Supported Channel element in between both TDLS peer STAs and so to confirm that they support the off-link operating off-channel(s).

Then, the TDLS initiator STA A2 transmits a TDLS Channel Switch Request frame 231 to move the P2P communication to the off-link. The TDLS Channel Switch Request includes the link identifier 400 such as defined in the TDLS setup, the Target Channel and its operating class, as well as a timing information for the Channel switch. The Target Channel corresponds to the operating channel of the off-link (i.e. the off-channel). In addition, the channel of the off-link used as target channel may be the base channel of the off-link or the primary channel of the off-link or one of the channels in the channel entry (Channel Usage element) corresponding to the off-link. Target partner STA B2 responds with a TDLS Channel Switch Response frame 232 with the link identifier and a status code set to SUCCESS (if it agrees to switch to the target channel), then both peer STAs switch (from the base channel) to the Targeted Channel. If the TDLS Channel Switch Response frame 232 contains a STATUS code different from SUCCESS, both STAs continue to operate on the current base channel.

We describe now some variants in which the channel switch indicates a Target Link instead of a Target Channel.

In a first variant, the non-AP MLDs deduce that this is a link switch because the target Channel correspond to an off-link created by the AP MLD.

In a second variant, we use the Link identifier included in the channel switch in order to indicate, as for the setup, the target link through its BSSID. Thereby, The BSSID field 401 of the link identifier 400 is set to the BSSID of the Virtual AP corresponding to the off-link. Additionally, the TDLS initiator STA Address field 402 and the TDLS responder STA Address field 403 may be set to the addresses of the STAs involved in the switch (instead of the addresses of the MLDs. In the example of the FIG. 8c, we obtain: the TDLS initiator STA Address field is set to the address of the STA A2 122; the TDLS responder STA Address field is set to the address of the STA B2 132; and the BSSID field is set to the BSSID of the AP3 113 corresponding of the off-link.

In a third variant, we add a Link ID field in the channel Switch Request/Response frames.

The first and second variants allow to keep the existing signaling.

To avoid being obliged to switch back to the base channel, the non-AP MLDs 120 and 130 have to disable or remove the link (referred to as “previous link) which was formerly uses by the AP2 112 to communicate with STA A2 122 and STA B2 132. This may be done through an update of the TID-to-LINK mapping by removing all TIDs from the previous link and consequently disabling the previous link or by a Multi-Link (re)setup in between AP MLD 110 and the non-AP MLDs 120 and 130 to remove the previous link from the setup link(s). This procedure of link removal or disabling is presented by the arrows 850 in the present figure. In the example of the figure, the messages corresponding to this procedure are transmitted through the STA A1 121 and STA B1 131 as the link removal/disabling is performed after the TDLS Channel Switch but in an alternative, STA A2 and STA B2 may transmit this message before performing the TDLS Channel Switch.

As a result, after the removal/disabling of the previous link, both STAs (STA A2 and STA B2) are dedicated to P2P communication and may perform direct link communication on the off-link without need to switch back to the base channel.

Relying on a Virtual AP involves additional processing for the AP MLD, e.g. additional signaling in the management frames. Other mechanisms are provided below. In these mechanisms, one of the (peer) non-AP MLDs creates a TDLS link, with own link ID, that defines the off-link corresponding to at least one off-channel that does not overlap the channel(s) used by the AP device. A TDLS direct link can then be established between the non-AP MLDs using that TDLS link (i.e. its link ID) with conventional TDLS mechanisms.

The AP MLD is advantageously not involved in the creation process. To efficiently choose one or more off-channels that do not impact the AP MLD's operations, the non-AP MLDs may however obtain, from the AP MLD, recommended channels that are not infrastructure BSSs or an off-channel TDLS direct link. The off-channel or off-channels to define the off-link are then selected from the recommended channels.

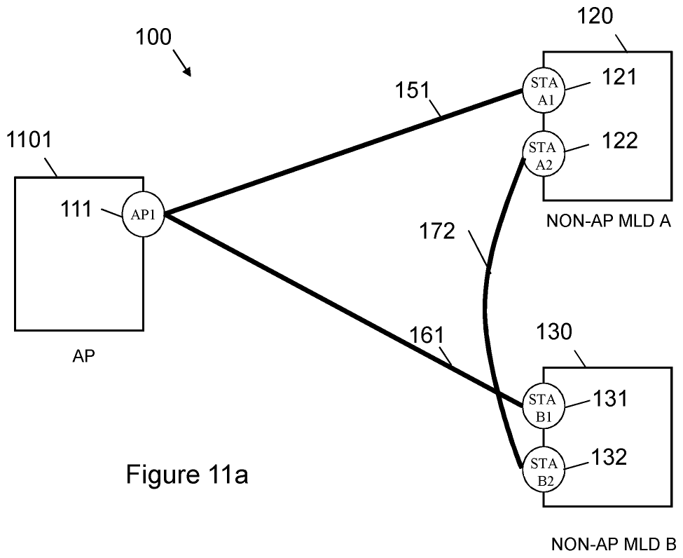

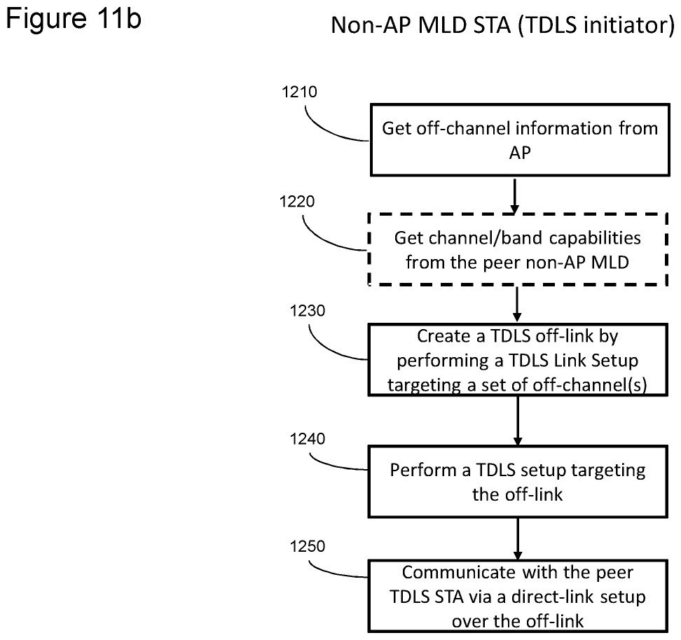

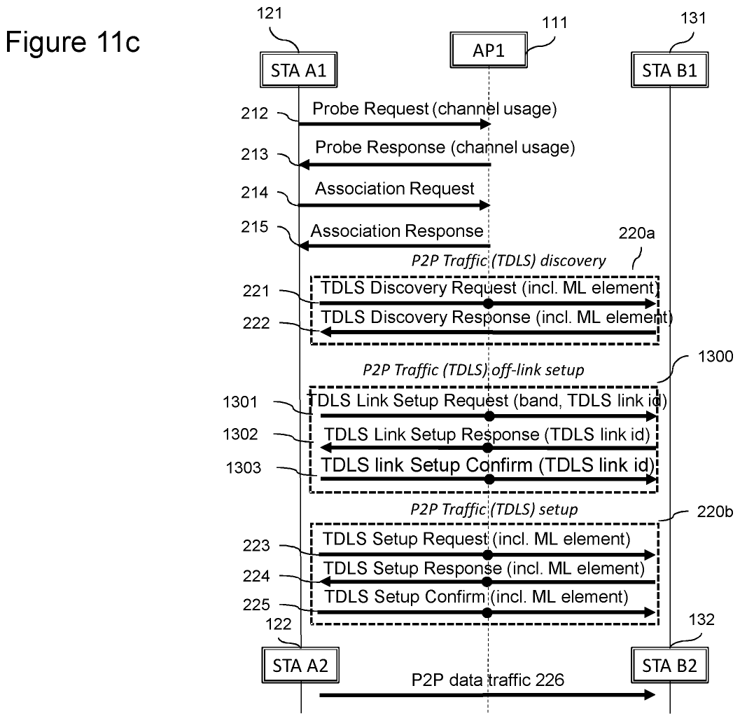

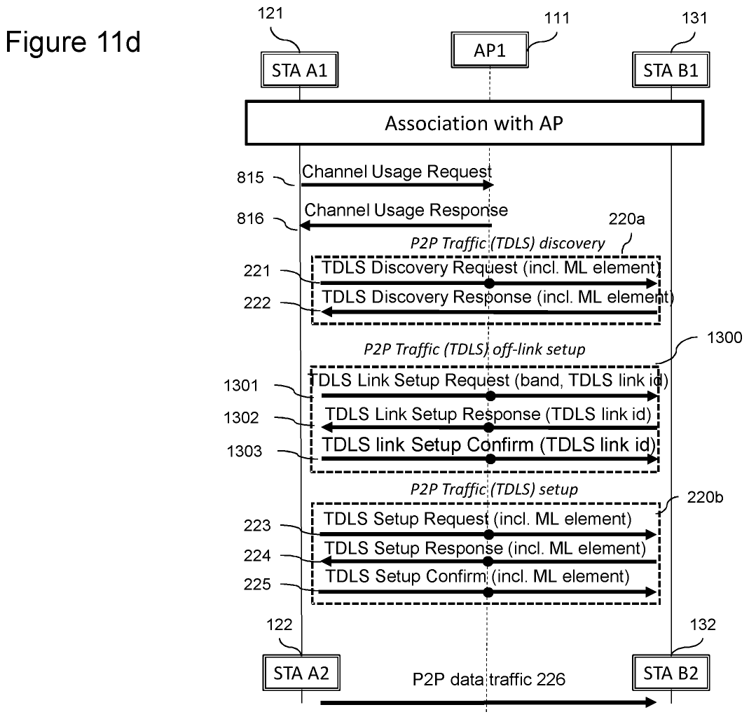

First embodiments are described with reference to FIGS. 11a-11d. In these embodiments, the TDLS link is created by exchanging TDLS Action frames with the other (peer) non-AP MLD. Such frames may be new TDLS Action frames compared to the D2.2 standard. As TDLS Action frames, they are tunneled by the AP device, to simultaneously create the off-link at both (peer) non-AP MLDs.

Next, the establishment of the TDLS direct link between the two non-AP MLDs consists in merely performing a TDLS direct-link establishment targeting the created off-link. The conventional TDLS direct-link establishment is defined in section 11.20.4 of the IEEE P802.11-REVme/D2.0. It includes exchanging TDLS Setup Request/Response frames as explained above with reference to FIG. 2a, wherein these frames include (e.g. in the Link Identifier IE 400) the MAC addresses of the affiliated peer STAs associated with the created off-link.

FIG. 11a illustrates an 802.11 network environment involving non-AP multi-radio devices MLDs associated to an AP device in which embodiments of the present invention may be implemented. The example of the Figure illustrates two non-AP MLDs (non-AP MLD A 120 and non-AP MLD B 130) with two affiliated STAs (from 121 to 122 and from 131 to 132 respectively) and an AP MLD 1101 having only one affiliated AP 111. In another embodiment, the AP 1101 may be a legacy AP, i.e. without any multi-link capabilities. Each non-AP MLD has setup a link with the AP device, here STA A1 121 has setup link 151 with AP1 111 while STA B1 131 has setup link 161 with AP1 111.

The non-AP MLDs 120 and 130 instantiate or create a TDLS link over a set of off-channel(s) (that does not overlap the operating channels of the AP device) to get an off-link 172 for operations out of the AP management. The created TDLS link or off-link 172 is setup at another affiliated station than the transmitting one, here STA A2 122 for non-AP MLD A 120 and STA B2 132 for non-AP MLD B 130.

Typically, this off-link is used for TDLS communications. It means that non-AP MLDs 120 and 130 establish a TDLS session (TDLS direct link) on off-link 172 by exchanging TDLS Action frames via their affiliated stations STA A1 121 and STA B1 131, the frames being tunneled by AP1 111.

As a result, the non-AP MLDs 120 and 130 are able to use the off-link 172 with one of their affiliated stations while keeping the former connection with the AP device through the initial link corresponding to the connection with AP1 111.

Of course, the number of links shown in the present figure for the sake of illustration, is not limitative.

FIG. 11b illustrates, using a flowchart, exemplary steps for direct communications, in accordance with certain aspects of the present invention. These steps are performed by a (peer) non-AP MLD initiating the creation or instantiation of the TDLS Link (off-link) over a set of off-channel(s).

The operations begin at step 1210, where the TDLS initiator non-AP MLD obtains, from the AP device, recommended channels that are not infrastructure BSSs or an off-channel TDLS direct link. For instance, it may receive from AP1 Channel Usage information as described above with reference to FIG. 6.

The Channel Usage information may be carried either into a Probe Response frame exchanged during the association procedure with the AP MLD or into a Channel Usage Response frame exchanged with the AP MLD once the non-AP MLD (its affiliated STA) is associated with the AP MLD. The Channel Usage information is provided by the AP MLD to the TDLS initiator non-AP MLD to recommend channels for BSSs that are not infrastructure BSSs or an off-channel TDLS direct link. The non-AP MLD can use the Channel Usage information as part of channel selection processing for a BSS that is not an infrastructure BSS or an off-channel TDLS direct link (4.3.21.4 Channel usage in REVme 2.0 (October 2022)). In other words, Channel Usage information provides the TDLS initiator non-AP MLD with channels that do not overlap the operating channels of the AP MLD.

FIG. 11c illustrates, using frame exchanges in a timeline, the creation and use of an off-link according to embodiments of the invention, wherein the Channel Usage information is obtained from a Probe Response frame. This Figure is based on the scenario of FIG. 11a where STA A1 121 and STA B1 131 register to AP1 111.

At the beginning of the frame exchange, STA A1 121 affiliated with the non-AP MLD 120 is not associated with any AP or AP MLD. In the context of discovery, STA A1 121 sends a Probe Request frame 212 including STA capabilities. Of interest for the current scenario, the Probe Request frame 212 includes a Supported Operating Classes element (order 6 in the Probe Request frame body) and a Channel Usage element (order 11 in the Probe Request frame body).

The Supported Operating Classes element advertises the operating classes within which the non-AP MLD is currently configured to operate. The Usage Mode carried in the Channel Usage element advertises the usage that the non-AP MLD wishes to do with the off-channel(s).

In some embodiments, the Probe Request frame 212 is in the Multi-Link version (802.11be), meaning it also includes a Multi-Link element (defined in section 9.4.2.312.1 of the D2.2 standard) used to request additional information from the AP MLD. If there is no per-STA profile in the Multi-Link element, the AP MLD includes (in its Probe Response frame) information about all its affiliated APs otherwise the AP MLD advertises the non-AP MLD only with the per-STA profile whose Link ID is equal to the value in the link ID field included in the per-STA profile carried in the Multi Link element of the Probe Request frame.

In another embodiment, the Supported Operating Classes may be carried in the per-STA profile included in the Multi-link element to advertise for each STA affiliated to the non-AP MLD the operating classes within which each STA is currently configured to operate.

In yet another embodiment, the non-AP MLD uses the Multi-Band element (order 14 in the Probe Request Frame Body) to advertise the AP MLD about the Supported Operating Classes through the different frequency band. Indeed, the Multi-band element indicates that the STA transmitting this element (the transmitting STA) is within a multi-band device capable of operating in a frequency band or operating class or channel other than the one in which this element (the Probe Request frame 212) is transmitted.

AP MLD 1101 responds through its affiliated AP1 111 with a Probe Response frame 213 to transmitting STA A1 121. The Probe Response frame 213 includes one or more Channel Usage elements as described above. They provide recommended channels (a set of channels for operation of a non-infrastructure network or an off-channel TDLS direct link) that do not overlap the channel(s) used by the AP MLD.

Once receiving the Probe Response frame 213, the non-AP MLD 120 solicits an association with the AP MLD (through its affiliated AP1 111). To do so, the non-AP MLD 120 transmits via STA A1 111 an Association Request frame 214. The Association Request frame 214 includes a Multi-Link element with a per-STA profile for each link (corresponding to each AP affiliated to the AP MLD) that are requested by the non-AP MLD for the association. Of course, such Multi-Link element does not populate the Association Request frame 214 when the AP 1101 is a legacy AP without multi-link capabilities.

If the AP MLD agrees with the Association request, AP1 111 responds to the non-AP MLD 120 with an Association Response frame 215, which (only when the AP is an MLD AP) includes a per-STA profile for each link corresponding to each AP affiliated to the AP MLD that are accepted for the association.

FIG. 11d illustrates, using frame exchanges in a timeline, the creation and use of an off-link according to other embodiments of the invention, wherein the Channel Usage information is obtained from a Channel Usage Response frame exchanged with the AP MLD once the non-AP MLD (its affiliated STA) is associated with the AP MLD. This Figure is based on the scenario of FIG. 11a where STA A1 121 and STA B1 131 have registered to AP1 111.

A non-AP STA supporting Channel Usage may indeed send a Channel Usage Request frame at any time after association to the AP that supports the use of Channel Usage to request the Channel Usage information for supported operating classes.

In this example, the non-AP MLDs 120 and 130 are already associated to the AP 1101. The non-AP MLD 120 hence requests, by sending the Channel Usage Request frame 815, the Channel Usage information from the AP MLD. The latter replies with the Channel Usage Response frame 816 that includes the Channel Usage information.

Back to FIG. 11b, optionally, at step 1220, the TDLS initiator non-AP MLD performs a TDLS discovery procedure (as already described above) to get information about the channel(s) and band(s) supported by its peer non-AP MLD. This step includes sending a TDLS Discovery Request frame 221 and receiving a TDLS Discovery Response frame 222 as already described above with reference to FIG. 2a.

This optional step is illustrated in the scenarios of FIGS. 11c and 11d.

When attempting to discover TDLS stations in the same BSS, a series of frame exchanges is used.

Initiator STA A1 sends a TDLS Discovery Request frame 221, tunneled through AP1 111 (relay illustrated by the black dot), to an individual destination station, here peer STA B1. The TDLS Discovery Request frame includes the Link Identifier element 400 as shown in FIG. 4a and may also contain the Multi-band element as defined above to indicate that the STA transmitting this element is within a multi-band device capable of operating in a frequency band or operating class or channel other than the one in which this element is transmitted. In addition, the STA informs the role (e.g. TDLS STA) the transmitting STA plays on the channel of the operating class indicated in the Multi-band element. This Multi-band element allows the initiator STA to inform the receiving STA about its channel capabilities. Finally, the TDLS Discovery Request frame may contain a TDLS Multi-Link element 450 as shown in FIG. 4b, to e.g. convey a per-STA profile for each STA of the TDLS initiator non-AP MLD, here non-AP MLD A 120, and to inform about the channel capabilities supported by the non-AP MLD.

Peer STA B1 responds to the TDLS Discovery Request frame 221 with a TDLS Discovery Response frame 222 sent directly to STA A1 (without relay by AP 111). This response frame conveys a Link Identifier element 400 and a TDLS Multi-Link element 450 amongst the IEs of the Elements field 303. Additionally, the TDLS Discovery Response frame may include the supported channels and the Multi-band elements to inform the TDLS initiator non-AP MLD through its affiliated STA about the channels and bands supported by the peer non-AP MLD.

From that point, STA A1 and STA B1 know each other, meaning they know the other operates on the communication link setup with AP 111. And, at MLD viewpoint, both non-AP MLDs 120 and 130 know the supported channels of the other.

Next, at step 1230, based on the recommended channels gathered from the AP MLD and optionally based on the supported channels/bands gathered from the peer non-AP MLD and also its own supported channels/bands, the TDLS initiator non-AP MLD selects one or more channels as off-channels. It means it selects one or more of the recommended channels that comply with its supported channels/bands and those of the peer non-AP MLD.

The selected channel or channels may be on the same band as or on a different band from the operating band(s) of the AP MLD.

It then creates a TDLS link targeting the set of selected off-channel(s) by exchanging TDLS Action frames with the peer non-AP MLD, that are tunneled by the AP MLD. The off-link for TDLS communication is therefore simultaneously created at both peer non-AP MLDs.

A new type of TDLS Action frame may be used, referred to below as TDLS Link Setup Request frame and corresponding TDLS Link Setup Response frame and TDLS Link Setup Confirm frame, on the same scheme as the TDLS Setup frames. Of course, the TDLS Setup frames could be upgraded to convey the signalling as required by the TDLS Link Setup frames now described (rather than creating new frames).

TDLS Link Setup Request frame may be assigned value 11 in the Action field 302; TDLS Link Setup Response frame may be assigned value 12 in the Action field 302; and TDLS Link Setup Confirm frame may be assigned value 13 in the Action field 302.

For example, the TDLS initiator non-AP MLD initiates the creation of the TDLS off-link by sending, to the peer non-AP STA, a TDLS Link Setup Request frame including a link identifier and the operating band of this new link, i.e. the selected off-channel or off-channels.

The TDLS Link Setup Request frame may be a TDLS Action frame including:
a Target Channel element (as defined in 9.4.1.35 (Target Channel) of REVme 2.0) to specify the channel number of the selected off-channel(s) for the off-link to create,
an Operating Class element (as defined in 9.4.1.36 (Operating Class) of REVme 2.0) to specify the operating band of the off-link to create, and
a link ID, i.e. a numeric value, that identifies the off-link to create for the future. A Link ID element such as element 523 of FIG. 5a1 can be used.

The link ID (also TDLS link ID below) is chosen by the TDLS initiator non-AP MLD. Preferably, the TDLS link ID defining the off-link is selected from a set of candidate link IDs deprived of any link ID used by the AP MLD. This is to avoid any conflict.

For example, the value of the TDLS link ID is out of the range of the value managed by the AP MLD, i.e. above 15). Indeed, as a result, the TDLS link ID is compatible with the link IDs managed by the AP.

As a variant, the TDLS Link Setup Request frame may include a Link Identifier element (as shown in FIG. 4a) to convey a link ID. For example, the TDLS initiator non-AP MLD may specify therein the MAC address of the affiliated STA (STA A2 in the example of FIG. 11a) that intends to operate on the off-link. In particular, this MAC address is included in the BSSID field 401 to identify the target link, i.e. the off-link to create. In that case, the off-link is assigned a BSSID, Basic Service Set Identifier, set to a MAC address of the affiliated STA involved in the TDLS initiator non-AP MLD, here STA A2. In a variant, the BSSID of the off-link may be set to a MAC address of the TDLS initiator non-AP MLD.

The MAC address may be used as a single identification of the off-link. In variant, it may be used in combination of the aforementioned link ID specified in element 523.

In some embodiments seeking to declare multiple off-links for the TDLS initiator non-AP MLD, the TDLS Link Setup Request frame may include a Multi-link element with plural per-STA profile, each of which conveying the Target Channel, Operating Class and link identifier of the corresponding off-link to create. This allows multiple off-links to be created with a peer non-AP STA through a single procedure (single exchange of TDLS Link Setup Request/Response and Confirm frames).

The TDLS initiator non-AP MLD receives, in response, a TDLS Link Setup Response frame that aims to confirm or not the creation of the off-link(s), by using a dedicated code.

The TDLS Link Setup Response frame may have the same format as the TDLS Link Setup Request frame, plus the response code.

The TDLS Link Setup Response frame may reject the creation of the off-link (or off-links), when a refusal code is conveyed.

In some embodiments, the TDLS Link Setup Response frame includes an alternative off-link (or multiple off-links with a Multi-link element) corresponding to at least one alternative off-channel that does not overlap the channel(s) used by the AP device. That means the peer non-AP MLD that does not accept the proposed off-link makes a counterproposal. A negotiation of an off-link is therefore conducted.

The alternative off-link may be defined with different operating band/channel.

The negotiation may continue as follows.

If plural alternative off-channels are proposed, the TDLS initiator non-AP MLD may select one of them as new target channel.

The TDLS initiator non-AP MLD then restarts the TDLS off-link creation procedure (sending a TDLS Link Setup Request frame) with the new target channel advised by the peer non-AP MLD, if the initiator agrees with. In a variant, the TDLS Link Setup Confirm frame as described below may be used to confirm the TDLS link creation with the alternative parameters (mainly operating channel(s)) provided by the peer non-AP MLD through the TDLS Link Setup Response frame.

Of course, in variants, the TDLS Link Setup Response frame may be a mere refusal without any proposal for an alternative off-link.

Finally, if the link proposed in the TDLS Link Setup Request frame is approved by the peer non-AP MLD, the TDLS Link Setup Response frame accepts the creation of the off-link (or off-links) with an acceptance code.

A TDLS Link Setup Confirm frame can then be sent by the TDLS initiator non-AP MLD to confirm creation of the off-link.

It is noted that at any moment once the off-link has been created, the TDLS initiator non-AP MLD (and/or the peer non-AP MLD) may notify the AP MLD about the created link ID and created off-link. This may be done by using reserved bit 523b in any subsequent frame that includes a Link ID Info field 523.

The creation of the off-link is illustrated in the same manner in FIGS. 11c and 11d. TDLS Link Setup Request frame is shown under reference 1301, while TDLS Link Setup Response frame is shown under reference 1302 and TDLS Link Setup Confirm frame is shown under reference 1303.

In details, TDLS initiator non-AP MLD A 120 sends, through its affiliated STA A1 121, TDLS Link Setup Request frame 1301 to peer non-AP MLD B 130 through its affiliated STA B1 131, over the existing link with the AP MLD, here AP1 111. This frame includes the target operating band and channel on which the link has to be established, as well as a link identifier to identify the TDLS link or off-link to create and the MAC address of STA A2 122 affiliated to the non-AP MLD that will be used to operate on the off-link. This MAC address can be used on behalf of the BSSID for the off-link.

In response to TDLS Link Setup Request frame 1301, the peer non-AP MLD responds through its affiliated STA B1 131 to the initiator non-AP MLD with TDLS Link Setup Response frame 1302. This frame includes the TDLS link ID received through frame 1301 plus a status code (acceptance or refusal) to inform that the creation of the link is accepted or not. In case of link creation rejection, the STA B1 131 adds one or more alternative bands and/or channels in response frame 1302.

When the frames 1301 and 1302 include a Multi-link element with one or several per-STA profiles, an acceptation at link level may be performed. Each STA profile conveyed in the TDLS Link Setup Request frame targets one different TDLS link or off-link to create. And as a response, each STA profile conveyed in the TDLS Link Setup Response frame corresponds to an TDLS link accepted by the peer non-AP STA. The other TDLS links are rejected.

Finally, the TDLS initiator non-AP MLD through its affiliated STA A1 121 sends a TDLS Link Setup Confirm frame 1303 to confirm the receipt of the TDLS Link Setup Response frame 1302. TDLS Link Setup Confirm frame 1303 conveys the link ID of the created off-link.

The TDLS Link Setup Confirm frame allows the MAC address of the STA affiliated to the initiator non-AP MLD that will operate on each different created off-link(s) (in the Multi-link element if any) to be shared.

As a result, the TDLS link, i.e. off-link is created.

Once the off-link has been created, the TDLS initiator non-AP MLD initiates at step 1240 a TDLS direct-link establishment to setup a TDLS direct link with a second non-AP MLD, targeting the off-link. This may be done using conventional TDLS Setup frames 223, 224, 225 wherein each TDLS Setup frames includes Link identifier 400 in which BSSID field 401 is set to the MAC Address of the STA affiliated to the initiator non-AP MLD which will operate on the target link. This is to indicate which off-link is targeted for the TDLS Setup. In some embodiments, the TDLS PeerKey (TPK) security protocol is derived based on the BSSID included in the Link Identifier that corresponds to the MAC address of the STA (STA A2 in the example of FIG. 11a) affiliated with the TDLS initiator non-AP MLD which intends to operate on the off-link.

In a variant to signalling the off-link in BSSID field 401, the target off-link may be specified in the per-STA profile carried in the TDLS Multi-Link element 450. The Multi-Link element transmitted by the TDLS initiator non-AP MLD in TDLS Setup Request frame 223 informs the peer non-AP MLD on which link(s) TDLS could be established. As a response, the Multi-Link element received by the TDLS initiator non-AP MLD from the peer non-AP MLD in TDLS Setup Response frame 224 informs the TDLS initiator non-AP MLD about which link(s) the TDLS session will be effectively established on, i.e. about the accepted off-links. In this variant, the BSSID field 401 may be set to the MAC address of the BSSID corresponding to the BSS of which the TDLS initiator non-AP MLD is a member, i.e. the MAC address of AP 111 or of AP MLD 1101. In the case where the TDLS session is established for multiple links (either only off-links or several classical direct links (with operating bands shared with APs) or a mix of classical links and off-links), the TDLS peers may create their own group TPK key for the multiple links. As each affiliated STA of an MLD uses a different MAC address, the key creation process may be adapted. Several variants can be envisaged:

(1) the TDLS PeerKey (TPK) security protocol may be derived based on the BSSIDs of all links setup by the TDLS setup procedure. Those BSSIDs may be retrieved from the per-STA profiles of the Multi-link element. They correspond to the AP MAC address for the classical links and to the address of a TDLS STA (initiator or responder) for the off-links. The TPK may be derived as follows when the frames transmitted during the TPK handshake by both peers include a TDLS Multi-Link element and the setup is for several links including off-link(s):

$$TPK = K DF - Hash - Length ( TPK - Key - Input , {}^{‶} TDLS {PMK}^{″} , min ( MAC\_I , MAC\_R ) ‖ max ( MAC\_I , MAC\_R ) ‖ BSSID 1 ‖ BSSID 2 ‖ … BSSIDn ‖ AP MLD MAC )$$

where:
TPK-Key-Input is derived from the hash algorithm, and KDF-Hash-Length is the key derivation function, as defined in section 12.7.1.6.2 of REVme D2.0.
MAC_I and MAC_R are the MAC addresses of the TDLS initiator STA and the TDLS responder STA, respectively;
The n-listed BSSIDs are set to the BSSIDs of the BSSs of which the TDLS initiator STA is a member;
AP MLD MAC is the MLD MAC address of the AP MLD with which the initiating non-AP MLD has performed multi-link setup.

In case where the number of links in the TDLS session is modified, the TDLS peers may decide to still use the current TPK for its entire (but limited) lifetime, and upon the end of lifetime being reached, to renew the TPK by considering the new (modified) set of links and their associated BSSIDs.

(2) In a variant, the TDLS PeerKey (TPK) may be derived based on the BSSID of one of the links, or on a wildcard BSSID or on the BSSID corresponding to the BSS of which the TDLS initiator non-AP MLD is a member, i.e. the MAC address of AP 111 or of AP MLD 1101. The TPK may be derived as follows:

$$TPK = K DF - Hash - Length ( TPK - Key - Input , {}^{‶} TDLS {PMK}^{″} , min ( MAC\_I , MAC\_R ) ‖ max ( MAC\_I , MAC\_R ) ‖ BSSID ‖ AP MLD MAC )$$

where, in addition to the above parameters defined above:
BSSID is the BSSID of the BSS of which the TDLS initiator STA is a member.

(3) In another variant, the TDLS PeerKey (TPK) may be derived based on the non-AP MLDs and AP MLD MAC addresses without considering the BSSID(s) corresponding to used link(s). The TPK may be derived as follows:

$$TPK = K DF - Hash - Length ( TPK - Key - Input , {}^{‶} TDLS {PMK}^{″} , min ( MLD MAC\_I , MAC\_R ) ‖ max ( MLD MAC\_I , MAC\_R ) ‖ AP MLD MAC )$$

where, in addition to the above parameters defined above:
MLD MAC_I and MLD MAC_R are the MLD MAC addresses of the (non-AP) TDLS initiator MLD STA and the (non-AP) TDLS responder MLD STA, respectively.

(4) In yet another variant, if the non-AP MLDs are associated with a legacy AP (for instance AP 111 in the example of FIG. 11a), the TDLS PeerKey (TPK) may be derived based on the non-AP MLDs MAC addresses and the BSSID of the BSS of which the TDLS initiator STA is a member. The TPK may be derived as follows:

$$TPK = K DF - Hash - Length ( TPK - Key - Input , {}^{‶} TDLS {PMK}^{″} , min ( MLD MAC\_I , MAC\_R ) ‖ max ( MLD MAC\_I , MLD MAC\_R ) ‖ BSSID ‖ .$$

Variants (2), (3) and (4) advantageously allow the number of links in the TDLS session to be modified without modifying the TPK.

Any combination of TPK variants may be envisaged.

In another variant to the above signalling of the off-link, the TDLS Setup frames include the Multi-Link Link element 490 which contains a Link ID bitmap 491, each bit of which corresponding to an off-link previously created. The Link ID bitmap 491 in the TDLS Setup Request frame 223 indicates the target off-link for the TDLS Setup while the link ID bitmap 491 in the TDLS Setup Response frame 224 indicates the accepted off-link(s).

The setting up of the TDLS direct link based on an off-link is illustrated in the same manner in FIGS. 11c and 11d.

TDLS initiator STA A1 121 performs TDLS Setup with peer STA B1 131 via AP1 111. Each TDLS Setup frames includes Link identifier 400. TDLS initiator STA Address field 402 carried in the Link Identifier is set to the MLD MAC Address of non-AP MLD 120, TDLS responder STA Address field 403 is set to the MLD MAC Address of non-AP MLD 130 and BSSID field 401 is set to the MAC Address of STA A2 122 which is the STA affiliated to TDLS initiator non-AP MLD A which operates on the target off-link. The MAC address of STA A2 122 used as BSSID is gathered by peer non-AP MLD B through the TDLS Link Setup Request or Confirm frame according to the embodiments.

As mentioned above variants may consider signalling the target off-link in the per-STA profile carried in the TDLS Multi-Link element 450 or signalling it through Link ID bitmap 491 provided in the Multi-Link Link Information element 490.

As a result, at step 1250, if the TDLS direct-link establishment succeeds, STA A2 122 and STA B2 132 (TDLS peer STAs) respectively affiliated to TDLS peer non-AP MLDs 120 and 130 can directly (P2P) communicate over the setup off-link. P2P data traffic 226 is thus directly exchanged between the two TDLS peer STAs as shown in FIGS. 11c and 11d. Advantageously, each TDLS peer non-AP MLD A and B can continue to operate with AP1 111 over the other setup links (here link 151 via STA A1 121 for non-AP MLD A 120 and link 161 via STA B1 131 for non-AP MLD B 130).

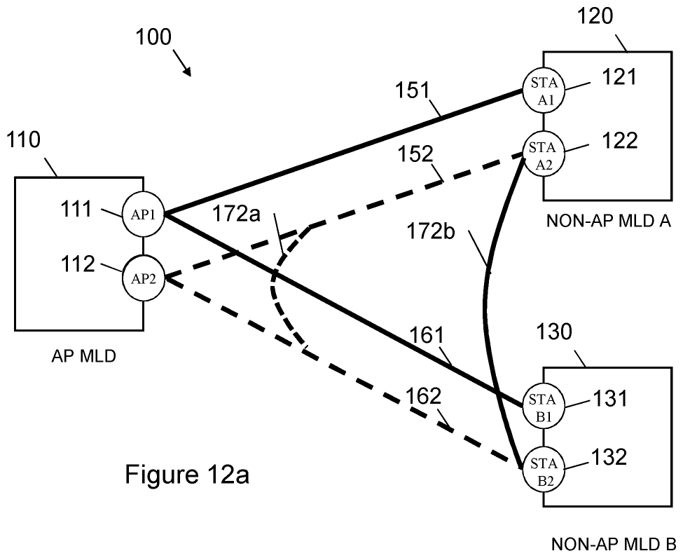

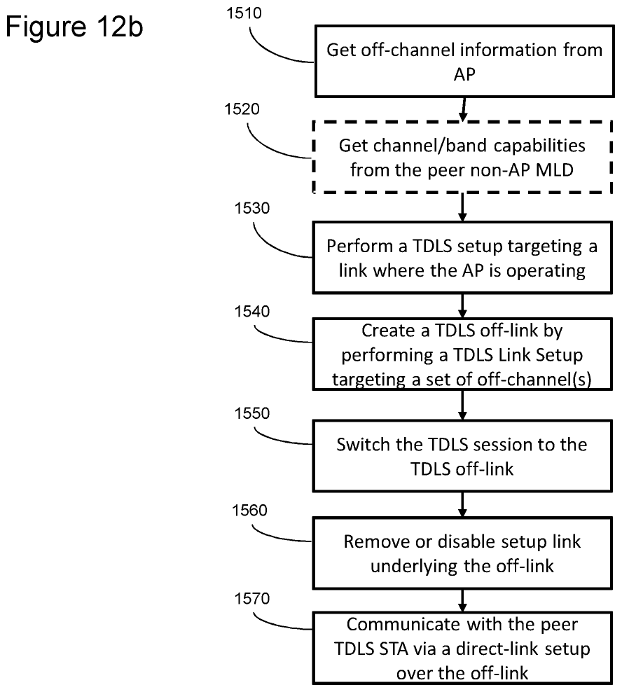

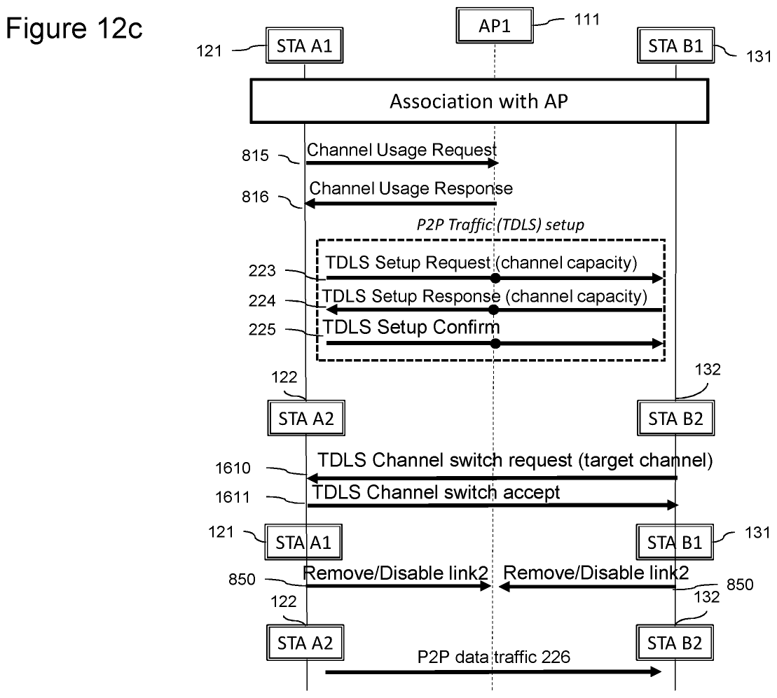

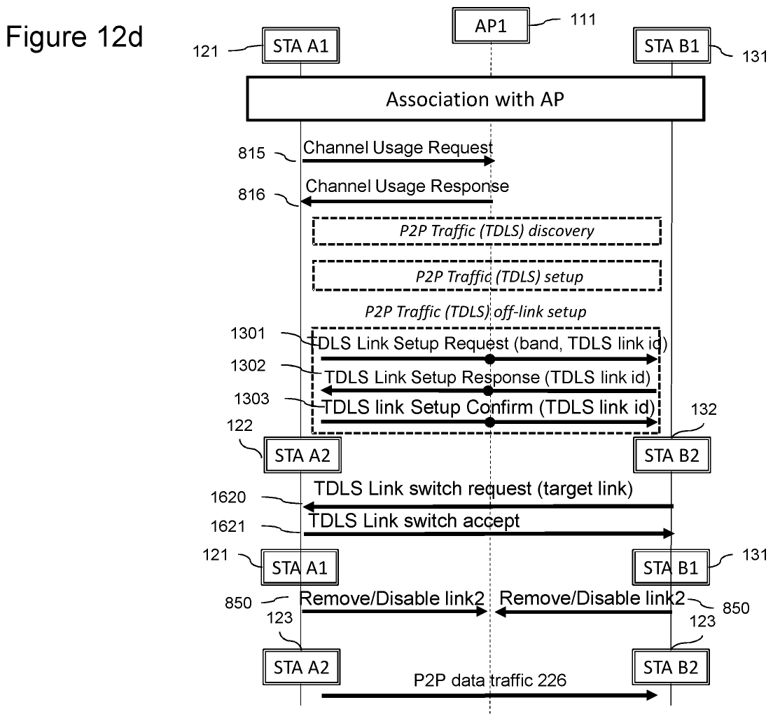

Second embodiments are described with reference to FIGS. 12a-12d. In these embodiments, a first TDLS direct link is established between the two non-AP MLDs, on a first link setup with the AP device. Next, the first TDLS session is switched to the off-link. The switch thus establishes the TDLS session on the off-link.

The first link initially supporting the first TDLS session can then be removed or disabled to remove any activity for the affiliated STAs (now involved in the off-link) with the AP device.

FIG. 12a illustrates an 802.11 network environment involving multi-radio devices MLDs as of FIG. 1 in which embodiments of the present invention may be implemented. The example of the Figure illustrates two non-AP MLDs (non-AP MLD A 120 and non-AP MLD B 130) with two affiliated STAs (from 121 to 122 and from 131 to 132 respectively) and an AP MLD 110 with two affiliated APs 111 and 112. Both non-AP MLDs associated to AP MLD 110, initially setup a TDLS direct link session 172a on the same operating band than the AP2 112, i.e. on link #2.

The non-AP MLDs 120 and 130 instantiate or create a TDLS link over a set of off-channel(s) to get an off-link 172b for operations out of the AP management. Next, the non-AP MLDs move the TDLS session from the link 172a operating on the same channel/band as AP2 112 to the off-link 172b which is not located on any operating channel/band of an AP(s) affiliated to the AP MLD 110. Their own connections to AP2 112 through respectively link 152 and 162 may then be removed.

As a result, the non-AP MLDs 120 and 130 are able to use the off-link 172b with one of their affiliated stations (respectively STA A2 122 and STA B2 132) while keeping the former connection with AP MLD through the link #1 corresponding to the connection with affiliated AP1.

Of course, the number of links shown in the present figure for the sake of illustration, is not limitative.

FIG. 12b illustrates, using a flowchart, exemplary steps for direct communications, in accordance with certain aspects of the present invention. These steps are performed by a (peer) non-AP MLD initiating the TDLS Link (off-link) over a set of off-channel(s). This process involves similar steps as FIG. 11b as explained below.

The operations begin at step 1510, where the TDLS initiator non-AP MLD obtains, from the AP device, recommended channels that are not infrastructure BSSs or an off-channel TDLS direct link. Step 1510 is similar to step 1210 described above.

FIGS. 12c and 12d illustrates, using frame exchanges in a timeline, two different scenarios for creating and using an off-link according to embodiments of the invention. In both scenarios, the Channel Usage information is obtained from a Channel Usage Response frame 816 exchanged with the AP MLD once the non-AP MLD (its affiliated STA) is associated with the AP MLD. Of course, it may alternatively be obtained from a Probe Response frame.

Optionally, in step 1520, the TDLS initiator non-AP MD performs a TDLS discovery procedure to get information of the channel(s) and band(s) supported by its peer non-AP MLD as well as its capabilities. Step 1520 is similar to step 1220 already described.

It is schematically illustrated in FIG. 12d while it is omitted in FIG. 12c but could also be implemented in this scenario. Each TDLS Discovery frame 221, 222 includes a Link identifier 400 in which TDLS initiator STA Address field 402 is set to the MLD MAC Address of non-AP MLD 120, TDLS responder STA Address field 403 is set to the MLD MAC Address of non-AP MLD 130 and BSSID field 401 is set to the BSSID corresponding to AP2 112 operating on a base channel.

Next, at step 1530, the TDLS initiator non-AP MLD initiates a conventional TDLS setup (i.e. TDLS direct-link establishment) with the peer non-AP MLD using a link shared and setup with the AP MLD (AP2 112 in the example of FIG. 12a) as a target link. As a reminder, each TDLS Setup frames includes Link identifier 400 in which BSSID field 401 is set to the BSSID of the AP that is operating on the link where the non-AP MLD intends to establish the single link TDLS direct link (AP2 112 in the same example).

During the TDLS setup phase, both non-AP MLDs may share their own capabilities, supported channels, supported band. That is why the TDLS Discovery procedure may be omitted. In other words, the two peer non-AP MLDs may know each other (about the supported channels and bands) through the TDLS Discovery procedure or through a TDLS Setup procedure.

Once the TDLS Setup procedure ends successfully, STA A2 122 and STA B2 132 (TDLS peer STAs) respectively affiliated to non-AP MLDs 120 and 130 can communicate (P2P data—not shown in FIGS. 12c and 12d) through the setup TDLS direct link, but in direct concurrency with the AP's traffic.

At this stage, the TDLS initiator non-AP MLD may select one or more channels as off-channels, based on the recommended channels gathered from the AP MLD (through Probe Response frame 213 or Channel Usage Response frame 816) and optionally based on the supported channels/bands gathered from the peer non-AP MLD (during TDLS Discovery procedure or TDLS Setup procedure) and also its own supported channels/bands. This or these off-channels define a target off-link to be created, according to the second embodiments, for use in direct or P2P communication.

The TDLS initiator non-AP MLD next decides to move or switch the setup TDLS session (direct link) from the TDLS link shared with the AP's traffic to the target off-link.

In some embodiments as illustrated in FIG. 12d, the move is operated in two steps, while a single step is required for other embodiments as illustrated in FIG. 12c. The switching in the two-step approach is based on a target link (corresponding to the off-link yet created) while the switching in the one-step approach is based on a target channel (defining the off-link yet to be created in the same operation).

At step 1540 dedicated to the two-step approach, the TDLS initiator non-AP MLD creates a TDLS link targeting the set of selected off-channel(s), i.e. the off-link, by exchanging TDLS Action frames with the peer non-AP MLD, that are tunneled by the AP MLD through the existing TDLS session. The off-link for TDLS communication is therefore simultaneously created at both peer non-AP MLDs. This step is quite similar to step 1230 described above.

For example, the TDLS initiator non-AP MLD initiates the creation of the TDLS off-link by sending, to the peer non-AP STA, a TDLS Link Setup Request frame including a link identifier and the operating band of this new link, i.e. the selected off-channel or off-channels. The frame may be a TDLS Action frame including a Target Channel element, an Operating Class element, and a link ID, i.e. a numeric value, that identifies the off-link to create for the future. In variants, the TDLS Link Setup Request frame may include a Multi-link element with plural per-STA profile, each of which conveying the Target Channel, Operating Class and link identifier of the corresponding off-link to create.

The TDLS initiator non-AP MLD receives, in response, a TDLS Link Setup Response frame that aims to confirm or not the creation of the off-link(s), by using a dedicated code. The response frame may include a counterproposal to perform an off-link negotiation as described above with reference to step 1230.

If approved, a TDLS Link Setup Confirm frame is sent by the TDLS initiator non-AP MLD to confirm creation of the off-link. The AP MLD may be notified about the created link ID and created off-link.

FIG. 12d illustrates the exchange of TDLS Link Setup Request frame 1301, TDLS Link Setup Response frame 1302 and TDLS Link Setup Confirm frame 1303.

Next step is step 1550 where the two peer non-AP MLDs actually switch the TDLS session (setup at step 1530) to the off-link.

In the two-step scenario of FIG. 12d, the switching consists in performing a TDLS Link switching, i.e. a change of link (and not of channel or band only as in the conventional TDLS Channel switching) of the existing TDLS session.

The link switching may be done by exchanging TDLS Action frames with the peer non-AP MLD directly (i.e. not tunneled by the AP MLD) over the existing TDLS session (on the channel of AP2 112).

A new type of TDLS Action frame may be used, referred to below as TDLS Link Switch Request frame and corresponding TDLS Link Switch Response frame, on the same scheme as the TDLS Switch frames. Of course, the TDLS Switch frames could be upgraded to convey the signalling as required by the TDLS Link Setup frames now described (rather than creating new frames).

TDLS Link Switch Request frame may be assigned value 14 in the Action field 302 and TDLS Link Switch Response frame may be assigned value 15 in the Action field 302.

For example, one of the two non-AP MLDs, through any of STA A2 122 or STA B2 132, sends a TDLS Link Switch Request frame 1620 to the other.

Frame 1620 includes the link ID of the target off-link to which the TDLS switch initiator non-AP MLD intends to move. This is the link ID specified when creating and setting up the off-link (at step 1540).

Next, the peer non-AP MLD responds by a TDLS Link Switch Response frame 1621 that repeats the link ID and includes a status code.

To acknowledge the Link Switch, the response includes a success status code (e.g. SUCCESS). As a result, both peer STAs involved in the initial TDLS session (setup at step 1540) configure themselves to operate on the target off-link.

In case of rejection of the Link Switch, the response includes a rejection status code (e.g. REQUEST_DECLINED). As a result, both STAs continue to operate on the same link (the TDLS session does not move).

To ensure synchronicity between the two peer STAs when configuring themselves to the target off-link, the TDLS Link Switch Request and Response frames 1620, 1621 may include timing information element (9.4.2.63 Channel Switch Timing element in REVme 2.0) to synchronize the moment where the link switch effectively occurs.

In the one-step scenario of FIG. 12c, the switching consists in performing a TDLS Channel switching that targets the off-channel or off-channels of the off-link to move the first TDLS session to the off-link. The TDLS Channel switching is a conventional operation defined in section 11.20.6 of the REVme 2.0, that involves exchanging TDLS Switch Request and corresponding Response frames.

For example, one of the two non-AP MLDs, through STA A2 122 or B2 132, sends a TDLS Channel Switch Request frame 1610 to the other, to move the P2P communication/session to the off-link.

The TDLS Channel Switch Request frame 1610 includes the target operating band and channel on which the off-link has to be established, as well as a link identifier to identify the new off-link to create in the same way as TDLS Link Setup Request frame 1301 described above. Furthermore, frame 1610, as a Switch frame, includes timing information for the Channel switch (9.4.2.63 Channel Switch Timing element in REVme 2.0).

The target Channel corresponds to the operating channel of the off-link (i.e. the off-channel) used as target channel.

In case the off-link is defined with a plurality of off-channels, TDLS Channel Switch Request frame 1610 may further include a Multi-link element with one or several per-STA profiles defining the multiple off-channels. In that case, the operating channel of the off-link used as target channel may be any of the channels in the channel entry (Channel Usage element) corresponding to the off-link. This ensures the peer STA clearly identifies which off-link is targeted for the switch.

Peer partner STA, B2 in the example, responds with a TDLS Channel Switch Response frame 1611 conveying the same link identifier and a status code.

To acknowledge the Channel Switch, the response includes a success status code (e.g. SUCCESS). As a result, both peer STAs involved in the initial TDLS session (setup at step 1540) configure themselves to operate on the target off-link.

In case of rejection of the Channel Switch, the response includes a rejection status code (e.g. REQUEST_DECLINED). As a result, both STAs continue to operate on the same link (the TDLS session does not move).

As it transpires from the above, the TDLS Link Switch frames and the TDLS Channel Switch frames mainly distinguish one from the other by the signalling of a Link ID field (for the former) rather than target operating band and channel (for the latter).

As a result (in both one-step and two-step approaches), after an adequate period of clear channel assessment (CCA) on the off-link (as described in 11.20.6 TDLS channel switching in REVme 2.0), STA A2 122 and B2 132 (TDLS peer STAs) respectively affiliated to the non-AP MLDs 120 and 130 may communicate over the off-link at step 1570.

In other words, the two non-AP MLDs operates a peer-to-peer communication between the first and second TDLS STAs, over the created off-link.

To remove any dependency of peer STAs to the AP MLD and thus the need to switch back to their base channel, optional step 1560 (before or during step 1570) removes or disables the link setup by the involved peer STAs with the AP MLD, i.e. the setup link that is underlying the off-link. In the scenario of FIG. 12a, it means links 152 and 162 with AP2 112 are both removed or disabled.

In variants, the removal/disabling may be operated before the switching.

Various implementations of this operation can be contemplated. For example, the removal or disabling of the link setup by any of the two peer STAs with the AP MLD may include one of:
updating a TID-To-Link mapping of the links setup by the corresponding non-AP MLD with the AP MLD, to remove all TIDs assigned to the link to remove/disable, and
performing a new multi-link setup (hence it is a re-setup) with the AP MLD that excludes the link to remove/disable.

This operation is illustrated in FIGS. 12c and 12d by the arrows 850. Since the two peer STAs are involved in the P2P communication over the off-link, another affiliated STA is used for this operation at both peer non-AP MLDs.

In the examples shown, the frame aiming at removing/disabling link 152 is sent by STA A1 121 to AP1 111, while the frame aiming at removing/disabling link 162 is sent by STA B1 131 to AP1 111 too.

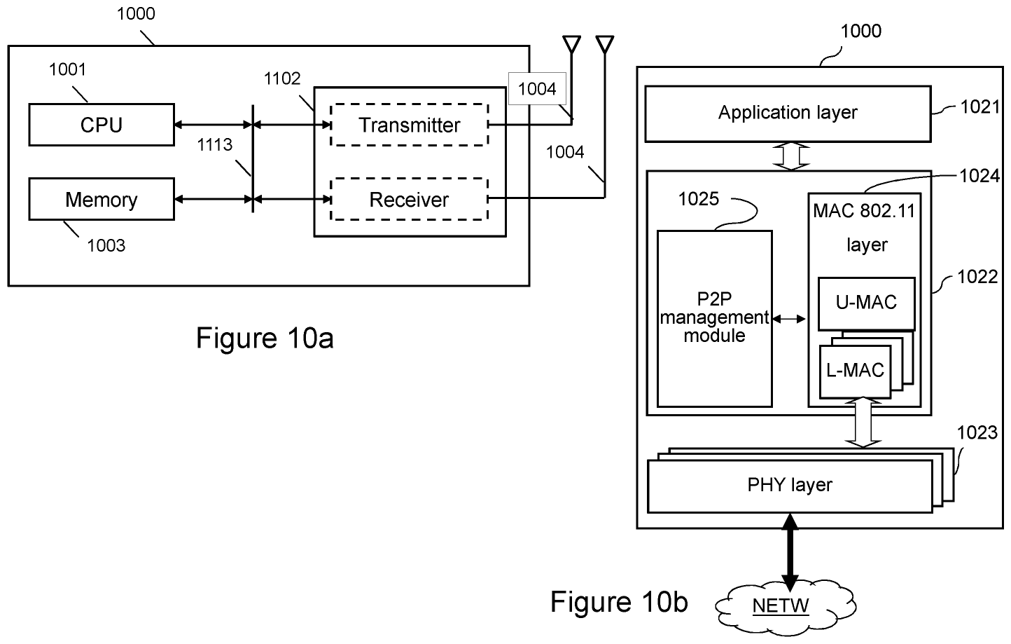

FIG. 10a schematically illustrates a communication device 1000, either a non-AP MLD, embedding a plurality of non-AP stations 120, 130, or an AP MLD, embedding a plurality of APs 110, of a radio network NETW, configured to implement at least one embodiment of the present invention. The communication device 1000 may preferably be a device such as a micro-computer, a workstation or a light portable device. The communication device 1000 comprises a communication bus 1113 to which there are preferably connected:
a central processing unit 1001, such as a processor, denoted CPU;
a memory 1003 for storing an executable code of methods or steps of the methods according to embodiments of the invention as well as the registers adapted to record variables and parameters necessary for implementing the methods; and
at least one communication interface 1002 connected to a wireless communication network, for example a communication network according to one of the IEEE 802.11 family of standards, via transmitting and receiving antennas 1004.

Preferably the communication bus provides communication and interoperability between the various elements included in the communication device 1800 or connected to it. The representation of the bus is not limiting and in particular the central processing unit is operable to communicate instructions to any element of the communication device 1800 directly or by means of another element of the communication device 1000.

The executable code may be stored in a memory that may either be read only, a hard disk or on a removable digital medium such as for example a disk. According to an optional variant, the executable code of the programs can be received by means of the communication network, via the interface 1002, in order to be stored in the memory of the communication device 1000 before being executed.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

FIG. 10b is a block diagram schematically illustrating the architecture of the communication device 1000, adapted to carry out, at least partially, the invention. As illustrated, device 1800 comprises a physical (PHY) layer block 1023, a MAC layer block 1022, and an application layer block 1021.

The PHY layer block 1023 (here a multiple of 802.11 standardized PHY layer modules) has the task of formatting, modulating on or demodulating from any 20 MHz channel or the composite channel, and thus sending or receiving frames over the radio medium NETW, such as 802.11 frames, for instance medium access trigger frames to reserve a transmission slot, MAC data and management frames based on a 20 MHz width to interact with legacy 802.11 stations, as well as of MAC data frames of OFDMA type having smaller width than 20 MHz legacy (typically 2 or 5 MHz) to/from that radio medium.

The MAC layer block or controller 1022 preferably comprises a MLE MAC 802.11 layer 1824 implementing conventional 802.11 MAC operations, and additional block 1025 for carrying out, at least partially, embodiments of the invention. The MAC layer block 1022 may optionally be implemented in software, which software is loaded into RAM 1003 and executed by CPU 1801. The MLE MAC 802.11 layer 1024 may implement an Upper-MAC stack along with a series of Lower-MAC modules.

Preferably, the additional block 1025, referred to as P2P management module for performing off-link operation for TDLS service over multi-link communications, implements part of embodiments of the invention (at a peer non-AP MLD). This block performs the operations described with reference to FIGS. 5b, 6a-6c, 7a-7d, 8-8c and 9a-9b, or FIGS. 11a-11d and 12a-12d, depending on the embodiments implemented.

MAC 802.11-layer 1024 and P2P management 1025 interact one with the other in order to establish and process accurately communications over OFDMA RU in between multiple non-AP MLD stations according to embodiments of the invention.

On top of the FIG. 10b, application layer block 1021 runs an application that generates and receives data packets, for example data packets such as a video stream. Application layer block 1021 represents all the stack layers above MAC layer according to ISO standardization.

In an embodiment, the device is a programmable apparatus which uses software to implement embodiments of the invention. However, alternatively, embodiments of the present invention may be implemented, totally or in partially, in hardware (for example, in the form of an Application Specific Integrated Circuit or ASIC).

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon referring to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1-44. (canceled)

45. A non-Access Point (AP) Multi-Link device (MLD) comprising:
at least one memory that stores a set of instructions; and
at least one processor that executes the instructions, the instructions, when executed, causing the device to perform operations comprising:
transmitting a frame including a subfield indicating whether the non-AP MLD has in-device coexistence activities on the non-AP MLD's one or more links.

46. The non-AP MLD according to claim 45,
wherein the non-AP MLD is compliant to the Institute of Electrical and Electronics Engineers (IEEE) 802.11 standard series, and
wherein the subfield indicates that a link is dedicated to coexistence with communication in other radio access technology than radio access technology in accordance with IEEE802.11 standard series.

47. The non-AP MLD according to claim 45, wherein the non-AP MLD embeds multiple communication chips and optimize coexistence in between these different Radio Access technologies.

48. The non-AP MLD according to claim 47, wherein the multiple communication chips include at least two of communication chips for cellular, Wi-Fi or Bluetooth.

49. An Access Point (AP) Multi-Link device (MLD) comprising:
at least one memory that stores a set of instructions; and
at least one processor that executes the instructions, the instructions, when executed, causing the device to perform operations comprising:
receiving, from the non-AP MLD, a frame including a subfield indicating whether the non-AP MLD has in-device coexistence activities on the non-AP MLD's one or more links.

50. The AP MLD according to claim 49,
wherein the non-AP MLD is compliant to the Institute of Electrical and Electronics Engineers (IEEE) 802.11 standard series, and
wherein the subfield indicates that a link is dedicated to coexistence with communication in other radio access technology than radio access technology in accordance with IEEE802.11 standard series.

51. A method of controlling a non-Access Point (AP) Multi-Link device (MLD) comprising:
generating a frame including a subfield indicating whether the non-AP MLD has in-device coexistence activities on the non-AP MLD's one or more links; and
transmitting the generated frame.

52. A method of controlling an Access Point (AP) Multi-Link device (MLD) comprising:
receiving, from the non-AP MLD, a frame including a subfield indicating whether the non-AP MLD has in-device coexistence activities on the non-AP MLD's one or more links; and
interpreting the received frame.

53. A non-transitory computer readable storage medium that stores a program that causes, when the program is executed, a non-Access Point (AP) Multi-Link device (MLD) to perform:
generating a frame including a subfield indicating whether the non-AP MLD has in-device coexistence activities on the non-AP MLD's one or more links; and
transmitting the generated frame.

54. A non-transitory computer readable storage medium that stores a program that causes, when the program is executed, an Access Point (AP) Multi-Link device (MLD) to perform:
receiving, from the non-AP MLD, a frame including a subfield indicating whether the non-AP MLD has in-device coexistence activities on the non-AP MLD's one or more links; and
interpreting the received frame.
